(19) United States
(12) Patent Application Publication
(10) Pub. No.: US 2014/0006239 A1
(43) Pub. Date: Jan. 2, 2014

(54) Consistent Interface for Service Confirmation

(71) Applicants: Simon Dieterich, Heidelberg (DE); Ralph Meiswinkel, Bad Schoenborn (DE); Christian Haas, Heidelberg (DE)

(72) Inventors: Simon Dieterich, Heidelberg (DE); Ralph Meiswinkel, Bad Schoenborn (DE); Christian Haas, Heidelberg (DE)

(21) Appl. No.: 13/535,433

(22) Filed: Jun. 28, 2012

(51) Int. Cl. G06Q 40/00

(52) U.S. Cl. 705/35

(57) ABSTRACT

A business object model, which reflects data that is used during a given business transaction, is utilized to generate interfaces. This business object model facilitates commercial transactions by providing consistent interfaces that are suitable for use across industries, across businesses, and across different departments within a business during a business transaction. In some operations, software creates, updates, or otherwise processes information related to a service confirmation business object.

### CROSS-REFERENCE TO RELATED APPLICATIONS

Some details of the subject matter of this specification are described in previously-filed U.S. patent application Ser. No. 11/803,178, entitled “Consistent Set of Interfaces Derived From a Business Object Model”, filed on May 11, 2007, which is hereby incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter described herein relates generally to the generation and use of consistent interfaces (or services) derived from a business object model. More particularly, the present disclosure relates to the generation and use of consistent interfaces or services that are suitable for use across industries, across businesses, and across different departments within a business.

### BACKGROUND

Transactions are common among businesses and between business departments within a particular business. During any given transaction, these business entities exchange information. For example, during a sales transaction, numerous business entities may be involved, such as a sales entity that sells merchandise to a customer, a financial institution that handles the financial transaction, and a warehouse that sends the merchandise to the customer. The end-to-end business transaction may require a significant amount of information to be exchanged between the various business entities involved. For example, the customer may send a request for the merchandise as well as some form of payment authorization for the merchandise to the sales entity, and the sales entity may send the financial institution a request for a transfer of funds from the customer's account to the sales entity's account.

Exchanging information between different business entities is not a simple task. This is particularly true because the information used by different business entities is usually tightly tied to the business entity itself. Each business entity may have its own program for handling its part of the transaction. These programs differ from each other because they typically are created for different purposes and because each business entity may use semantics that differ from the other business entities. For example, one program may relate to accounting, another program may relate to manufacturing, and a third program may relate to inventory control. Similarly, one program may identify merchandise using the name of the product while another program may identify the same merchandise using its model number. Further, one business entity may use U.S. dollars to represent its currency while another business entity may use Japanese Yen. A simple difference in formatting, e.g., the use of upper-case lettering rather than lower-case or title-case, makes the exchange of information between businesses a difficult task. Unless the individual businesses agree upon particular semantics, human interaction typically is required to facilitate transactions between these businesses. Because these “heterogeneous” programs are used by different companies or by different business areas within a given company, a need exists for a consistent way to exchange information and perform a business transaction between the different business entities.

Currently, many standards exist that offer a variety of interfaces used to exchange business information. Most of these interfaces, however, apply to only one specific industry and are not consistent between the different standards. Moreover, a number of these interfaces are not consistent within an individual standard.

### SUMMARY

In a first aspect, a computer-readable medium includes program code for providing a message-based interface for exchanging information about service confirmations. The medium comprises program code for receiving, via a message-based interface exposing at least one service as defined in a service registry and from a heterogeneous application executing in an environment of computer systems providing message-based services, a first message for a request from an external service performing and charging system to create a service confirmation with reference to a customer contract. The first message includes a message package hierarchically organized as an external service performing and charging system service confirmation create request message entity and an external service performing and charging system service confirmation package including an external service performing and charging system service confirmation entity. The external service performing and charging system service confirmation entity includes at least one of the following: a customer contract identifier and a name. The medium further comprises program code for sending a second message to the heterogeneous application responsive to the first message.

Implementations can include the following. The external service performing and charging system service confirmation entity further includes at least one item entity from an item package. The external service performing and charging system service confirmation entity further includes at least one of the following: a text collection and an attachment folder.

In another aspect, a distributed system operates in a landscape of computer systems providing message-based services defined in a service registry. The system comprises a graphical user interface comprising computer readable instructions, embedded on tangible media, for a request from an external service performing and charging system to create a service confirmation with reference to a customer contract, the instructions using a request. The system further comprises a first memory storing a user interface controller for processing the request and involving a message including a message package hierarchically organized as an external service performing and charging system service confirmation create request message entity and an external service performing and charging system service confirmation package including an external service performing and charging system service confirmation entity. The external service performing and charging system service confirmation entity includes at least one of the following: a customer contract identifier and a name. The system further comprises a second memory, remote from the graphical user interface, storing a plurality of service interfaces, wherein one of the service interfaces is operable to process the message via the service interface.

Implementations can include the following. The first memory is remote from the graphical user interface. The first memory is remote from the second memory.

### BRIEF DESCRIPTION OF THE DRAWINGS

FIG. 1 depicts a flow diagram of the overall steps performed by methods and systems consistent with the subject matter described herein.

FIG. 2 depicts a business document flow for an invoice request in accordance with methods and systems consistent with the subject matter described herein.

FIGS. 3A-B illustrate example environments implementing the transmission, receipt, and processing of data between heterogeneous applications in accordance with certain embodiments included in the present disclosure.

FIG. 4 illustrates an example application implementing certain techniques and components in accordance with one embodiment of the system of FIG. 1.

FIG. 5A depicts an example development environment in accordance with one embodiment of FIG. 1.

FIG. 5B depicts a simplified process for mapping a model representation to a runtime representation using the example development environment of FIG. 5A or some other development environment.

FIG. 6 depicts message categories in accordance with methods and systems consistent with the subject matter described herein.

FIG. 7 depicts an example of a package in accordance with methods and systems consistent with the subject matter described herein.

FIG. 8 depicts another example of a package in accordance with methods and systems consistent with the subject matter described herein.

FIG. 9 depicts a third example of a package in accordance with methods and systems consistent with the subject matter described herein.

FIG. 10 depicts a fourth example of a package in accordance with methods and systems consistent with the subject matter described herein.

FIG. 11 depicts the representation of a package in the XML schema in accordance with methods and systems consistent with the subject matter described herein.

FIG. 12 depicts a graphical representation of cardinalities between two entities in accordance with methods and systems consistent with the subject matter described herein.

FIG. 13 depicts an example of a composition in accordance with methods and systems consistent with the subject matter described herein.

FIG. 14 depicts an example of a hierarchical relationship in accordance with methods and systems consistent with the subject matter described herein.

FIG. 15 depicts an example of an aggregating relationship in accordance with methods and systems consistent with the subject matter described herein.

FIG. 16 depicts an example of an association in accordance with methods and systems consistent with the subject matter described herein.

FIG. 17 depicts an example of a specialization in accordance with methods and systems consistent with the subject matter described herein.

FIG. 18 depicts the categories of specializations in accordance with methods and systems consistent with the subject matter described herein.

FIG. 19 depicts an example of a hierarchy in accordance with methods and systems consistent with the subject matter described herein.

FIG. 20 depicts a graphical representation of a hierarchy in accordance with methods and systems consistent with the subject matter described herein.

FIGS. 21A-B depict a flow diagram of the steps performed to create a business object model in accordance with methods and systems consistent with the subject matter described herein.

FIGS. 22A-F depict a flow diagram of the steps performed to generate an interface from the business object model in accordance with methods and systems consistent with the subject matter described herein.

FIG. 23 depicts an example illustrating the transmittal of a business document in accordance with methods and systems consistent with the subject matter described herein.

FIG. 24 depicts an interface proxy in accordance with methods and systems consistent with the subject matter described herein.

FIG. 25 depicts an example illustrating the transmittal of a message using proxies in accordance with methods and systems consistent with the subject matter described herein.

FIG. 26A depicts components of a message in accordance with methods and systems consistent with the subject matter described herein.

FIG. 26B depicts IDs used in a message in accordance with methods and systems consistent with the subject matter described herein.

FIGS. 27A-E depict a hierarchization process in accordance with methods and systems consistent with the subject matter described herein.

FIG. 28 illustrates an example method for service enabling in accordance with one embodiment of the present disclosure.

FIG. 29 is a graphical illustration of an example business object and associated components as may be used in the enterprise service infrastructure system of the present disclosure.

FIG. 30 illustrates an example method for managing a process agent framework in accordance with one embodiment of the present disclosure.

FIG. 31 illustrates an example method for status and action management in accordance with one embodiment of the present disclosure.

FIG. 32 depicts an example External Service Performing And Charging System Service Confirmation Create Request message data type.

FIGS. 33-1 through 33-5 collectively depict an example External Service Performing and Charging System Service Confirmation Create Request element structure.

FIGS. 34-1 through 34-8 collectively depict an example Service Confirmation object model.

### DETAILED DESCRIPTION

A. Overview

Methods and systems consistent with the subject matter described herein facilitate e-commerce by providing consistent interfaces that are suitable for use across industries, across businesses, and across different departments within a business during a business transaction. To generate consistent interfaces, methods and systems consistent with the subject matter described herein utilize a business object model, which reflects the data that will be used during a given business transaction. An example of a business transaction is the exchange of purchase orders and order confirmations between a buyer and a seller. The business object model is generated in a hierarchical manner to ensure that the same type of data is represented the same way throughout the business object model. This ensures the consistency of the information in the business object model. Consistency is also reflected in the semantic meaning of the various structural elements. That is, each structural element has a consistent business meaning. For example, the location entity, regardless of in which package it is located, refers to a location.

From this business object model, various interfaces are derived to accomplish the functionality of the business transaction. Interfaces provide an entry point for components to access the functionality of an application. For example, the interface for a Purchase Order Request provides an entry point for components to access the functionality of a Purchase Order, in particular, to transmit and/or receive a Purchase Order Request. One skilled in the art will recognize that each of these interfaces may be provided, sold, distributed, utilized, or marketed as a separate product or as a major component of a separate product. Alternatively, a group of related interfaces may be provided, sold, distributed, utilized, or marketed as a product or as a major component of a separate product. Because the interfaces are generated from the business object model, the information in the interfaces is consistent, and the interfaces are consistent among the business entities. Such consistency facilitates heterogeneous business entities in cooperating to accomplish the business transaction.

Generally, the business object is a representation of a type of a uniquely identifiable business entity (an object instance) described by a structural model. In the architecture, processes may typically operate on business objects. Business objects represent a specific view on some well-defined business content. In other words, business objects represent content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. The process component is a software package that realizes a business process and generally exposes its functionality as services. The functionality contains business transactions. In general, the process component contains one or more semantically related business objects. Often, a particular business object belongs to no more than one process component. Interactions between process component pairs involving their respective business objects, process agents, operations, interfaces, and messages are described as process component interactions, which generally determine the interactions of a pair of process components across a deployment unit boundary. Interactions between process components within a deployment unit are typically not constrained by the architectural design and can be implemented in any convenient fashion. Process components may be modular and context-independent. In other words, process components may not be specific to any particular application and as such, may be reusable. In some implementations, the process component is the smallest (most granular) element of reuse in the architecture. An external process component is generally used to represent the external system in describing interactions with the external system; however, this should be understood to require no more of the external system than that able to produce and receive messages as required by the process component that interacts with the external system. For example, process components may include multiple operations that may provide interaction with the external system. Each operation generally belongs to one type of process component in the architecture. Operations can be synchronous or asynchronous, corresponding to synchronous or asynchronous process agents, which will be described below. The operation is often the smallest, separately-callable function, described by a set of data types used as input, output, and fault parameters serving as a signature.

The architectural elements may also include the service interface, referred to simply as the interface. The interface is a named group of operations. The interface often belongs to one process component and process component might contain multiple interfaces. In one implementation, the service interface contains only inbound or outbound operations, but not a mixture of both. One interface can contain both synchronous and asynchronous operations. Normally, operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. Operation can use multiple message types for inbound, outbound, or error messages. When two process components are in different deployment units, invocation of an operation of one process component by the other process component is accomplished by the operation on the other process component sending a message to the first process component.

The architectural elements may also include the process agent. Process agents do business processing that involves the sending or receiving of messages. Each operation normally has at least one associated process agent. Each process agent can be associated with one or more operations. Process agents can be either inbound or outbound and either synchronous or asynchronous. Asynchronous outbound process agents are called after a business object changes such as after a “create”, “update”, or “delete” of a business object instance. Synchronous outbound process agents are generally triggered directly by business object. An outbound process agent will generally perform some processing of the data of the business object instance whose change triggered the event. The outbound agent triggers subsequent business process steps by sending messages using well-defined outbound services to another process component, which generally will be in another deployment unit, or to an external system. The outbound process agent is linked to the one business object that triggers the agent, but it is sent not to another business object but rather to another process component. Thus, the outbound process agent can be implemented without knowledge of the exact business object design of the recipient process component. Alternatively, the process agent may be inbound. For example, inbound process agents may be used for the inbound part of a message-based communication. Inbound process agents are called after a message has been received. The inbound process agent starts the execution of the business process step requested in a message by creating or updating one or multiple business object instances. Inbound process agent is not generally the agent of business object but of its process component. Inbound process agent can act on multiple business objects in a process component. Regardless of whether the process agent is inbound or outbound, an agent may be synchronous if used when a process component requires a more or less immediate response from another process component, and is waiting for that response to continue its work.

The architectural elements also include the deployment unit. Each deployment unit may include one or more process components that are generally deployed together on a single computer system platform. Conversely, separate deployment units can be deployed on separate physical computing systems. The process components of one deployment unit can interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by the deployment unit to be scaled to meet demand by creating as many instances as needed.

Since interaction between deployment units is through process component operations, one deployment unit can be replaced by other another deployment unit as long as the new deployment unit supports the operations depended upon by other deployment units as appropriate. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement generally supports the operations of the original.

Services (or interfaces) may be provided in a flexible architecture to support varying criteria between services and systems. The flexible architecture may generally be provided by a service delivery business object. The system may be able to schedule a service asynchronously as necessary, or on a regular basis. Services may be planned according to a schedule manually or automatically. For example, a follow-up service may be scheduled automatically upon completing an initial service. In addition, flexible execution periods may be possible (e.g. hourly, daily, every three months, etc.). Each customer may plan the services on demand or reschedule service execution upon request.

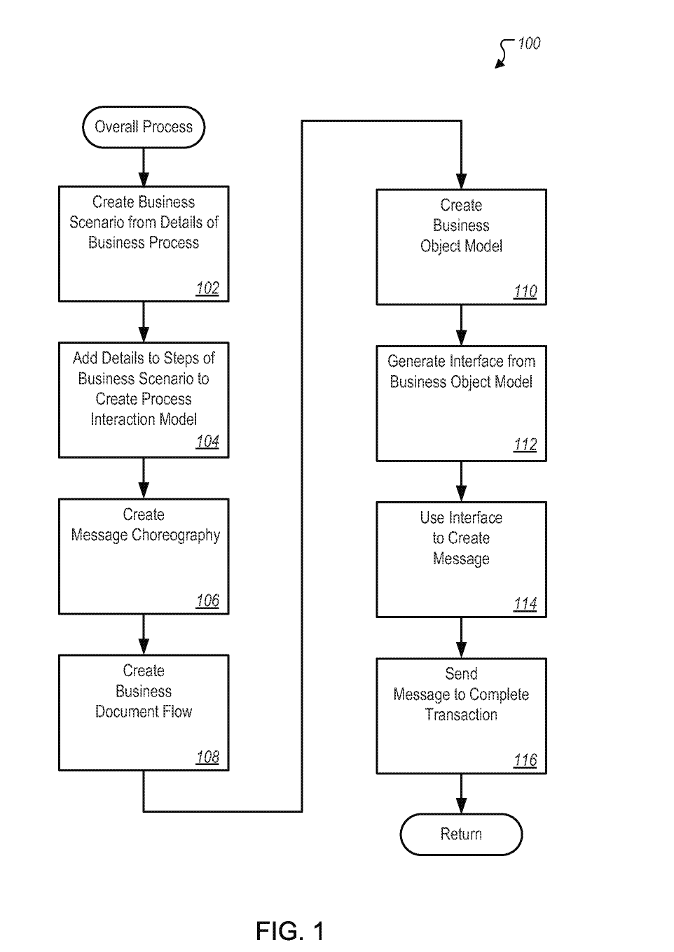

FIG. 1 depicts a flow diagram 100 showing an example technique, perhaps implemented by systems similar to those disclosed herein. Initially, to generate the business object model, design engineers study the details of a business process, and model the business process using a “business scenario” (step 102). The business scenario identifies the steps performed by the different business entities during a business process. Thus, the business scenario is a complete representation of a clearly defined business process.

After creating the business scenario, the developers add details to each step of the business scenario (step 104). In particular, for each step of the business scenario, the developers identify the complete process steps performed by each business entity. A discrete portion of the business scenario reflects a “business transaction,” and each business entity is referred to as a “component” of the business transaction. The developers also identify the messages that are transmitted between the components. A “process interaction model” represents the complete process steps between two components.

After creating the process interaction model, the developers create a “message choreography” (step 106), which depicts the messages transmitted between the two components in the process interaction model. The developers then represent the transmission of the messages between the components during a business process in a “business document flow” (step 108). Thus, the business document flow illustrates the flow of information between the business entities during a business process.

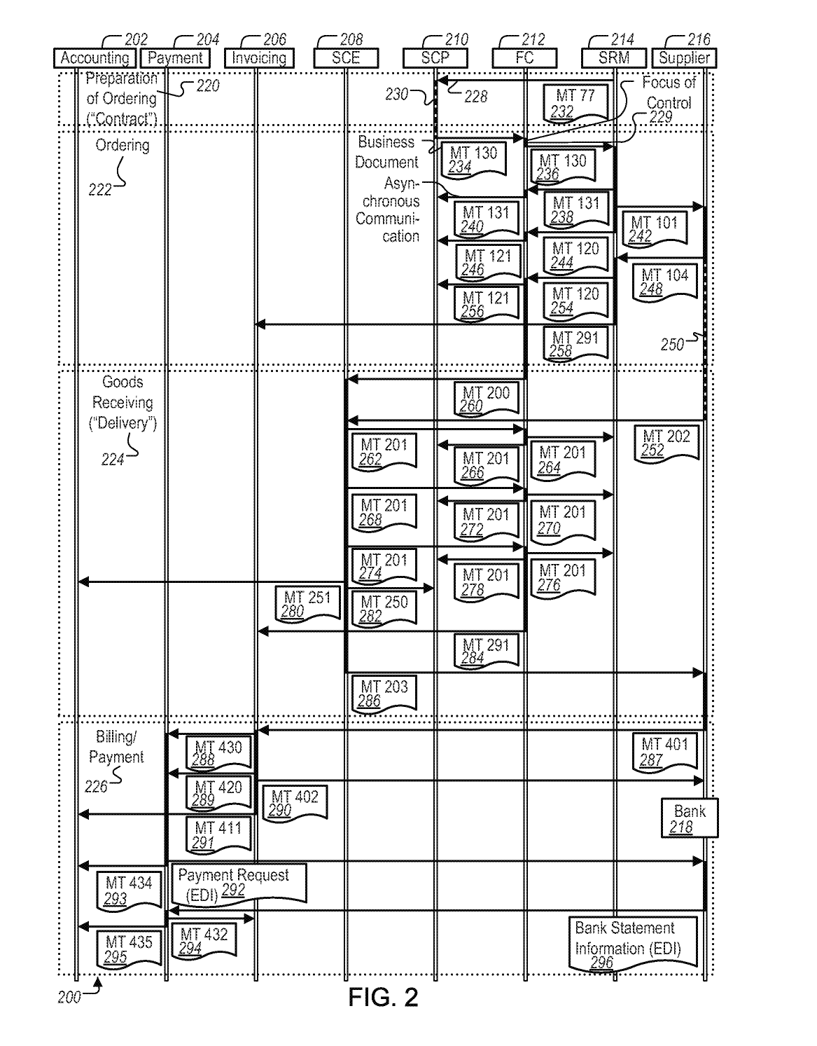

FIG. 2 depicts an example business document flow 200 for the process of purchasing a product or service. The business entities involved with the illustrative purchase process include Accounting 202, Payment 204, Invoicing 206, Supply Chain Execution (“SCE”) 208, Supply Chain Planning (“SCP”) 210, Fulfillment Coordination (“FC”) 212, Supply Relationship Management (“SRM”) 214, Supplier 216, and Bank 218. The business document flow 200 is divided into four different transactions: Preparation of Ordering (“Contract”) 220, Ordering 222, Goods Receiving (“Delivery”) 224, and Billing/Payment 226. In the business document flow, arrows 228 represent the transmittal of documents. Each document reflects a message transmitted between entities. One of ordinary skill in the art will appreciate that the messages transferred may be considered to be a communications protocol. The process flow follows the focus of control, which is depicted as a solid vertical line (e.g., 229) when the step is required, and a dotted vertical line (e.g., 230) when the step is optional.

During the Contract transaction 220, the SRM 214 sends a Source of Supply Notification 232 to the SCP 210. This step is optional, as illustrated by the optional control line 230 coupling this step to the remainder of the business document flow 200. During the Ordering transaction 222, the SCP 210 sends a Purchase Requirement Request 234 to the FC 212, which forwards a Purchase Requirement Request 236 to the SRM 214. The SRM 214 then sends a Purchase Requirement Confirmation 238 to the FC 212, and the FC 212 sends a Purchase Requirement Confirmation 240 to the SCP 210. The SRM 214 also sends a Purchase Order Request 242 to the Supplier 216, and sends Purchase Order Information 244 to the FC 212. The FC 212 then sends a Purchase Order Planning Notification 246 to the SCP 210. The Supplier 216, after receiving the Purchase Order Request 242, sends a Purchase Order Confirmation 248 to the SRM 214, which sends a Purchase Order Information confirmation message 254 to the FC 212, which sends a message 256 confirming the Purchase Order Planning Notification to the SCP 210. The SRM 214 then sends an Invoice Due Notification 258 to Invoicing 206.

During the Delivery transaction 224, the FC 212 sends a Delivery Execution Request 260 to the SCE 208. The Supplier 216 could optionally (illustrated at control line 250) send a Dispatched Delivery Notification 252 to the SCE 208. The SCE 208 then sends a message 262 to the FC 212 notifying the FC 212 that the request for the Delivery Information was created. The FC 212 then sends a message 264 notifying the SRM 214 that the request for the Delivery Information was created. The FC 212 also sends a message 266 notifying the SCP 210 that the request for the Delivery Information was created. The SCE 208 sends a message 268 to the FC 212 when the goods have been set aside for delivery. The FC 212 sends a message 270 to the SRM 214 when the goods have been set aside for delivery. The FC 212 also sends a message 272 to the SCP 210 when the goods have been set aside for delivery.

The SCE 208 sends a message 274 to the FC 212 when the goods have been delivered. The FC 212 then sends a message 276 to the SRM 214 indicating that the goods have been delivered, and sends a message 278 to the SCP 210 indicating that the goods have been delivered. The SCE 208 then sends an Inventory Change Accounting Notification 280 to Accounting 202, and an Inventory Change Notification 282 to the SCP 210. The FC 212 sends an Invoice Due Notification 284 to Invoicing 206, and SCE 208 sends a Received Delivery Notification 286 to the Supplier 216.

During the Billing/Payment transaction 226, the Supplier 216 sends an Invoice Request 287 to Invoicing 206. Invoicing 206 then sends a Payment Due Notification 288 to Payment 204, a Tax Due Notification 289 to Payment 204, an Invoice Confirmation 290 to the Supplier 216, and an Invoice Accounting Notification 291 to Accounting 202. Payment 204 sends a Payment Request 292 to the Bank 218, and a Payment Requested Accounting Notification 293 to Accounting 202. Bank 218 sends a Bank Statement Information 296 to Payment 204. Payment 204 then sends a Payment Done Information 294 to Invoicing 206 and a Payment Done Accounting Notification 295 to Accounting 202.

Within a business document flow, business documents having the same or similar structures are marked. For example, in the business document flow 200 depicted in FIG. 2, Purchase Requirement Requests 234, 236 and Purchase Requirement Confirmations 238, 240 have the same structures. Thus, each of these business documents is marked with an “O6.” Similarly, Purchase Order Request 242 and Purchase Order Confirmation 248 have the same structures. Thus, both documents are marked with an “O1.” Each business document or message is based on a message type.

From the business document flow, the developers identify the business documents having identical or similar structures, and use these business documents to create the business object model (step 110). The business object model includes the objects contained within the business documents. These objects are reflected as packages containing related information, and are arranged in a hierarchical structure within the business object model, as discussed below.

Methods and systems consistent with the subject matter described herein then generate interfaces from the business object model (step 112). The heterogeneous programs use instantiations of these interfaces (called “business document objects” below) to create messages (step 114), which are sent to complete the business transaction (step 116). Business entities use these messages to exchange information with other business entities during an end-to-end business transaction. Since the business object model is shared by heterogeneous programs, the interfaces are consistent among these programs. The heterogeneous programs use these consistent interfaces to communicate in a consistent manner, thus facilitating the business transactions.

Standardized Business-to-Business (“B2B”) messages are compliant with at least one of the e-business standards (i.e., they include the business-relevant fields of the standard). The e-business standards include, for example, RosettaNet for the high-tech industry, Chemical Industry Data Exchange (“CIDX”), Petroleum Industry Data Exchange (“PIDX”) for the oil industry, UCCnet for trade, PapiNet for the paper industry, Odette for the automotive industry, HR-XML for human resources, and XML Common Business Library (“xCBL”). Thus, B2B messages enable simple integration of components in heterogeneous system landscapes. Application-to-Application (“A2A”) messages often exceed the standards and thus may provide the benefit of the full functionality of application components. Although various steps of FIG. 1 were described as being performed manually, one skilled in the art will appreciate that such steps could be computer-assisted or performed entirely by a computer, including being performed by either hardware, software, or any other combination thereof.

B. Implementation Details

As discussed above, methods and systems consistent with the subject matter described herein create consistent interfaces by generating the interfaces from a business object model. Details regarding the creation of the business object model, the generation of an interface from the business object model, and the use of an interface generated from the business object model are provided below.

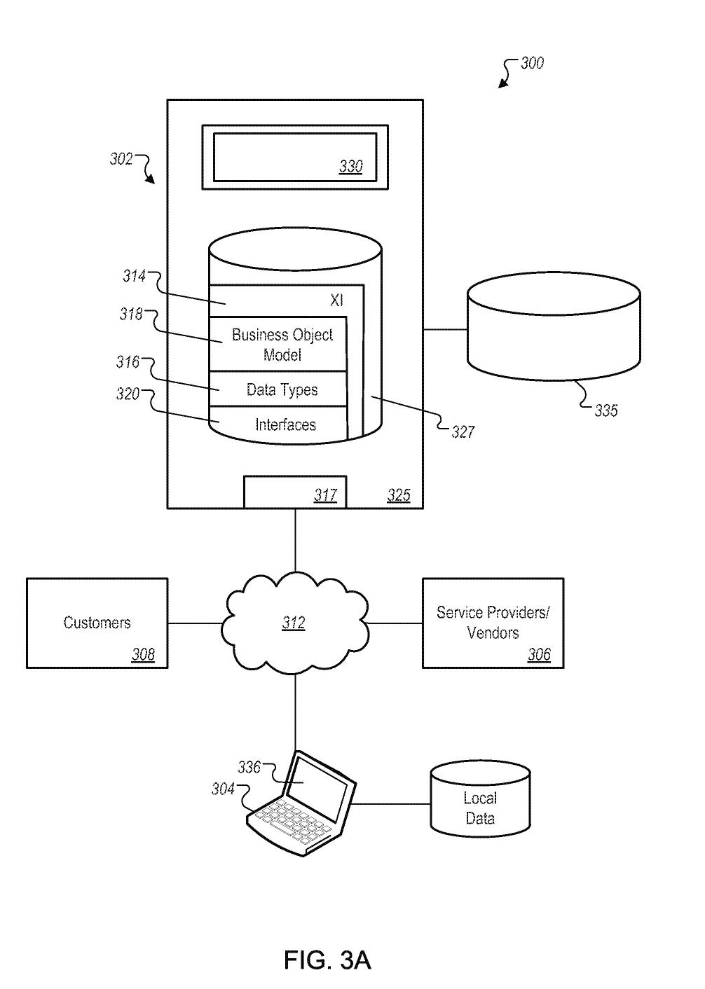

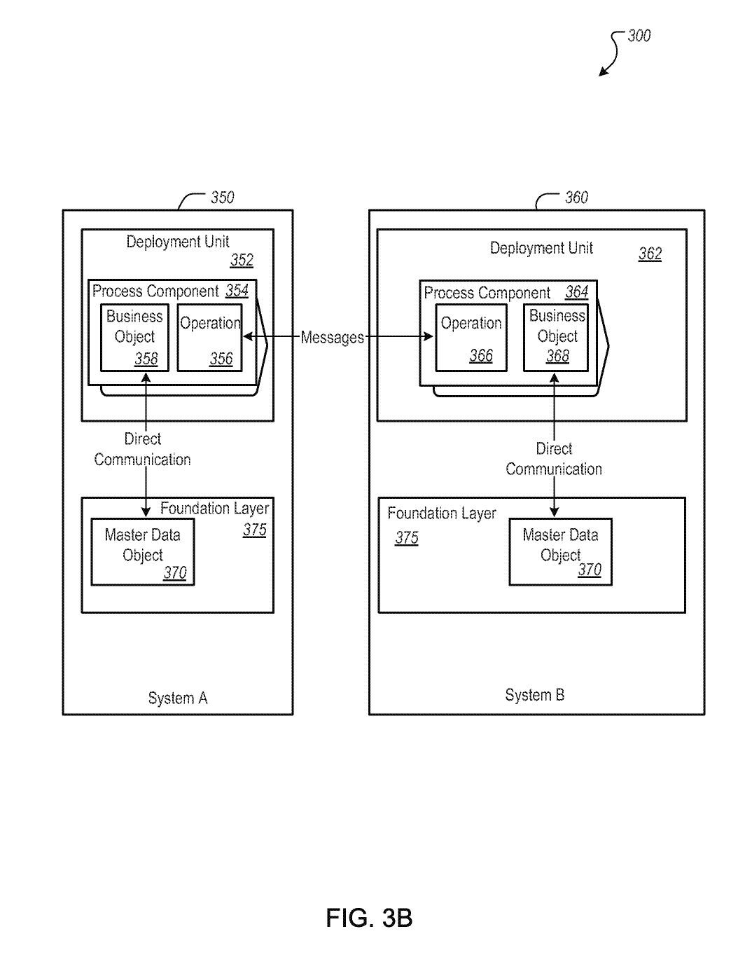

Turning to the illustrated embodiment in FIG. 3A, environment 300 includes or is communicably coupled (such as via a one-, bi- or multi-directional link or network) with server 302, one or more clients 304, one or more or vendors 306, one or more customers 308, at least some of which communicate across network 312. But, of course, this illustration is for example purposes only, and any distributed system or environment implementing one or more of the techniques described herein may be within the scope of this disclosure. Server 302 comprises an electronic computing device operable to receive, transmit, process and store data associated with environment 300. Generally, FIG. 3A provides merely one example of computers that may be used with the disclosure. Each computer is generally intended to encompass any suitable processing device. For example, although FIG. 3A illustrates one server 302 that may be used with the disclosure, environment 300 can be implemented using computers other than servers, as well as a server pool. Indeed, server 302 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 302 may be adapted to execute any operating system including Linux, UNIX, Windows Server, or any other suitable operating system. According to one embodiment, server 302 may also include or be communicably coupled with a web server and/or a mail server.

As illustrated (but not required), the server 302 is communicably coupled with a relatively remote repository 335 over a portion of the network 312. The repository 335 is any electronic storage facility, data processing center, or archive that may supplement or replace local memory (such as 327). The repository 335 may be a central database communicably coupled with the one or more servers 302 and the clients 304 via a virtual private network (VPN), SSH (Secure Shell) tunnel, or other secure network connection. The repository 335 may be physically or logically located at any appropriate location including in one of the example enterprises or off-shore, so long as it remains operable to store information associated with the environment 300 and communicate such data to the server 302 or at least a subset of plurality of the clients 304.

Illustrated server 302 includes local memory 327. Memory 327 may include any memory or database module and may take the form of volatile or non-volatile memory including, without limitation, magnetic media, optical media, random access memory (RAM), read-only memory (ROM), removable media, or any other suitable local or remote memory component. Illustrated memory 327 includes an exchange infrastructure (“XI”) 314, which is an infrastructure that supports the technical interaction of business processes across heterogeneous system environments. XI 314 centralizes the communication between components within a business entity and between different business entities. When appropriate, XI 314 carries out the mapping between the messages. XI 314 integrates different versions of systems implemented on different platforms (e.g., Java and ABAP). XI 314 is based on an open architecture, and makes use of open standards, such as eXtensible Markup Language (XML)™ and Java environments. XI 314 offers services that are useful in a heterogeneous and complex system landscape. In particular, XI 314 offers a runtime infrastructure for message exchange, configuration options for managing business processes and message flow, and options for transforming message contents between sender and receiver systems.

XI 314 stores data types 316, a business object model 318, and interfaces 320. The details regarding the business object model are described below. Data types 316 are the building blocks for the business object model 318. The business object model 318 is used to derive consistent interfaces 320. XI 314 allows for the exchange of information from a first company having one computer system to a second company having a second computer system over network 312 by using the standardized interfaces 320.

While not illustrated, memory 327 may also include business objects and any other appropriate data such as services, interfaces, VPN applications or services, firewall policies, a security or access log, print or other reporting files, HTML files or templates, data classes or object interfaces, child software applications or sub-systems, and others. This stored data may be stored in one or more logical or physical repositories. In some embodiments, the stored data (or pointers thereto) may be stored in one or more tables in a relational database described in terms of SQL statements or scripts. In the same or other embodiments, the stored data may also be formatted, stored, or defined as various data structures in text files, XML documents, Virtual Storage Access Method (VSAM) files, flat files, Btrieve files, comma-separated-value (CSV) files, internal variables, or one or more libraries. For example, a particular data service record may merely be a pointer to a particular piece of third party software stored remotely. In another example, a particular data service may be an internally stored software object usable by authenticated customers or internal development. In short, the stored data may comprise one table or file or a plurality of tables or files stored on one computer or across a plurality of computers in any appropriate format. Indeed, some or all of the stored data may be local or remote without departing from the scope of this disclosure and store any type of appropriate data.

Server 302 also includes processor 325. Processor 325 executes instructions and manipulates data to perform the operations of server 302 such as, for example, a central processing unit (CPU), a blade, an application specific integrated circuit (ASIC), or a field-programmable gate array (FPGA). Although FIG. 3A illustrates a single processor 325 in server 302, multiple processors 325 may be used according to particular needs and reference to processor 325 is meant to include multiple processors 325 where applicable. In the illustrated embodiment, processor 325 executes at least business application 330.

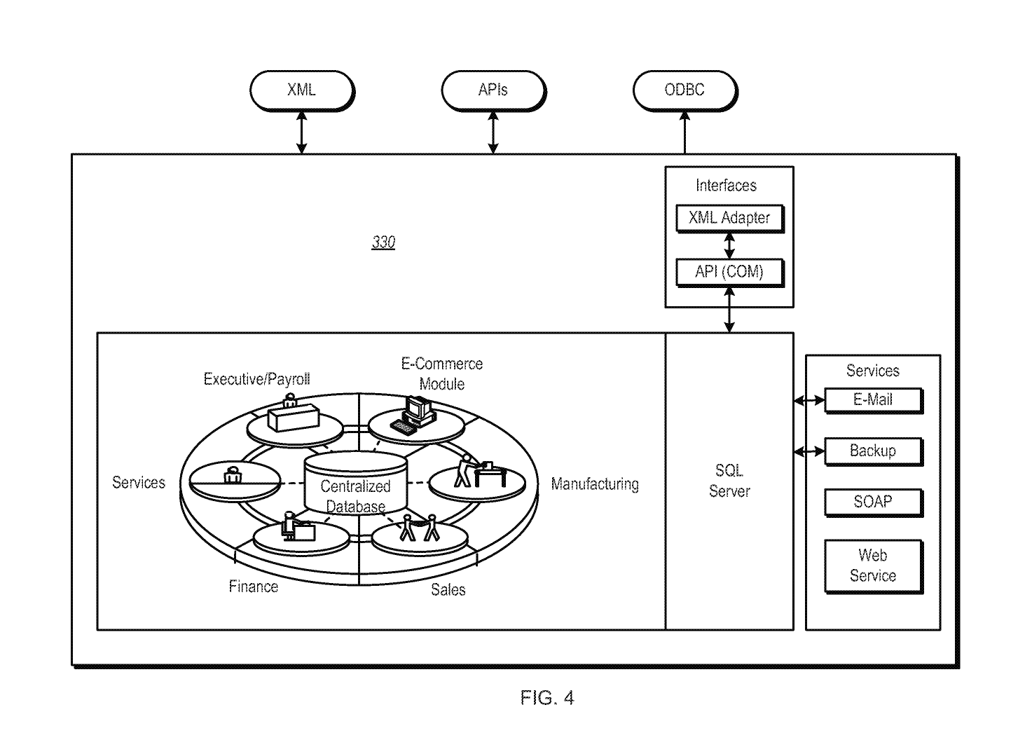

At a high level, business application 330 is any application, program, module, process, or other software that utilizes or facilitates the exchange of information via messages (or services) or the use of business objects. For example, application 330 may implement, utilize or otherwise leverage an enterprise service-oriented architecture (enterprise SOA), which may be considered a blueprint for an adaptable, flexible, and open IT architecture for developing services-based, enterprise-scale business solutions. This example enterprise service may be a series of web services combined with business logic that can be accessed and used repeatedly to support a particular business process. Aggregating web services into business-level enterprise services helps provide a more meaningful foundation for the task of automating enterprise-scale business scenarios Put simply, enterprise services help provide a holistic combination of actions that are semantically linked to complete the specific task, no matter how many cross-applications are involved. In certain cases, environment 300 may implement a composite application 330, as described below in FIG. 4. Regardless of the particular implementation, “software” may include software, firmware, wired or programmed hardware, or any combination thereof as appropriate. Indeed, application 330 may be written or described in any appropriate computer language including C, C++, Java, Visual Basic, assembler, Perl, any suitable version of 4GL, as well as others. For example, returning to the above mentioned composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while application 330 is illustrated in FIG. 4 as including various sub-modules, application 330 may include numerous other sub-modules or may instead be a single multi-tasked module that implements the various features and functionality through various objects, methods, or other processes. Further, while illustrated as internal to server 302, one or more processes associated with application 330 may be stored, referenced, or executed remotely. For example, a portion of application 330 may be a web service that is remotely called, while another portion of application 330 may be an interface object bundled for processing at remote client 304. Moreover, application 330 may be a child or sub-module of another software module or enterprise application (not illustrated) without departing from the scope of this disclosure. Indeed, application 330 may be a hosted solution that allows multiple related or third parties in different portions of the process to perform the respective processing.

More specifically, as illustrated in FIG. 4, application 330 may be a composite application, or an application built on other applications, that includes an object access layer (OAL) and a service layer. In this example, application 330 may execute or provide a number of application services, such as customer relationship management (CRM) systems, human resources management (HRM) systems, financial management (FM) systems, project management (PM) systems, knowledge management (KM) systems, and electronic file and mail systems. Such an object access layer is operable to exchange data with a plurality of enterprise base systems and to present the data to a composite application through a uniform interface. The example service layer is operable to provide services to the composite application. These layers may help the composite application to orchestrate a business process in synchronization with other existing processes (e.g., native processes of enterprise base systems) and leverage existing investments in the IT platform. Further, composite application 330 may run on a heterogeneous IT platform. In doing so, composite application may be cross-functional in that it may drive business processes across different applications, technologies, and organizations. Accordingly, composite application 330 may drive end-to-end business processes across heterogeneous systems or sub-systems. Application 330 may also include or be coupled with a persistence layer and one or more application system connectors. Such application system connectors enable data exchange and integration with enterprise sub-systems and may include an Enterprise Connector (EC) interface, an Internet Communication Manager/Internet Communication Framework (ICM/ICF) interface, an Encapsulated PostScript (EPS) interface, and/or other interfaces that provide Remote Function Call (RFC) capability. It will be understood that while this example describes a composite application 330, it may instead be a standalone or (relatively) simple software program. Regardless, application 330 may also perform processing automatically, which may indicate that the appropriate processing is substantially performed by at least one component of environment 300. It should be understood that automatically further contemplates any suitable administrator or other user interaction with application 330 or other components of environment 300 without departing from the scope of this disclosure.

Returning to FIG. 3A, illustrated server 302 may also include interface 317 for communicating with other computer systems, such as clients 304, over network 312 in a client-server or other distributed environment. In certain embodiments, server 302 receives data from internal or external senders through interface 317 for storage in memory 327, for storage in DB 335, and/or processing by processor 325. Generally, interface 317 comprises logic encoded in software and/or hardware in a suitable combination and operable to communicate with network 312. More specifically, interface 317 may comprise software supporting one or more communications protocols associated with communications network 312 or hardware operable to communicate physical signals.

Network 312 facilitates wireless or wireline communication between computer server 302 and any other local or remote computer, such as clients 304. Network 312 may be all or a portion of an enterprise or secured network. In another example, network 312 may be a VPN merely between server 302 and client 304 across wireline or wireless link. Such an example wireless link may be via 802.11a, 802.11b, 802.11g, 802.20, WiMax, and many others. While illustrated as a single or continuous network, network 312 may be logically divided into various sub-nets or virtual networks without departing from the scope of this disclosure, so long as at least portion of network 312 may facilitate communications between server 302 and at least one client 304. For example, server 302 may be communicably coupled to one or more “local” repositories through one sub-net while communicably coupled to a particular client 304 or “remote” repositories through another. In other words, network 312 encompasses any internal or external network, networks, sub-network, or combination thereof operable to facilitate communications between various computing components in environment 300. Network 312 may communicate, for example, Internet Protocol (IP) packets, Frame Relay frames, Asynchronous Transfer Mode (ATM) cells, voice, video, data, and other suitable information between network addresses. Network 312 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 312 may be a secure network associated with the enterprise and certain local or remote vendors 306 and customers 308. As used in this disclosure, customer 308 is any person, department, organization, small business, enterprise, or any other entity that may use or request others to use environment 300. As described above, vendors 306 also may be local or remote to customer 308. Indeed, a particular vendor 306 may provide some content to business application 330, while receiving or purchasing other content (at the same or different times) as customer 308. As illustrated, customer 308 and vendor O6 each typically perform some processing (such as uploading or purchasing content) using a computer, such as client 304.

Client 304 is any computing device operable to connect or communicate with server 302 or network 312 using any communication link. For example, client 304 is intended to encompass a personal computer, touch screen terminal, workstation, network computer, kiosk, wireless data port, smart phone, personal data assistant (PDA), one or more processors within these or other devices, or any other suitable processing device used by or for the benefit of business 308, vendor 306, or some other user or entity. At a high level, each client 304 includes or executes at least GUI 336 and comprises an electronic computing device operable to receive, transmit, process and store any appropriate data associated with environment 300. It will be understood that there may be any number of clients 304 communicably coupled to server 302. Further, “client 304,” “business,” “business analyst,” “end user,” and “user” may be used interchangeably as appropriate without departing from the scope of this disclosure. Moreover, for ease of illustration, each client 304 is described in terms of being used by one user. But this disclosure contemplates that many users may use one computer or that one user may use multiple computers. For example, client 304 may be a PDA operable to wirelessly connect with external or unsecured network. In another example, client 304 may comprise a laptop that includes an input device, such as a keypad, touch screen, mouse, or other device that can accept information, and an output device that conveys information associated with the operation of server 302 or clients 304, including digital data, visual information, or GUI 336. Both the input device and output device may include fixed or removable storage media such as a magnetic computer disk, CD-ROM, or other suitable media to both receive input from and provide output to users of clients 304 through the display, namely the client portion of GUI or application interface 336.

GUI 336 comprises a graphical user interface operable to allow the user of client 304 to interface with at least a portion of environment 300 for any suitable purpose, such as viewing application or other transaction data. Generally, GUI 336 provides the particular user with an efficient and user-friendly presentation of data provided by or communicated within environment 300. For example, GUI 336 may present the user with the components and information that is relevant to their task, increase reuse of such components, and facilitate a sizable developer community around those components. GUI 336 may comprise a plurality of customizable frames or views having interactive fields, pull-down lists, and buttons operated by the user. For example, GUI 336 is operable to display data involving business objects and interfaces in a user-friendly form based on the user context and the displayed data. In another example, GUI 336 is operable to display different levels and types of information involving business objects and interfaces based on the identified or supplied user role. GUI 336 may also present a plurality of portals or dashboards. For example, GUI 336 may display a portal that allows users to view, create, and manage historical and real-time reports including role-based reporting and such. Of course, such reports may be in any appropriate output format including PDF, HTML, and printable text. Real-time dashboards often provide table and graph information on the current state of the data, which may be supplemented by business objects and interfaces. It should be understood that the term graphical user interface may be used in the singular or in the plural to describe one or more graphical user interfaces and each of the displays of a particular graphical user interface. Indeed, reference to GUI 336 may indicate a reference to the front-end or a component of business application 330, as well as the particular interface accessible via client 304, as appropriate, without departing from the scope of this disclosure. Therefore, GUI 336 contemplates any graphical user interface, such as a generic web browser or touchscreen, that processes information in environment 300 and efficiently presents the results to the user. Server 302 can accept data from client 304 via the web browser (e.g., Microsoft Internet Explorer or Netscape Navigator) and return the appropriate HTML or XML responses to the browser using network 312.

More generally in environment 300 as depicted in FIG. 3B, a Foundation Layer 375 can be deployed on multiple separate and distinct hardware platforms, e.g., System A 350 and System B 360, to support application software deployed as two or more deployment units distributed on the platforms, including deployment unit 352 deployed on System A and deployment unit 362 deployed on System B. In this example, the foundation layer can be used to support application software deployed in an application layer. In particular, the foundation layer can be used in connection with application software implemented in accordance with a software architecture that provides a suite of enterprise service operations having various application functionality. In some implementations, the application software is implemented to be deployed on an application platform that includes a foundation layer that contains all fundamental entities that can used from multiple deployment units. These entities can be process components, business objects, and reuse service components. A reuse service component is a piece of software that is reused in different transactions. A reuse service component is used by its defined interfaces, which can be, e.g., local APIs or service interfaces. As explained above, process components in separate deployment units interact through service operations, as illustrated by messages passing between service operations 356 and 366, which are implemented in process components 354 and 364, respectively, which are included in deployment units 352 and 362, respectively. As also explained above, some form of direct communication is generally the form of interaction used between a business object, e.g., business object 358 and 368, of an application deployment unit and a business object, such as master data object 370, of the Foundation Layer 375.

Various components of the present disclosure may be modeled using a model-driven environment. For example, the model-driven framework or environment may allow the developer to use simple drag-and-drop techniques to develop pattern-based or freestyle user interfaces and define the flow of data between them. The result could be an efficient, customized, visually rich online experience. In some cases, this model-driven development may accelerate the application development process and foster business-user self-service. It further enables business analysts or IT developers to compose visually rich applications that use analytic services, enterprise services, remote function calls (RFCs), APIs, and stored procedures. In addition, it may allow them to reuse existing applications and create content using a modeling process and a visual user interface instead of manual coding.

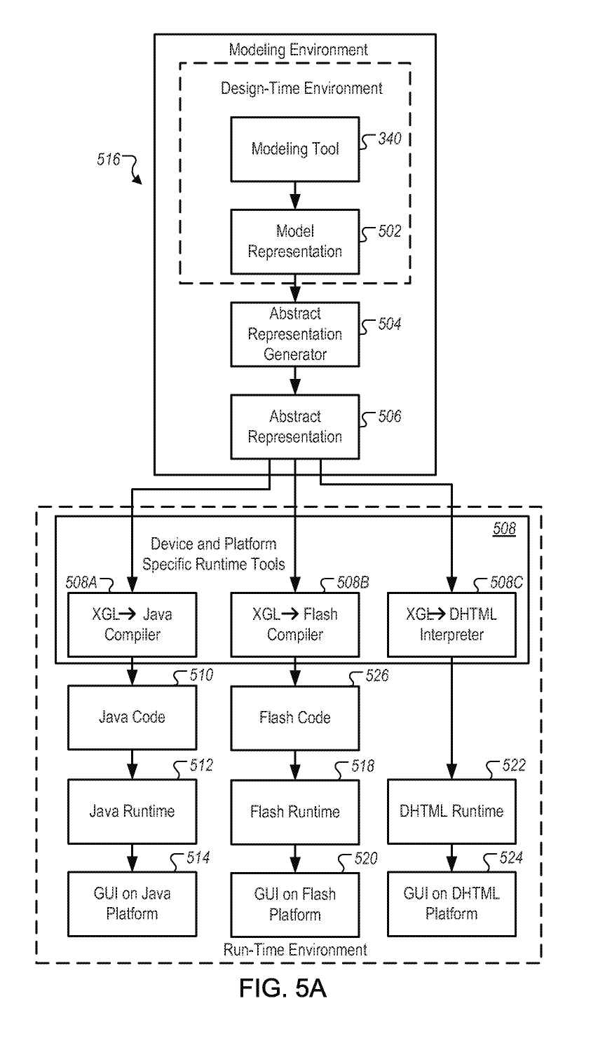

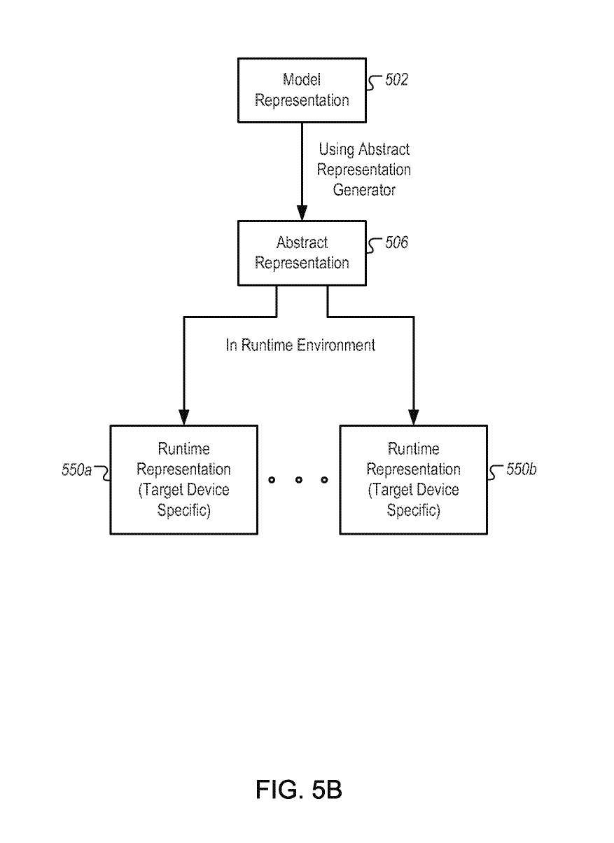

FIG. 5A depicts an example modeling environment 516, namely a modeling environment, in accordance with one embodiment of the present disclosure. Thus, as illustrated in FIG. 5A, such a modeling environment 516 may implement techniques for decoupling models created during design-time from the runtime environment. In other words, model representations for GUIs created in a design time environment are decoupled from the runtime environment in which the GUIs are executed. Often in these environments, a declarative and executable representation for GUIs for applications is provided that is independent of any particular runtime platform, GUI framework, device, or programming language.

According to some embodiments, a modeler (or other analyst) may use the model-driven modeling environment 516 to create pattern-based or freestyle user interfaces using simple drag-and-drop services. Because this development may be model-driven, the modeler can typically compose an application using models of business objects without having to write much, if any, code. In some cases, this example modeling environment 516 may provide a personalized, secure interface that helps unify enterprise applications, information, and processes into a coherent, role-based portal experience. Further, the modeling environment 516 may allow the developer to access and share information and applications in a collaborative environment. In this way, virtual collaboration rooms allow developers to work together efficiently, regardless of where they are located, and may enable powerful and immediate communication that crosses organizational boundaries while enforcing security requirements. Indeed, the modeling environment 516 may provide a shared set of services for finding, organizing, and accessing unstructured content stored in third-party repositories and content management systems across various networks 312. Classification tools may automate the organization of information, while subject-matter experts and content managers can publish information to distinct user audiences. Regardless of the particular implementation or architecture, this modeling environment 516 may allow the developer to easily model hosted business objects 140 using this model-driven approach.

In certain embodiments, the modeling environment 516 may implement or utilize a generic, declarative, and executable GUI language (generally described as XGL). This example XGL is generally independent of any particular GUI framework or runtime platform. Further, XGL is normally not dependent on characteristics of a target device on which the graphic user interface is to be displayed and may also be independent of any programming language. XGL is used to generate a generic representation (occasionally referred to as the XGL representation or XGL-compliant representation) for a design-time model representation. The XGL representation is thus typically a device-independent representation of a GUI. The XGL representation is declarative in that the representation does not depend on any particular GUI framework, runtime platform, device, or programming language. The XGL representation can be executable and therefore can unambiguously encapsulate execution semantics for the GUI described by a model representation. In short, models of different types can be transformed to XGL representations.

The XGL representation may be used for generating representations of various different GUIs and supports various GUI features including full windowing and componentization support, rich data visualizations and animations, rich modes of data entry and user interactions, and flexible connectivity to any complex application data services. While a specific embodiment of XGL is discussed, various other types of XGLs may also be used in alternative embodiments. In other words, it will be understood that XGL is used for example description only and may be read to include any abstract or modeling language that can be generic, declarative, and executable.

Turning to the illustrated embodiment in FIG. 5A, modeling tool 340 may be used by a GUI designer or business analyst during the application design phase to create a model representation 502 for a GUI application. It will be understood that modeling environment 516 may include or be compatible with various different modeling tools 340 used to generate model representation 502. This model representation 502 may be a machine-readable representation of an application or a domain specific model. Model representation 502 generally encapsulates various design parameters related to the GUI such as GUI components, dependencies between the GUI components, inputs and outputs, and the like. Put another way, model representation 502 provides a form in which the one or more models can be persisted and transported, and possibly handled by various tools such as code generators, runtime interpreters, analysis and validation tools, merge tools, and the like. In one embodiment, model representation 502 maybe a collection of XML documents with a well-formed syntax.

Illustrated modeling environment 516 also includes an abstract representation generator (or XGL generator) 504 operable to generate an abstract representation (for example, XGL representation or XGL-compliant representation) 506 based upon model representation 502. Abstract representation generator 504 takes model representation 502 as input and outputs abstract representation 506 for the model representation. Model representation 502 may include multiple instances of various forms or types depending on the tool/language used for the modeling. In certain cases, these various different model representations may each be mapped to one or more abstract representations 506. Different types of model representations may be transformed or mapped to XGL representations. For each type of model representation, mapping rules may be provided for mapping the model representation to the XGL representation 506. Different mapping rules may be provided for mapping a model representation to an XGL representation.

This XGL representation 506 that is created from a model representation may then be used for processing in the runtime environment. For example, the XGL representation 506 may be used to generate a machine-executable runtime GUI (or some other runtime representation) that may be executed by a target device. As part of the runtime processing, the XGL representation 506 may be transformed into one or more runtime representations, which may indicate source code in a particular programming language, machine-executable code for a specific runtime environment, executable GUI, and so forth, which may be generated for specific runtime environments and devices. Since the XGL representation 506, rather than the design-time model representation, is used by the runtime environment, the design-time model representation is decoupled from the runtime environment. The XGL representation 506 can thus serve as the common ground or interface between design-time user interface modeling tools and a plurality of user interface runtime frameworks. It provides a self-contained, closed, and deterministic definition of all aspects of a graphical user interface in a device-independent and programming-language independent manner. Accordingly, abstract representation 506 generated for a model representation 502 is generally declarative and executable in that it provides a representation of the GUI of model representation 502 that is not dependent on any device or runtime platform, is not dependent on any programming language, and unambiguously encapsulates execution semantics for the GUI. The execution semantics may include, for example, identification of various components of the GUI, interpretation of connections between the various GUI components, information identifying the order of sequencing of events, rules governing dynamic behavior of the GUI, rules governing handling of values by the GUI, and the like. The abstract representation 506 is also not GUI runtime-platform specific. The abstract representation 506 provides a self-contained, closed, and deterministic definition of all aspects of a graphical user interface that is device independent and language independent.

Abstract representation 506 is such that the appearance and execution semantics of a GUI generated from the XGL representation work consistently on different target devices irrespective of the GUI capabilities of the target device and the target device platform. For example, the same XGL representation may be mapped to appropriate GUIs on devices of differing levels of GUI complexity (i.e., the same abstract representation may be used to generate a GUI for devices that support simple GUIs and for devices that can support complex GUIs), the GUI generated by the devices are consistent with each other in their appearance and behavior.

Abstract representation generator 504 may be configured to generate abstract representation 506 for models of different types, which may be created using different modeling tools 340. It will be understood that modeling environment 516 may include some, none, or other sub-modules or components as those shown in this example illustration. In other words, modeling environment 516 encompasses the design-time environment (with or without the abstract generator or the various representations), a modeling toolkit (such as 340) linked with a developer's space, or any other appropriate software operable to decouple models created during design-time from the runtime environment. Abstract representation 506 provides an interface between the design time environment and the runtime environment. As shown, this abstract representation 506 may then be used by runtime processing.

As part of runtime processing, modeling environment 516 may include various runtime tools 508 and may generate different types of runtime representations based upon the abstract representation 506. Examples of runtime representations include device or language-dependent (or specific) source code, runtime platform-specific machine-readable code, GUIs for a particular target device, and the like. The runtime tools 508 may include compilers, interpreters, source code generators, and other such tools that are configured to generate runtime platform-specific or target device-specific runtime representations of abstract representation 506. The runtime tool 508 may generate the runtime representation from abstract representation 506 using specific rules that map abstract representation 506 to a particular type of runtime representation. These mapping rules may be dependent on the type of runtime tool, characteristics of the target device to be used for displaying the GUI, runtime platform, and/or other factors. Accordingly, mapping rules may be provided for transforming the abstract representation 506 to any number of target runtime representations directed to one or more target GUI runtime platforms. For example, XGL-compliant code generators may conform to semantics of XGL, as described below. XGL-compliant code generators may ensure that the appearance and behavior of the generated user interfaces is preserved across a plurality of target GUI frameworks, while accommodating the differences in the intrinsic characteristics of each and also accommodating the different levels of capability of target devices.

For example, as depicted in example FIG. 5A, an XGL-to-Java compiler 508A may take abstract representation 506 as input and generate Java code 510 for execution by a target device comprising a Java runtime 512. Java runtime 512 may execute Java code 510 to generate or display a GUI 514 on a Java-platform target device. As another example, an XGL-to-Flash compiler 508B may take abstract representation 506 as input and generate Flash code 526 for execution by a target device comprising a Flash runtime 518. Flash runtime 518 may execute Flash code 516 to generate or display a GUI 520 on a target device comprising a Flash platform. As another example, an XGL-to-DHTML (dynamic HTML) interpreter 508C may take abstract representation 506 as input and generate DHTML statements (instructions) on the fly which are then interpreted by a DHTML runtime 522 to generate or display a GUI 524 on a target device comprising a DHTML platform.

It should be apparent that abstract representation 506 may be used to generate GUIs for Extensible Application Markup Language (XAML) or various other runtime platforms and devices. The same abstract representation 506 may be mapped to various runtime representations and device-specific and runtime platform-specific GUIs. In general, in the runtime environment, machine executable instructions specific to a runtime environment may be generated based upon the abstract representation 506 and executed to generate a GUI in the runtime environment. The same XGL representation may be used to generate machine executable instructions specific to different runtime environments and target devices.

According to certain embodiments, the process of mapping a model representation 502 to an abstract representation 506 and mapping an abstract representation 506 to some runtime representation may be automated. For example, design tools may automatically generate an abstract representation for the model representation using XGL and then use the XGL abstract representation to generate GUIs that are customized for specific runtime environments and devices. As previously indicated, mapping rules may be provided for mapping model representations to an XGL representation. Mapping rules may also be provided for mapping an XGL representation to a runtime platform-specific representation.

Since the runtime environment uses abstract representation 506 rather than model representation 502 for runtime processing, the model representation 502 that is created during design-time is decoupled from the runtime environment. Abstract representation 506 thus provides an interface between the modeling environment and the runtime environment. As a result, changes may be made to the design time environment, including changes to model representation 502 or changes that affect model representation 502, generally to not substantially affect or impact the runtime environment or tools used by the runtime environment. Likewise, changes may be made to the runtime environment generally to not substantially affect or impact the design time environment. A designer or other developer can thus concentrate on the design aspects and make changes to the design without having to worry about the runtime dependencies such as the target device platform or programming language dependencies.

FIG. 5B depicts an example process for mapping a model representation 502 to a runtime representation using the example modeling environment 516 of FIG. 5A or some other modeling environment. Model representation 502 may comprise one or more model components and associated properties that describe a data object, such as hosted business objects and interfaces. As described above, at least one of these model components is based on or otherwise associated with these hosted business objects and interfaces. The abstract representation 506 is generated based upon model representation 502. Abstract representation 506 may be generated by the abstract representation generator 504. Abstract representation 506 comprises one or more abstract GUI components and properties associated with the abstract GUI components. As part of generation of abstract representation 506, the model GUI components and their associated properties from the model representation are mapped to abstract GUI components and properties associated with the abstract GUI components. Various mapping rules may be provided to facilitate the mapping. The abstract representation encapsulates both appearance and behavior of a GUI. Therefore, by mapping model components to abstract components, the abstract representation not only specifies the visual appearance of the GUI but also the behavior of the GUI, such as in response to events whether clicking/dragging or scrolling, interactions between GUI components and such.

One or more runtime representations 550a, including GUIs for specific runtime environment platforms, may be generated from abstract representation 506. A device-dependent runtime representation may be generated for a particular type of target device platform to be used for executing and displaying the GUI encapsulated by the abstract representation. The GUIs generated from abstract representation 506 may comprise various types of GUI elements such as buttons, windows, scrollbars, input boxes, etc. Rules may be provided for mapping an abstract representation to a particular runtime representation. Various mapping rules may be provided for different runtime environment platforms.

Methods and systems consistent with the subject matter described herein provide and use interfaces 320 derived from the business object model 318 suitable for use with more than one business area, for example different departments within a company such as finance, or marketing. Also, they are suitable across industries and across businesses. Interfaces 320 are used during an end-to-end business transaction to transfer business process information in an application-independent manner. For example the interfaces can be used for fulfilling a sales order.

1. Message Overview

To perform an end-to-end business transaction, consistent interfaces are used to create business documents that are sent within messages between heterogeneous programs or modules.

a) Message Categories

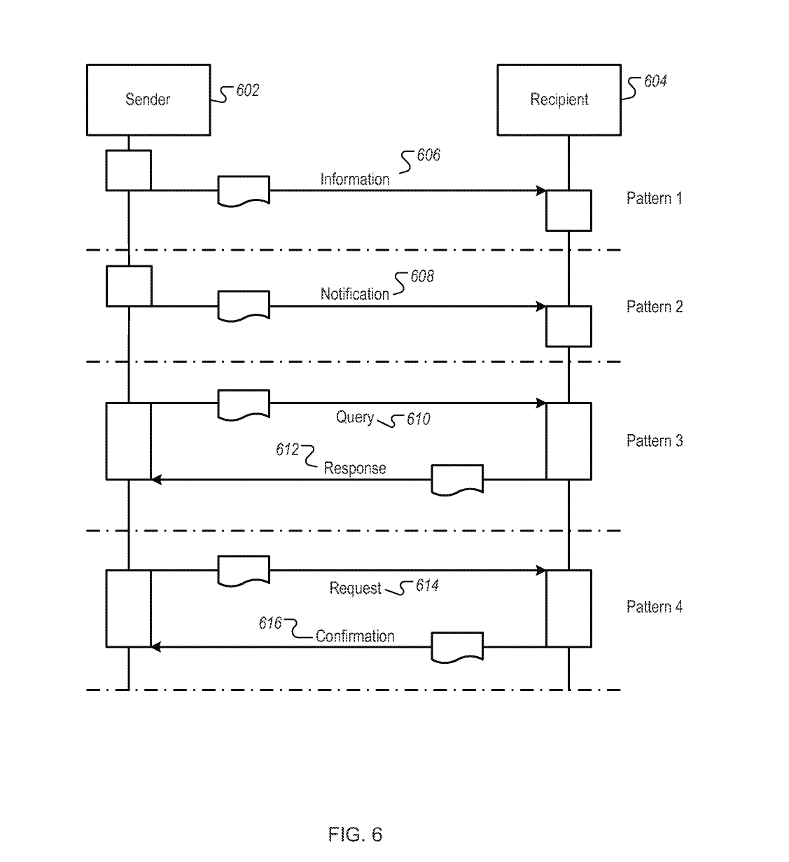

As depicted in FIG. 6, the communication between a sender 602 and a recipient 604 can be broken down into basic categories that describe the type of the information exchanged and simultaneously suggest the anticipated reaction of the recipient 604. A message category is a general business classification for the messages. Communication is sender-driven. In other words, the meaning of the message categories is established or formulated from the perspective of the sender 602. The message categories include information 606, notification 608, query 610, response 612, request 614, and confirmation 616.

### (1) Information

Information 606 is a message sent from a sender 602 to a recipient 604 concerning a condition or a statement of affairs. No reply to information is expected. Information 606 is sent to make business partners or business applications aware of a situation. Information 606 is not compiled to be application-specific. Examples of “information” are an announcement, advertising, a report, planning information, and a message to the business warehouse.

### (2) Notification

A notification 608 is a notice or message that is geared to a service. A sender 602 sends the notification 608 to a recipient 604. No reply is expected for a notification. For example, a billing notification relates to the preparation of an invoice while a dispatched delivery notification relates to preparation for receipt of goods.

### (3) Query

A query 610 is a question from a sender 602 to a recipient 604 to which a response 612 is expected. A query 610 implies no assurance or obligation on the part of the sender 602. Examples of a query 610 are whether space is available on a specific flight or whether a specific product is available. These queries do not express the desire for reserving the flight or purchasing the product.

### (4) Response

A response 612 is a reply to a query 610. The recipient 604 sends the response 612 to the sender 602. A response 612 generally implies no assurance or obligation on the part of the recipient 604. The sender 602 is not expected to reply. Instead, the process is concluded with the response 612. Depending on the business scenario, a response 612 also may include a commitment, i.e., an assurance or obligation on the part of the recipient 604. Examples of responses 612 are a response stating that space is available on a specific flight or that a specific product is available. With these responses, no reservation was made.

### (5) Request

A request 614 is a binding requisition or requirement from a sender 602 to a recipient 604. Depending on the business scenario, the recipient 604 can respond to a request 614 with a confirmation 616. The request 614 is binding on the sender 602. In making the request 614, the sender 602 assumes, for example, an obligation to accept the services rendered in the request 614 under the reported conditions. Examples of a request 614 are a parking ticket, a purchase order, an order for delivery and a job application.

### (6) Confirmation

A confirmation 616 is a binding reply that is generally made to a request 614. The recipient 604 sends the confirmation 616 to the sender 602. The information indicated in a confirmation 616, such as deadlines, products, quantities and prices, can deviate from the information of the preceding request 614. A request 614 and confirmation 616 may be used in negotiating processes. A negotiating process can consist of a series of several request 614 and confirmation 616 messages. The confirmation 616 is binding on the recipient 604. For example, 100 units of X may be ordered in a purchase order request; however, only the delivery of 80 units is confirmed in the associated purchase order confirmation.

b) Message Choreography

A message choreography is a template that specifies the sequence of messages between business entities during a given transaction. The sequence with the messages contained in it describes in general the message “lifecycle” as it proceeds between the business entities. If messages from a choreography are used in a business transaction, they appear in the transaction in the sequence determined by the choreography. This illustrates the template character of a choreography, i.e., during an actual transaction, it is not necessary for all messages of the choreography to appear. Those messages that are contained in the transaction, however, follow the sequence within the choreography. A business transaction is thus a derivation of a message choreography. The choreography makes it possible to determine the structure of the individual message types more precisely and distinguish them from one another.

2. Components of the Business Object Model

The overall structure of the business object model ensures the consistency of the interfaces that are derived from the business object model. The derivation ensures that the same business-related subject matter or concept is represented and structured in the same way in all interfaces.

The business object model defines the business-related concepts at a central location for a number of business transactions. In other words, it reflects the decisions made about modeling the business entities of the real world acting in business transactions across industries and business areas. The business object model is defined by the business objects and their relationship to each other (the overall net structure).

Each business object is generally a capsule with an internal hierarchical structure, behavior offered by its operations, and integrity constraints. Business objects are semantically disjoint, i.e., the same business information is represented once. In the business object model, the business objects are arranged in an ordering framework. From left to right, they are arranged according to their existence dependency to each other. For example, the customizing elements may be arranged on the left side of the business object model, the strategic elements may be arranged in the center of the business object model, and the operative elements may be arranged on the right side of the business object model. Similarly, the business objects are arranged from the top to the bottom based on defined order of the business areas, e.g., finance could be arranged at the top of the business object model with CRM below finance and SRM below CRM.

To ensure the consistency of interfaces, the business object model may be built using standardized data types as well as packages to group related elements together, and package templates and entity templates to specify the arrangement of packages and entities within the structure.

a) Data Types

Data types are used to type object entities and interfaces with a structure. This typing can include business semantic. Such data types may include those generally described at pages 96 through 1642 (which are incorporated by reference herein) of U.S. patent application Ser. No. 11/803,178, filed on May 11, 2007 and entitled “Consistent Set Of Interfaces Derived From A Business Object Model”. For example, the data type BusinessTransactionDocumentID is a unique identifier for a document in a business transaction. Also, as an example, Data type BusinessTransactionDocumentParty contains the information that is exchanged in business documents about a party involved in a business transaction, and includes the party's identity, the party's address, the party's contact person and the contact person's address. BusinessTransactionDocumentParty also includes the role of the party, e.g., a buyer, seller, product recipient, or vendor.

The data types are based on Core Component Types (“CCTs”), which themselves are based on the World Wide Web Consortium (“W3C”) data types. “Global” data types represent a business situation that is described by a fixed structure. Global data types include both context-neutral generic data types (“GDTs”) and context-based context data types (“CDTs”). GDTs contain business semantics, but are application-neutral, i.e., without context. CDTs, on the other hand, are based on GDTs and form either a use-specific view of the GDTs, or a context-specific assembly of GDTs or CDTs. A message is typically constructed with reference to a use and is thus a use-specific assembly of GDTs and CDTs. The data types can be aggregated to complex data types.

To achieve a harmonization across business objects and interfaces, the same subject matter is typed with the same data type. For example, the data type “GeoCoordinates” is built using the data type “Measure” so that the measures in a GeoCoordinate (i.e., the latitude measure and the longitude measure) are represented the same as other “Measures” that appear in the business object model.

b) Entities

Entities are discrete business elements that are used during a business transaction. Entities are not to be confused with business entities or the components that interact to perform a transaction. Rather, “entities” are one of the layers of the business object model and the interfaces. For example, a Catalogue entity is used in a Catalogue Publication Request and a Purchase Order is used in a Purchase Order Request. These entities are created using the data types defined above to ensure the consistent representation of data throughout the entities.

c) Packages

Packages group the entities in the business object model and the resulting interfaces into groups of semantically associated information. Packages also may include “sub”-packages, i.e., the packages may be nested.

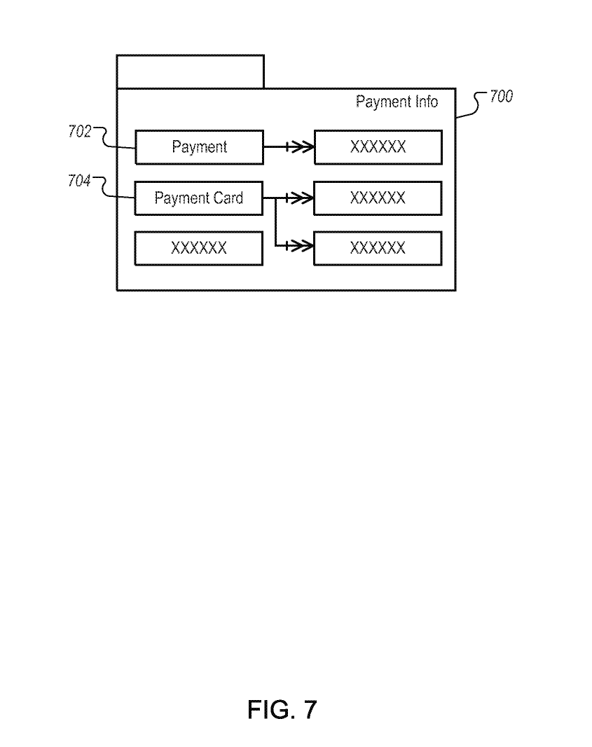

Packages may group elements together based on different factors, such as elements that occur together as a rule with regard to a business-related aspect. For example, as depicted in FIG. 7, in a Purchase Order, different information regarding the purchase order, such as the type of payment 702, and payment card 704, are grouped together via the PaymentInformation package 700.

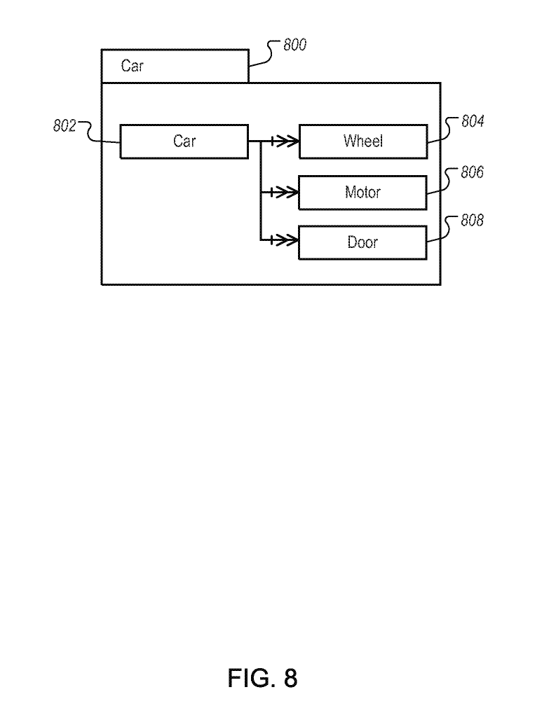

Packages also may combine different components that result in a new object. For example, as depicted in FIG. 8, the components wheels 804, motor 806, and doors 808 are combined to form a composition “Car” 802. The “Car” package 800 includes the wheels, motor and doors as well as the composition “Car.”

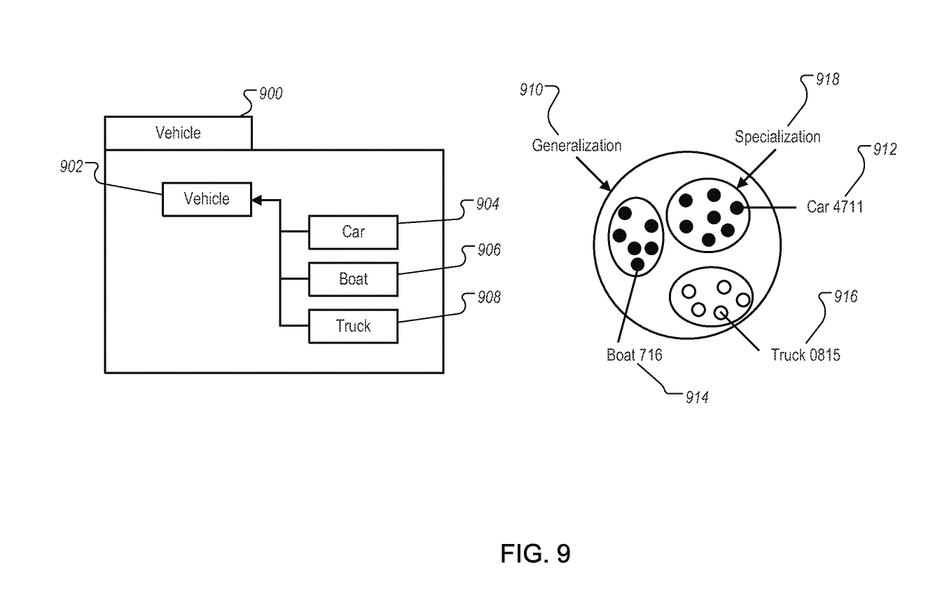

Another grouping within a package may be subtypes within a type. In these packages, the components are specialized forms of a generic package. For example, as depicted in FIG. 9, the components Car 904, Boat 906, and Truck 908 can be generalized by the generic term Vehicle 902 in Vehicle package 900. Vehicle in this case is the generic package 910, while Car 912, Boat 914, and Truck 916 are the specializations 918 of the generalized vehicle 910.

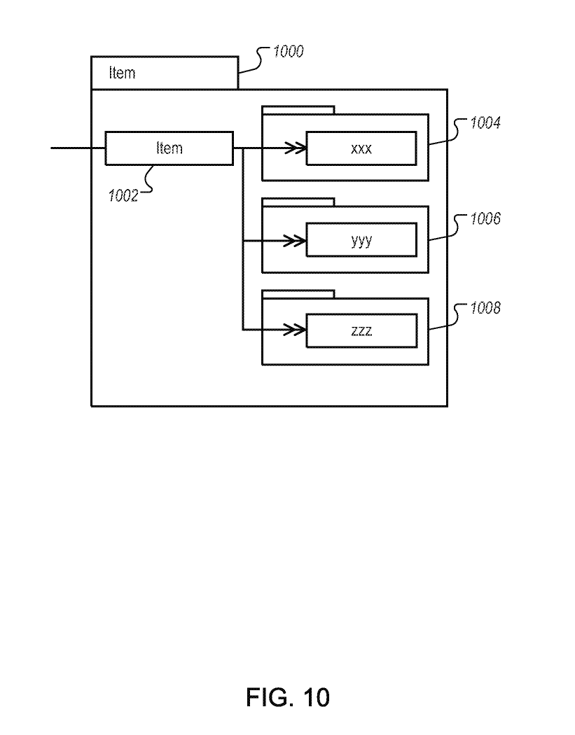

Packages also may be used to represent hierarchy levels. For example, as depicted in FIG. 10, the Item Package 1000 includes Item 1002 with subitem xxx 1004, subitem yyy 1006, and subitem zzz 1008.

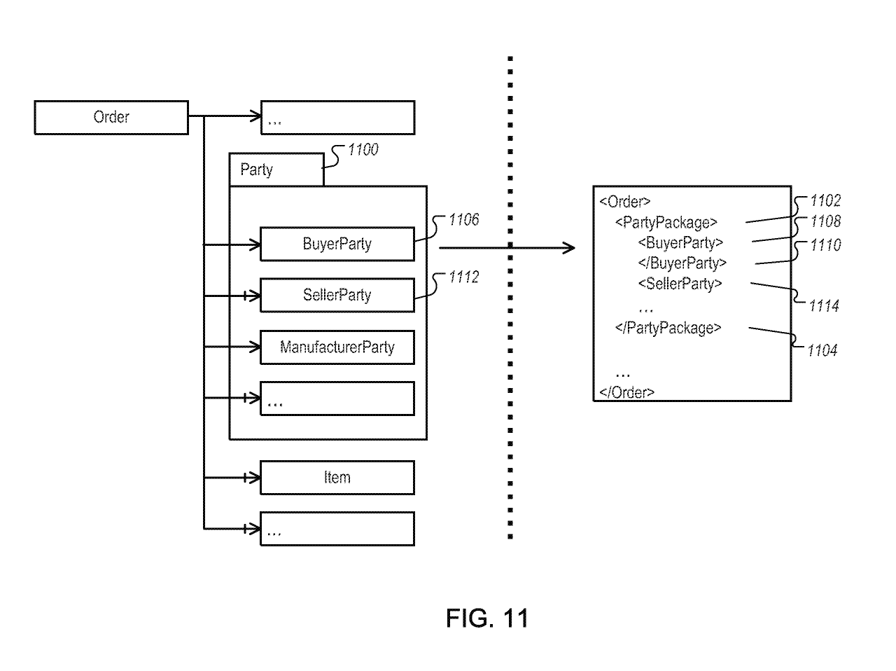

Packages can be represented in the XML schema as a comment. One advantage of this grouping is that the document structure is easier to read and is more understandable. The names of these packages are assigned by including the object name in brackets with the suffix “Package.” For example, as depicted in FIG. 11, Party package 1100 is enclosed by <PartyPackage> 1102 and </PartyPackage> 1104. Party package 1100 illustratively includes a Buyer Party 1106, identified by <BuyerParty> 1108 and </BuyerParty> 1110, and a Seller Party 1112, identified by <SellerParty> 1114 and </SellerParty>, etc.

d) Relationships

Relationships describe the interdependencies of the entities in the business object model, and are thus an integral part of the business object model.

### (1) Cardinality of Relationships

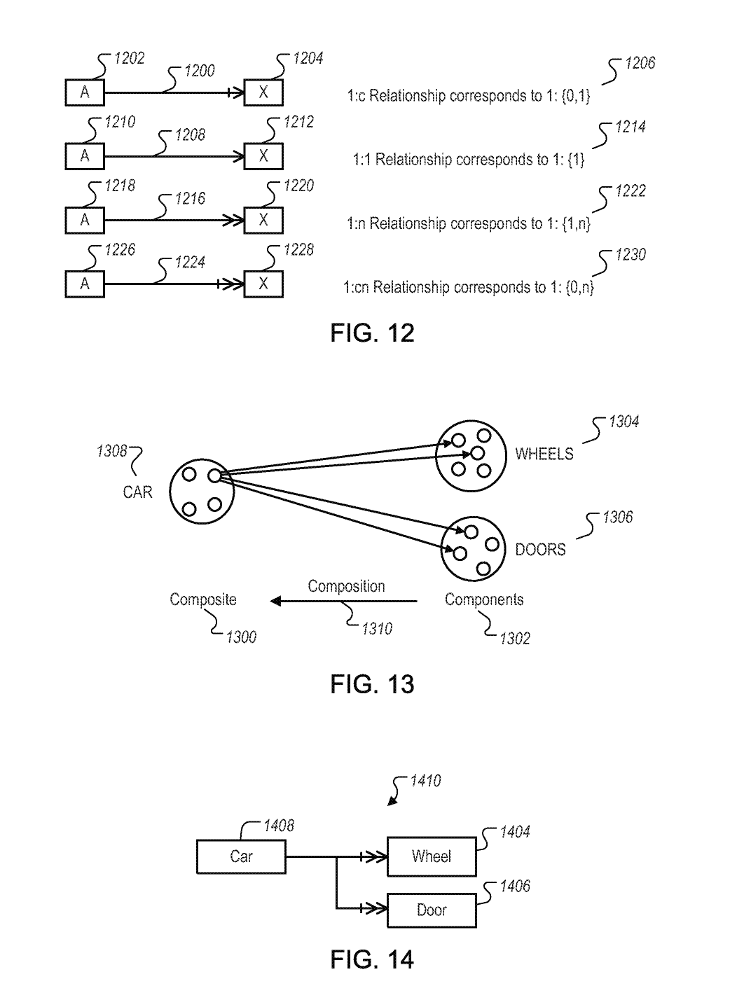

FIG. 12 depicts a graphical representation of the cardinalities between two entities. The cardinality between a first entity and a second entity identifies the number of second entities that could possibly exist for each first entity. Thus, a 1:c cardinality 1200 between entities A 1202 and X 1204 indicates that for each entity A 1202, there is either one or zero 1206 entity X 1204. A 1:1 cardinality 1208 between entities A 1210 and X 1212 indicates that for each entity A 1210, there is exactly one 1214 entity X 1212. A 1:n cardinality 1216 between entities A 1218 and X 1220 indicates that for each entity A 1218, there are one or more 1222 entity Xs 1220. A 1:cn cardinality 1224 between entities A 1226 and X 1228 indicates that for each entity A 1226, there are any number 1230 of entity Xs 1228 (i.e., 0 through n Xs for each A).

### (2) Types of Relationships

### (a) Composition

A composition or hierarchical relationship type is a strong whole-part relationship which is used to describe the structure within an object. The parts, or dependent entities, represent a semantic refinement or partition of the whole, or less dependent entity. For example, as depicted in FIG. 13, the components 1302, wheels 1304, and doors 1306 may be combined to form the composite 1300 “Car” 1308 using the composition 1310. FIG. 14 depicts a graphical representation of the composition 1410 between composite Car 1408 and components wheel 1404 and door 1406.

### (b) Aggregation

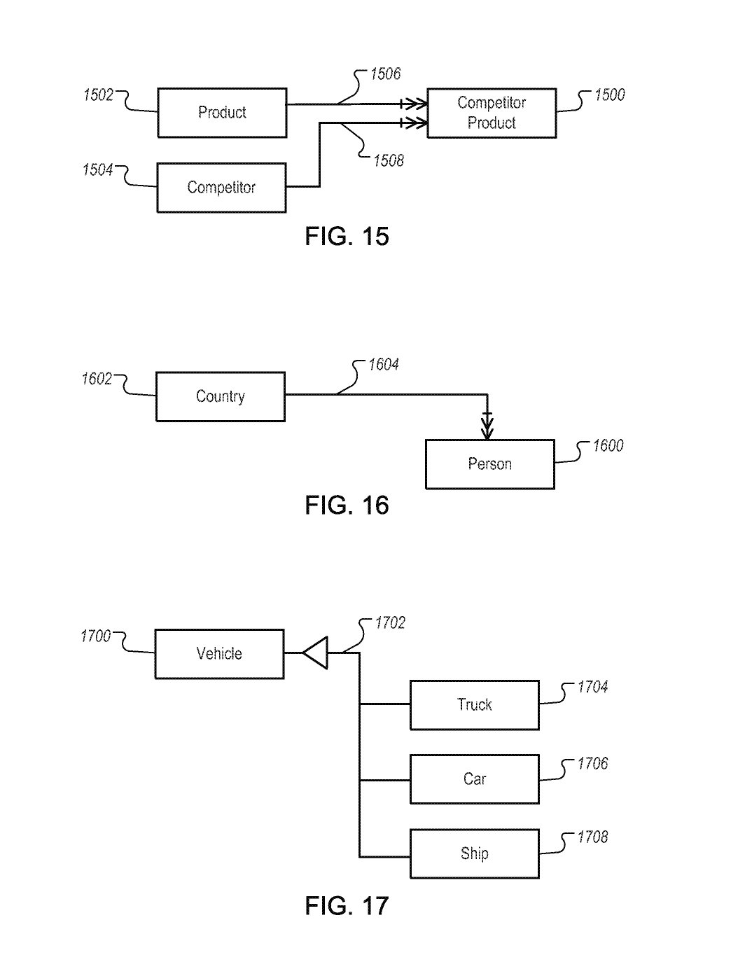

An aggregation or an aggregating relationship type is a weak whole-part relationship between two objects. The dependent object is created by the combination of one or several less dependent objects. For example, as depicted in FIG. 15, the properties of a competitor product 1500 are determined by a product 1502 and a competitor 1504. A hierarchical relationship 1506 exists between the product 1502 and the competitor product 1500 because the competitor product 1500 is a component of the product 1502. Therefore, the values of the attributes of the competitor product 1500 are determined by the product 1502. An aggregating relationship 1508 exists between the competitor 1504 and the competitor product 1500 because the competitor product 1500 is differentiated by the competitor 1504. Therefore the values of the attributes of the competitor product 1500 are determined by the competitor 1504.

### (c) Association

An association or a referential relationship type describes a relationship between two objects in which the dependent object refers to the less dependent object. For example, as depicted in FIG. 16, a person 1600 has a nationality, and thus, has a reference to its country 1602 of origin. There is an association 1604 between the country 1602 and the person 1600. The values of the attributes of the person 1600 are not determined by the country 1602.

### (3) Specialization

Entity types may be divided into subtypes based on characteristics of the entity types. For example, FIG. 17 depicts an entity type “vehicle” 1700 specialized 1702 into subtypes “truck” 1704, “car” 1706, and “ship” 1708. These subtypes represent different aspects or the diversity of the entity type.

Subtypes may be defined based on related attributes. For example, although ships and cars are both vehicles, ships have an attribute, “draft,” that is not found in cars. Subtypes also may be defined based on certain methods that can be applied to entities of this subtype and that modify such entities. For example, “drop anchor” can be applied to ships. If outgoing relationships to a specific object are restricted to a subset, then a subtype can be defined which reflects this subset.

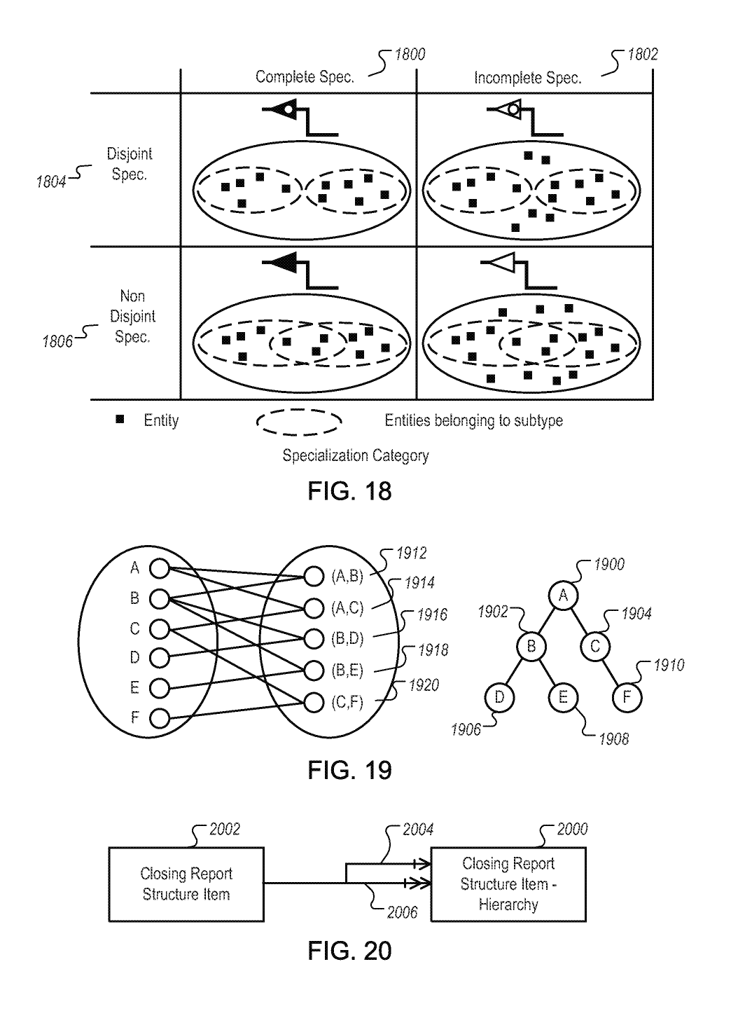

As depicted in FIG. 18, specializations may further be characterized as complete specializations 1800 or incomplete specializations 1802. There is a complete specialization 1800 where each entity of the generalized type belongs to at least one subtype. With an incomplete specialization 1802, there is at least one entity that does not belong to a subtype. Specializations also may be disjoint 1804 or nondisjoint 1806. In a disjoint specialization 1804, each entity of the generalized type belongs to a maximum of one subtype. With a nondisjoint specialization 1806, one entity may belong to more than one subtype. As depicted in FIG. 18, four specialization categories result from the combination of the specialization characteristics.

e) Structural Patterns

### (1) Item

An item is an entity type which groups together features of another entity type. Thus, the features for the entity type chart of accounts are grouped together to form the entity type chart of accounts item. For example, a chart of accounts item is a category of values or value flows that can be recorded or represented in amounts of money in accounting, while a chart of accounts is a superordinate list of categories of values or value flows that is defined in accounting.

The cardinality between an entity type and its item is often either 1:n or 1:cn. For example, in the case of the entity type chart of accounts, there is a hierarchical relationship of the cardinality 1:n with the entity type chart of accounts item since a chart of accounts has at least one item in all cases.

### (2) Hierarchy

A hierarchy describes the assignment of subordinate entities to superordinate entities and vice versa, where several entities of the same type are subordinate entities that have, at most, one directly superordinate entity. For example, in the hierarchy depicted in FIG. 19, entity B 1902 is subordinate to entity A 1900, resulting in the relationship (A,B) 1912. Similarly, entity C 1904 is subordinate to entity A 1900, resulting in the relationship (A,C) 1914. Entity D 1906 and entity E 1908 are subordinate to entity B 1902, resulting in the relationships (B,D) 1916 and (B,E) 1918, respectively. Entity F 1910 is subordinate to entity C 1904, resulting in the relationship (C,F) 1920.

Because each entity has at most one superordinate entity, the cardinality between a subordinate entity and its superordinate entity is 1:c. Similarly, each entity may have 0, 1 or many subordinate entities. Thus, the cardinality between a superordinate entity and its subordinate entity is 1:cn. FIG. 20 depicts a graphical representation of a Closing Report Structure Item hierarchy 2000 for a Closing Report Structure Item 2002. The hierarchy illustrates the 1:c cardinality 2004 between a subordinate entity and its superordinate entity, and the 1:cn cardinality 2006 between a superordinate entity and its subordinate entity.

3. Creation of the Business Object Model

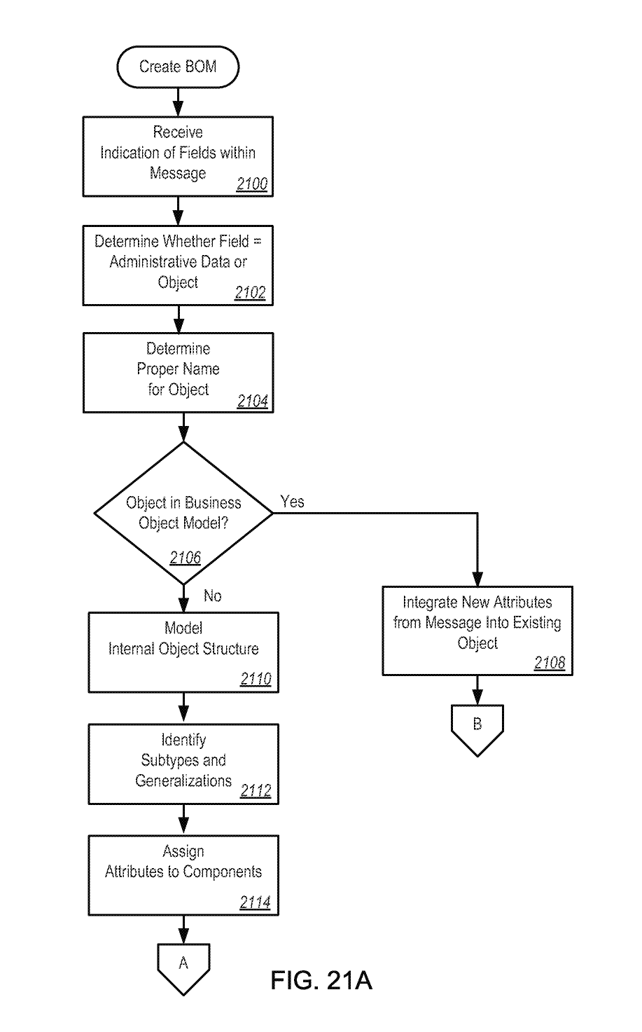

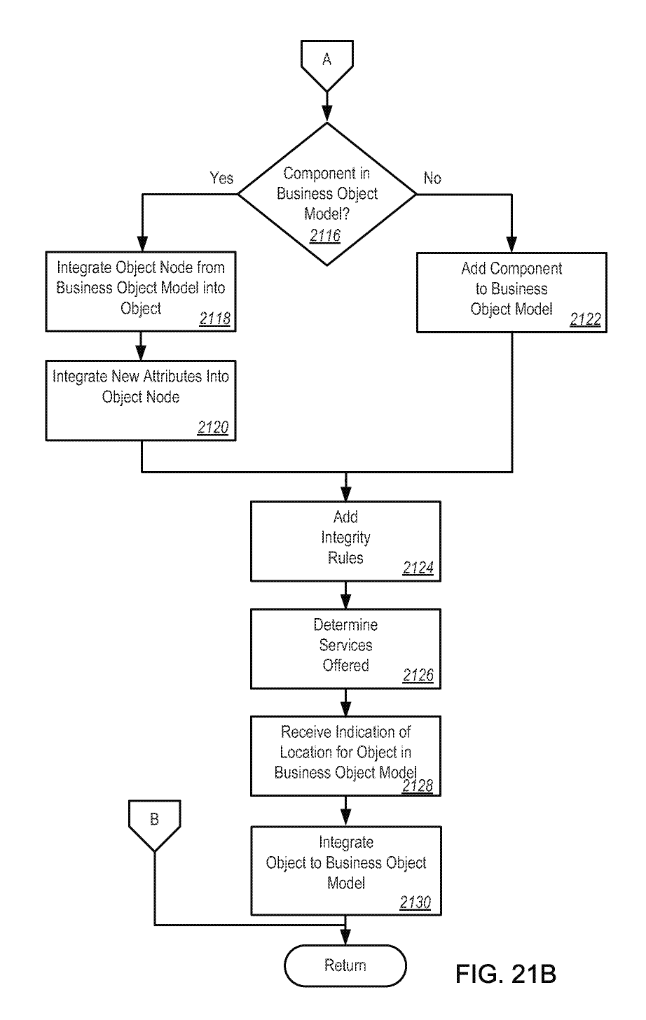

FIGS. 21A-B depict the steps performed using methods and systems consistent with the subject matter described herein to create a business object model. Although some steps are described as being performed by a computer, these steps may alternatively be performed manually, or computer-assisted, or any combination thereof. Likewise, although some steps are described as being performed by a computer, these steps may also be computer-assisted, or performed manually, or any combination thereof.

As discussed above, the designers create message choreographies that specify the sequence of messages between business entities during a transaction. After identifying the messages, the developers identify the fields contained in one of the messages (step 2100, FIG. 21A). The designers then determine whether each field relates to administrative data or is part of the object (step 2102). Thus, the first eleven fields identified below in the left column are related to administrative data, while the remaining fields are part of the object.

| | |
|---|---|
| MessageID | Admin |
| ReferenceID | |
| CreationDate | |
| SenderID | |
| AdditionalSenderID | |
| ContactPersonID | |
| SenderAddress | |
| RecipientID | |
| AdditionalRecipientID | |
| ContactPersonID | |
| RecipientAddress | |
| ID | MainObject |
| AdditionalID | |
| PostingDate | |
| LastChangeDate | |
| AcceptanceStatus | |
| Note | |
| CompleteTransmission Indicator | |
| Buyer | |
| BuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobileNumber | |
| Facsimile | |
| Email | |
| Seller | |
| SellerAddress | |
| Location | |
| LocationType | |
| DeliveryItemGroupID | |
| DeliveryPriority | |
| DeliveryCondition | |
| TransferLocation | |
| NumberofPartialDelivery | |
| QuantityTolerance | |
| MaximumLeadTime | |
| TransportServiceLevel | |
| TranportCondition | |
| TransportDescription | |
| CashDiscountTerms | |
| PaymentForm | |
| PaymentCardID | |
| PaymentCardReferenceID | |
| SequenceID | |
| Holder | |
| ExpirationDate | |
| AttachmentID | |
| AttachmentFilename | |
| DescriptionofMessage | |
| ConfirmationDescriptionof Message | |
| FollowUpActivity | |
| ItemID | |
| ParentItemID | |
| HierarchyType | |
| ProductID | |
| ProductType | |
| ProductNote | |
| ProductCategoryID | |
| Amount | |
| BaseQuantity | |
| ConfirmedAmount | |
| ConfirmedBaseQuantity | |
| ItemBuyer | |
| ItemBuyerOrganisationName | |
| Person Name | |
| FunctionalTitle | |
| DepartmentName | |
| CountryCode | |
| StreetPostalCode | |
| POBox Postal Code | |
| Company Postal Code | |
| City Name | |
| DistrictName | |
| PO Box ID | |
| PO Box Indicator | |
| PO Box Country Code | |
| PO Box Region Code | |
| PO Box City Name | |
| Street Name | |
| House ID | |
| Building ID | |
| Floor ID | |
| Room ID | |
| Care Of Name | |
| AddressDescription | |
| Telefonnumber | |
| MobilNumber | |
| Facsimile | |
| Email | |
| ItemSeller | |
| ItemSellerAddress | |
| ItemLocation | |
| ItemLocationType | |
| ItemDeliveryItemGroupID | |
| ItemDeliveryPriority | |
| ItemDeliveryCondition | |
| ItemTransferLocation | |
| ItemNumberofPartialDelivery | |
| ItemQuantityTolerance | |
| ItemMaximumLeadTime | |
| ItemTransportServiceLevel | |
| ItemTranportCondition | |
| ItemTransportDescription | |
| ContractReference | |
| QuoteReference | |
| CatalogueReference | |
| ItemAttachmentID | |
| ItemAttachmentFilename | |
| ItemDescription | |
| ScheduleLineID | |
| DeliveryPeriod | |
| Quantity | |
| ConfirmedScheduleLineID | |
| ConfirmedDeliveryPeriod | |
| ConfirmedQuantity | |

Next, the designers determine the proper name for the object according to the ISO 11179 naming standards (step 2104). In the example above, the proper name for the “Main Object” is “Purchase Order.” After naming the object, the system that is creating the business object model determines whether the object already exists in the business object model (step 2106). If the object already exists, the system integrates new attributes from the message into the existing object (step 2108), and the process is complete.

If at step 2106 the system determines that the object does not exist in the business object model, the designers model the internal object structure (step 2110). To model the internal structure, the designers define the components. For the above example, the designers may define the components identified below.

| | | | |
|---|---|---|---|
| ID | PurchaseOrder | | |
| AdditionalID | | | |
| PostingDate | | | |
| LastChangeDate | | | |
| AcceptanceStatus | | | |
| Note | | | |
| CompleteTransmissionIndicator | | | |
| Buyer | | Buyer | |
| BuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| DistrictName | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobileNumber | | | |
| Facsimile | | | |
| Email | | | |
| Seller | | Seller | |
| SellerAddress | | | |
| Location | | Location | |
| LocationType | | | |
| DeliveryItemGroupID | | DeliveryTerms | |
| DeliveryPriority | | | |
| DeliveryCondition | | | |
| TransferLocation | | | |
| NumberofPartialDelivery | | | |
| QuantityTolerance | | | |
| MaximumLeadTime | | | |
| TransportServiceLevel | | | |
| TranportCondition | | | |
| TransportDescription | | | |
| CashDiscountTerms | | | |
| PaymentForm | | Payment | |
| PaymentCardID | | | |
| PaymentCardReferenceID | | | |
| SequenceID | | | |
| Holder | | | |
| ExpirationDate | | | |
| AttachmentID | | | |
| AttachmentFilename | | | |
| DescriptionofMessage | | | |
| ConfirmationDescriptionofMessage | | | |
| FollowUpActivity | | | |
| ItemID | | Purchase Order Item | |
| ParentItemID | | | |
| HierarchyType | | | |
| ProductID | | | Product |
| ProductType | | | |
| ProductNote | | | |
| ProductCategoryID | | | ProductCategory |
| Amount | | | |
| BaseQuantity | | | |
| ConfirmedAmount | | | |
| ConfirmedBaseQuantity | | | |
| ItemBuyer | | | Buyer |
| ItemBuyerOrganisationName | | | |
| Person Name | | | |
| FunctionalTitle | | | |
| DepartmentName | | | |
| CountryCode | | | |
| StreetPostalCode | | | |
| POBox Postal Code | | | |
| Company Postal Code | | | |
| City Name | | | |
| District Name | | | |
| PO Box ID | | | |
| PO Box Indicator | | | |
| PO Box Country Code | | | |
| PO Box Region Code | | | |
| PO Box City Name | | | |
| Street Name | | | |
| House ID | | | |
| Building ID | | | |
| Floor ID | | | |
| Room ID | | | |
| Care Of Name | | | |
| AddressDescription | | | |
| Telefonnumber | | | |
| MobilNumber | | | |
| Facsimile | | | |
| Email | | | |
| ItemSeller | | | Seller |
| ItemSellerAddress | | | |
| ItemLocation | | | Location |
| ItemLocationType | | | |
| ItemDeliveryItemGroupID | | | |
| ItemDeliveryPriority | | | |
| ItemDeliveryCondition | | | |
| ItemTransferLocation | | | |
| ItemNumberofPartialDelivery | | | |
| ItemQuantityTolerance | | | |
| ItemMaximumLeadTime | | | |
| ItemTransportServiceLevel | | | |
| ItemTranportCondition | | | |
| ItemTransportDescription | | | |
| ContractReference | | | Contract |
| QuoteReference | | | Quote |
| CatalogueReference | | | Catalogue |
| ItemAttachmentID | | | |
| ItemAttachmentFilename | | | |
| ItemDescription | | | |
| ScheduleLineID | | | |
| DeliveryPeriod | | | |
| Quantity | | | |
| ConfirmedScheduleLineID | | | |
| ConfirmedDeliveryPeriod | | | |
| ConfirmedQuantity | | | |

During the step of modeling the internal structure, the designers also model the complete internal structure by identifying the compositions of the components and the corresponding cardinalities, as shown below.

| | | | | |
|---|---|---|---|---|
| PurchaseOrder | | | | 1 |
| | Buyer | | | 0 . . . 1 |
| | | Address | | 0 . . . 1 |
| | | ContactPerson | | 0 . . . 1 |
| | | | Address | 0 . . . 1 |
| | Seller | | | 0 . . . 1 |
| | Location | | | 0 . . . 1 |
| | | Address | | 0 . . . 1 |
| | DeliveryTerms | | | 0 . . . 1 |
| | | Incoterms | | 0 . . . 1 |
| | | PartialDelivery | | 0 . . . 1 |
| | | QuantityTolerance | | 0 . . . 1 |
| | | Transport | | 0 . . . 1 |
| | CashDiscountTerms | | | 0 . . . 1 |
| | | MaximumCashDiscount | | 0 . . . 1 |
| | | NormalCashDiscount | | 0 . . . 1 |
| | PaymentForm | | | 0 . . . 1 |
| | | PaymentCard | | 0 . . . 1 |
| | Attachment | | | 0 . . . n |
| | Description | | | 0 . . . 1 |
| | ConfirmationDescription | | | 0 . . . 1 |
| | Item | | | 0 . . . n |
| | | HierarchyRelationship | | 0 . . . 1 |
| | | Product | | 0 . . . 1 |
| | | ProductCategory | | 0 . . . 1 |
| | | Price | | 0 . . . 1 |
| | | | NetunitPrice | 0 . . . 1 |
| | | ConfirmedPrice | | 0 . . . 1 |
| | | | NetunitPrice | 0 . . . 1 |
| | | Buyer | | 0 . . . 1 |
| | | Seller | | 0 . . . 1 |
| | | Location | | 0 . . . 1 |
| | | DeliveryTerms | | 0 . . . 1 |
| | | Attachment | | 0 . . . n |
| | | Description | | 0 . . . 1 |
| | | ConfirmationDescription | | 0 . . . 1 |
| | | ScheduleLine | | 0 . . . n |
| | | | DeliveryPeriod | 1 |
| | | ConfirmedScheduleLine | | 0 . . . n |

After modeling the internal object structure, the developers identify the subtypes and generalizations for all objects and components (step 2112). For example, the Purchase Order may have subtypes Purchase Order Update, Purchase Order Cancellation and Purchase Order Information. Purchase Order Update may include Purchase Order Request, Purchase Order Change, and Purchase Order Confirmation. Moreover, Party may be identified as the generalization of Buyer and Seller. The subtypes and generalizations for the above example are shown below.

| | | | | | |
|---|---|---|---|---|---|
| PurchaseOrder | | | | | 1 |
| | PurchaseOrder- | | | | |
| | Update | | | | |
| | | PurchaseOrder Request | | | |
| | | PurchaseOrder Change | | | |
| | | PurchaseOrder- | | | |
| | | Confirmation | | | |
| | PurchaseOrder- | | | | |
| | Cancellation | | | | |
| | PurchaseOrder- | | | | |
| | Information | | | | |
| | Party | | | | |
| | | BuyerParty | | | 0 . . . 1 |
| | | | Address | | 0 . . . 1 |
| | | | ContactPerson | | 0 . . . 1 |
| | | | | Address | 0 . . . 1 |
| | | SellerParty | | | 0 . . . 1 |
| | Location | | | | |
| | | ShipToLocation | | | 0 . . . 1 |
| | | | Address | | 0 . . . 1 |
| | | ShipFromLocation | | | 0 . . . 1 |
| | | | Address | | 0 . . . 1 |
| | DeliveryTerms | | | | 0 . . . 1 |
| | | Incoterms | | | 0 . . . 1 |
| | | PartialDelivery | | | 0 . . . 1 |
| | | QuantityTolerance | | | 0 . . . 1 |
| | | Transport | | | 0 . . . 1 |
| | CashDiscount- | | | | 0 . . . 1 |
| | Terms | | | | |
| | | MaximumCash Discount | | | 0 . . . 1 |
| | | NormalCashDiscount | | | 0 . . . 1 |
| | PaymentForm | | | | 0 . . . 1 |
| | | PaymentCard | | | 0 . . . 1 |
| | Attachment | | | | 0 . . . n |
| | Description | | | | 0 . . . 1 |
| | Confirmation- | | | | 0 . . . 1 |
| | Description | | | | |
| | Item | | | | 0 . . . n |
| | | HierarchyRelationship | | | 0 . . . 1 |
| | | Product | | | 0 . . . 1 |
| | | ProductCategory | | | 0 . . . 1 |
| | | Price | | | 0 . . . 1 |
| | | | NetunitPrice | | 0 . . . 1 |
| | | ConfirmedPrice | | | 0 . . . 1 |
| | | | NetunitPrice | | 0 . . . 1 |
| | | Party | | | |
| | | | BuyerParty | | 0 . . . 1 |
| | | | SellerParty | | 0 . . . 1 |
| | | Location | | | |
| | | | ShipTo | | 0 . . . 1 |
| | | | Location | | |
| | | | ShipFrom | | 0 . . . 1 |
| | | | Location | | |
| | | DeliveryTerms | | | 0 . . . 1 |
| | | Attachment | | | 0 . . . n |
| | | Description | | | 0 . . . 1 |
| | | Confirmation- | | | 0 . . . 1 |
| | | Description | | | |
| | | ScheduleLine | | | 0 . . . n |
| | | | Delivery | | 1 |
| | | | Period | | |
| | | ConfirmedScheduleLine | | | 0 . . . n |

After identifying the subtypes and generalizations, the developers assign the attributes to these components (step 2114). The attributes for a portion of the components are shown below.

| | | | | |
|---|---|---|---|---|
| Purchase- | | | | 1 |
| Order | | | | |
| | ID | | | 1 |
| | SellerID | | | 0 . . . 1 |
| | BuyerPosting- | | | 0 . . . 1 |
| | DateTime | | | |
| | BuyerLast- | | | 0 . . . 1 |
| | ChangeDate- | | | |
| | Time | | | |
| | SellerPosting | | | 0 . . . 1 |
| | DateTime | | | |
| | SellerLast- | | | 0 . . . 1 |
| | ChangeDate- | | | |
| | Time | | | |
| | Acceptance- | | | 0 . . . 1 |
| | StatusCode | | | |
| | Note | | | 0 . . . 1 |
| | ItemList- | | | 0 . . . 1 |
| | Complete- | | | |
| | Transmission- | | | |
| | Indicator | | | |
| | BuyerParty | | | 0 . . . 1 |
| | | StandardID | | 0 . . . n |
| | | BuyerID | | 0 . . . 1 |
| | | SellerID | | 0 . . . 1 |
| | | Address | | 0 . . . 1 |
| | | ContactPerson | | 0 . . . 1 |
| | | | BuyerID | 0 . . . 1 |
| | | | SellerID | 0 . . . 1 |
| | | | Address | 0 . . . 1 |
| | SellerParty | | | 0 . . . 1 |
| | Product- | | | 0 . . . 1 |
| | RecipientParty | | | |
| | VendorParty | | | 0 . . . 1 |
| | Manufacturer- | | | 0 . . . 1 |
| | Party | | | |
| | BillToParty | | | 0 . . . 1 |
| | PayerParty | | | 0 . . . 1 |
| | CarrierParty | | | 0 . . . 1 |
| | ShipTo- | | | 0 . . . 1 |
| | Location | | | |
| | | StandardID | | 0 . . . n |
| | | BuyerID | | 0 . . . 1 |
| | | SellerID | | 0 . . . 1 |
| | | Address | | 0 . . . 1 |
| | ShipFrom- | | | 0 . . . 1 |
| | Location | | | |

The system then determines whether the component is one of the object nodes in the business object model (step 2116, FIG. 21B). If the system determines that the component is one of the object nodes in the business object model, the system integrates a reference to the corresponding object node from the business object model into the object (step 2118). In the above example, the system integrates the reference to the Buyer party represented by an ID and the reference to the ShipToLocation represented by an into the object, as shown below. The attributes that were formerly located in the PurchaseOrder object are now assigned to the new found object party. Thus, the attributes are removed from the PurchaseOrder object.

| | | |
|---|---|---|
| PurchaseOrder | | |
| | ID | |
| | SellerID | |
| | BuyerPostingDateTime | |
| | BuyerLastChangeDateTime | |
| | SellerPostingDateTime | |
| | SellerLastChangeDateTime | |
| | AcceptanceStatusCode | |
| | Note | |
| | ItemListCompleteTransmissionIndicator | |
| | BuyerParty | |
| | | ID |
| | SellerParty | |
| | ProductRecipientParty | |
| | VendorParty | |
| | ManufacturerParty | |
| | BillToParty | |
| | PayerParty | |
| | CarrierParty | |
| | ShipToLocation | |
| | | ID |
| | ShipFromLocation | |

During the integration step, the designers classify the relationship (i.e., aggregation or association) between the object node and the object being integrated into the business object model. The system also integrates the new attributes into the object node (step 2120). If at step 2116, the system determines that the component is not in the business object model, the system adds the component to the business object model (step 2122).

Regardless of whether the component was in the business object model at step 2116, the next step in creating the business object model is to add the integrity rules (step 2124). There are several levels of integrity rules and constraints which should be described. These levels include consistency rules between attributes, consistency rules between components, and consistency rules to other objects. Next, the designers determine the services offered, which can be accessed via interfaces (step 2126). The services offered in the example above include PurchaseOrderCreateRequest, PurchaseOrderCancellationRequest, and PurchaseOrderReleaseRequest. The system then receives an indication of the location for the object in the business object model (step 2128). After receiving the indication of the location, the system integrates the object into the business object model (step 2130).

4. Structure of the Business Object Model

The business object model, which serves as the basis for the process of generating consistent interfaces, includes the elements contained within the interfaces. These elements are arranged in a hierarchical structure within the business object model.

5. Interfaces Derived from Business Object Model

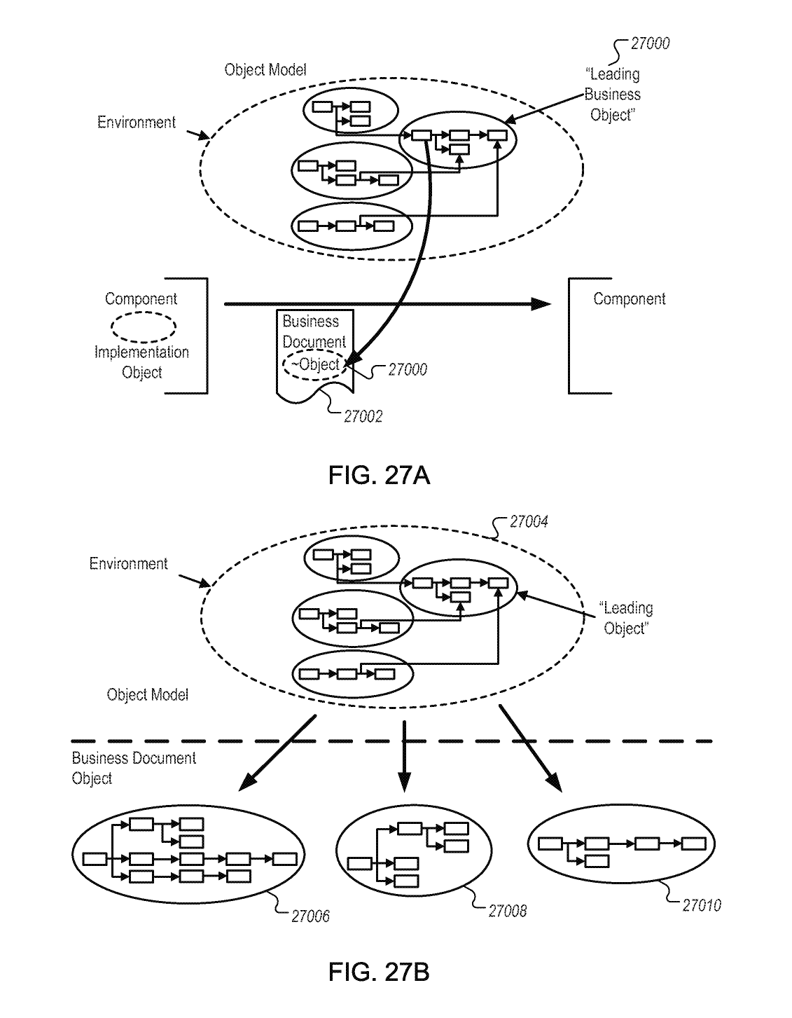

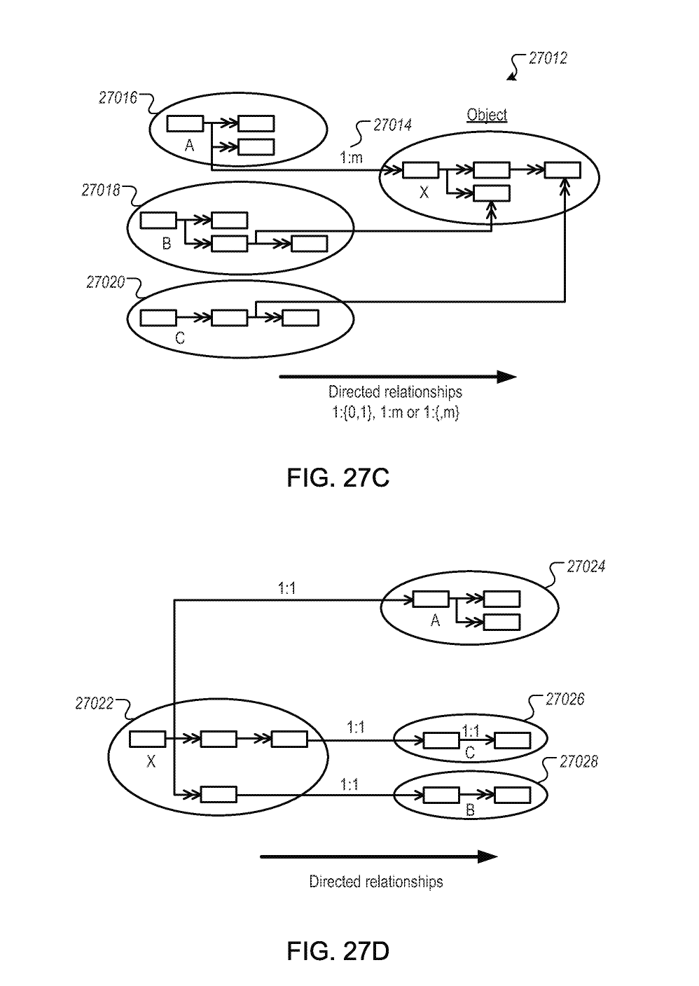

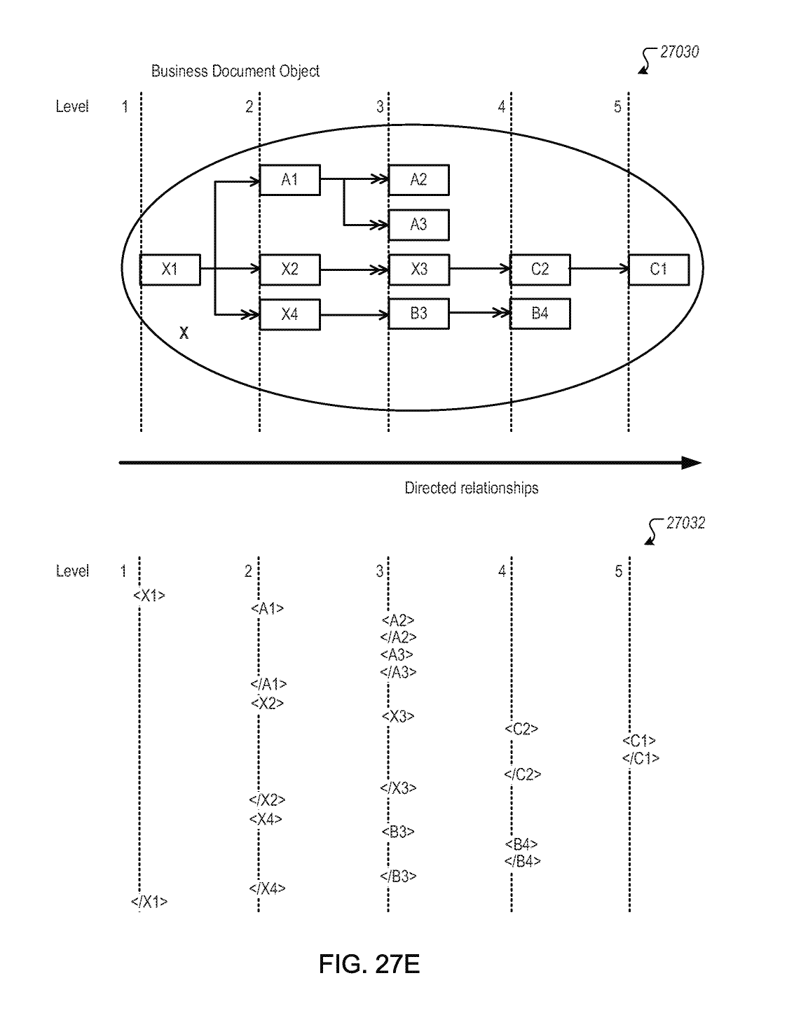

Interfaces are the starting point of the communication between two business entities. The structure of each interface determines how one business entity communicates with another business entity. The business entities may act as a unified whole when, based on the business scenario, the business entities know what an interface contains from a business perspective and how to fill the individual elements or fields of the interface. As illustrated in FIG. 27A, communication between components takes place via messages that contain business documents (e.g., business document 27002). The business document 27002 ensures a holistic business-related understanding for the recipient of the message. The business documents are created and accepted or consumed by interfaces, specifically by inbound and outbound interfaces. The interface structure and, hence, the structure of the business document are derived by a mapping rule. This mapping rule is known as “hierarchization.” An interface structure thus has a hierarchical structure created based on the leading business object 27000. The interface represents a usage-specific, hierarchical view of the underlying usage-neutral object model.

As illustrated in FIG. 27B, several business document objects 27006, 27008, and 27010 as overlapping views may be derived for a given leading object 27004. Each business document object results from the object model by hierarchization.

To illustrate the hierarchization process, FIG. 27C depicts an example of an object model 27012 (i.e., a portion of the business object model) that is used to derive a service operation signature (business document object structure). As depicted, leading object X 27014 in the object model 27012 is integrated in a net of object A 27016, object B 27018, and object C 27020. Initially, the parts of the leading object 27014 that are required for the business object document are adopted. In one variation, all parts required for a business document object are adopted from leading object 27014 (making such an operation a maximal service operation). Based on these parts, the relationships to the superordinate objects (i.e., objects A, B, and C from which object X depends) are inverted. In other words, these objects are adopted as dependent or subordinate objects in the new business document object.

For example, object A 27016, object B 27018, and object C 27020 have information that characterize object X. Because object A 27016, object B 27018, and object C 27020 are superordinate to leading object X 27014, the dependencies of these relationships change so that object A 27016, object B 27018, and object C 27020 become dependent and subordinate to leading object X 27014. This procedure is known as “derivation of the business document object by hierarchization.”

Business-related objects generally have an internal structure (parts). This structure can be complex and reflect the individual parts of an object and their mutual dependency. When creating the operation signature, the internal structure of an object is strictly hierarchized. Thus, dependent parts keep their dependency structure, and relationships between the parts within the object that do not represent the hierarchical structure are resolved by prioritizing one of the relationships.

Relationships of object X to external objects that are referenced and whose information characterizes object X are added to the operation signature. Such a structure can be quite complex (see, for example, FIG. 27D). The cardinality to these referenced objects is adopted as 1:1 or 1:C, respectively. By this, the direction of the dependency changes. The required parts of this referenced object are adopted identically, both in their cardinality and in their dependency arrangement.

The newly created business document object contains all required information, including the incorporated master data information of the referenced objects. As depicted in FIG. 27D, components Xi in leading object X 27022 are adopted directly. The relationship of object X 27022 to object A 27024, object B 27028, and object C 27026 are inverted, and the parts required by these objects are added as objects that depend from object X 27022. As depicted, all of object A 27024 is adopted. B3 and B4 are adopted from object B 27028, but B1 is not adopted. From object C 27026, C2 and C1 are adopted, but C3 is not adopted.

FIG. 27E depicts the business document object X 27030 created by this hierarchization process. As shown, the arrangement of the elements corresponds to their dependency levels, which directly leads to a corresponding representation as an XML structure 27032.

The following provides certain rules that can be adopted singly or in combination with regard to the hierarchization process. A business document object always refers to a leading business document object and is derived from this object. The name of the root entity in the business document entity is the name of the business object or the name of a specialization of the business object or the name of a service specific view onto the business object. The nodes and elements of the business object that are relevant (according to the semantics of the associated message type) are contained as entities and elements in the business document object.

The name of a business document entity is predefined by the name of the corresponding business object node. The name of the superordinate entity is not repeated in the name of the business document entity. The “full” semantic name results from the concatenation of the entity names along the hierarchical structure of the business document object.

The structure of the business document object is, except for deviations due to hierarchization, the same as the structure of the business object. The cardinalities of the business document object nodes and elements are adopted identically or more restrictively to the business document object. An object from which the leading business object is dependent can be adopted to the business document object. For this arrangement, the relationship is inverted, and the object (or its parts, respectively) are hierarchically subordinated in the business document object.

Nodes in the business object representing generalized business information can be adopted as explicit entities to the business document object (generally speaking, multiply TypeCodes out). When this adoption occurs, the entities are named according to their more specific semantic (name of TypeCode becomes prefix). Party nodes of the business object are modeled as explicit entities for each party role in the business document object. These nodes are given the name <Prefix><Party Role>Party, for example, BuyerParty, ItemBuyerParty. BTDReference nodes are modeled as separate entities for each reference type in the business document object. These nodes are given the name <Qualifier><BO><Node>Reference, for example SalesOrderReference, OriginSalesOrderReference, SalesOrderItemReference. A product node in the business object comprises all of the information on the Product, ProductCategory, and Batch. This information is modeled in the business document object as explicit entities for Product, ProductCategory, and Batch.

Entities which are connected by a 1:1 relationship as a result of hierarchization can be combined to a single entity, if they are semantically equivalent. Such a combination can often occurs if a node in the business document object that results from an assignment node is removed because it does not have any elements.

The message type structure is typed with data types. Elements are typed by GDTs according to their business objects. Aggregated levels are typed with message type specific data types (Intermediate Data Types), with their names being built according to the corresponding paths in the message type structure. The whole message type structured is typed by a message data type with its name being built according to the root entity with the suffix “Message”. For the message type, the message category (e.g., information, notification, query, response, request, confirmation, etc.) is specified according to the suited transaction communication pattern.

In one variation, the derivation by hierarchization can be initiated by specifying a leading business object and a desired view relevant for a selected service operation. This view determines the business document object. The leading business object can be the source object, the target object, or a third object. Thereafter, the parts of the business object required for the view are determined. The parts are connected to the root node via a valid path along the hierarchy. Thereafter, one or more independent objects (object parts, respectively) referenced by the leading object which are relevant for the service may be determined (provided that a relationship exists between the leading object and the one or more independent objects).

Once the selection is finalized, relevant nodes of the leading object node that are structurally identical to the message type structure can then be adopted. If nodes are adopted from independent objects or object parts, the relationships to such independent objects or object parts are inverted. Linearization can occur such that a business object node containing certain TypeCodes is represented in the message type structure by explicit entities (an entity for each value of the TypeCode). The structure can be reduced by checking all 1:1 cardinalities in the message type structure. Entities can be combined if they are semantically equivalent, one of the entities carries no elements, or an entity solely results from an n:m assignment in the business object.

After the hierarchization is completed, information regarding transmission of the business document object (e.g., CompleteTransmissionIndicator, ActionCodes, message category, etc.) can be added. A standardized message header can be added to the message type structure and the message structure can be typed. Additionally, the message category for the message type can be designated.

Invoice Request and Invoice Confirmation are examples of interfaces. These invoice interfaces are used to exchange invoices and invoice confirmations between an invoicing party and an invoice recipient (such as between a seller and a buyer) in a B2B process. Companies can create invoices in electronic as well as in paper form. Traditional methods of communication, such as mail or fax, for invoicing are cost intensive, prone to error, and relatively slow, since the data is recorded manually. Electronic communication eliminates such problems. The motivating business scenarios for the Invoice Request and Invoice Confirmation interfaces are the Procure to Stock (PTS) and Sell from Stock (SFS) scenarios. In the PTS scenario, the parties use invoice interfaces to purchase and settle goods. In the SFS scenario, the parties use invoice interfaces to sell and invoice goods. The invoice interfaces directly integrate the applications implementing them and also form the basis for mapping data to widely-used XML standard formats such as RosettaNet, PIDX, xCBL, and CIDX.

The invoicing party may use two different messages to map a B2B invoicing process: (1) the invoicing party sends the message type InvoiceRequest to the invoice recipient to start a new invoicing process; and (2) the invoice recipient sends the message type InvoiceConfirmation to the invoicing party to confirm or reject an entire invoice or to temporarily assign it the status “pending.”

An InvoiceRequest is a legally binding notification of claims or liabilities for delivered goods and rendered services—usually, a payment request for the particular goods and services. The message type InvoiceRequest is based on the message data type InvoiceMessage. The InvoiceRequest message (as defined) transfers invoices in the broader sense. This includes the specific invoice (request to settle a liability), the debit memo, and the credit memo.

InvoiceConfirmation is a response sent by the recipient to the invoicing party confirming or rejecting the entire invoice received or stating that it has been assigned temporarily the status “pending.” The message type InvoiceConfirmation is based on the message data type InvoiceMessage. An InvoiceConfirmation is not mandatory in a B2B invoicing process, however, it automates collaborative processes and dispute management.

Usually, the invoice is created after it has been confirmed that the goods were delivered or the service was provided. The invoicing party (such as the seller) starts the invoicing process by sending an InvoiceRequest message. Upon receiving the InvoiceRequest message, the invoice recipient (for instance, the buyer) can use the InvoiceConfirmation message to completely accept or reject the invoice received or to temporarily assign it the status “pending.” The InvoiceConfirmation is not a negotiation tool (as is the case in order management), since the options available are either to accept or reject the entire invoice. The invoice data in the InvoiceConfirmation message merely confirms that the invoice has been forwarded correctly and does not communicate any desired changes to the invoice. Therefore, the InvoiceConfirmation includes the precise invoice data that the invoice recipient received and checked. If the invoice recipient rejects an invoice, the invoicing party can send a new invoice after checking the reason for rejection (AcceptanceStatus and ConfirmationDescription at Invoice and InvoiceItem level). If the invoice recipient does not respond, the invoice is generally regarded as being accepted and the invoicing party can expect payment.

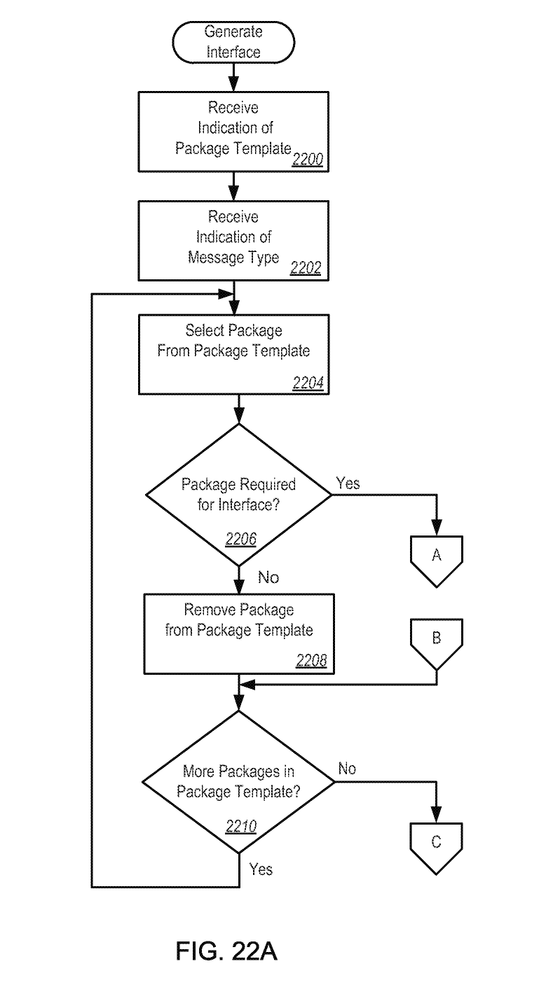

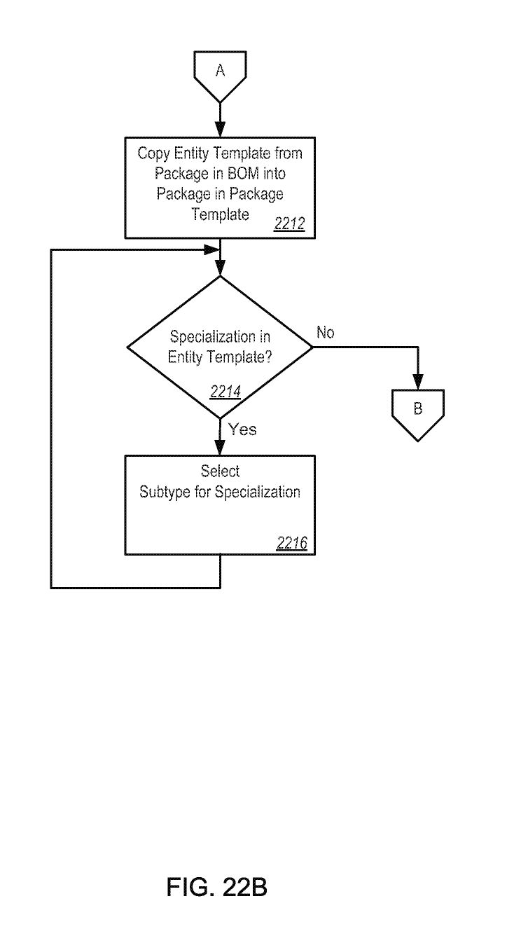

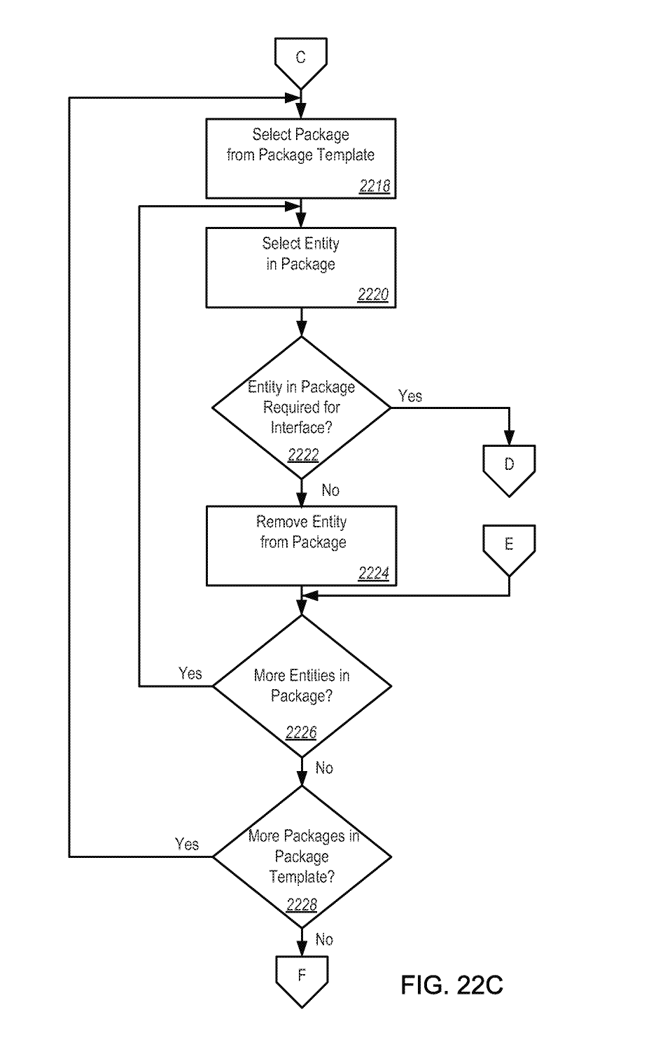

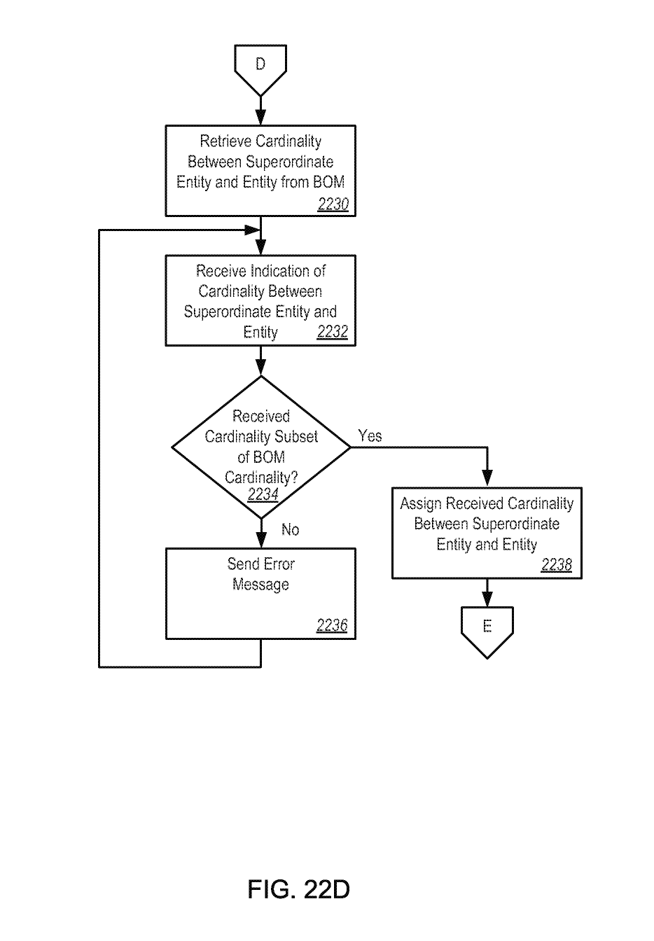

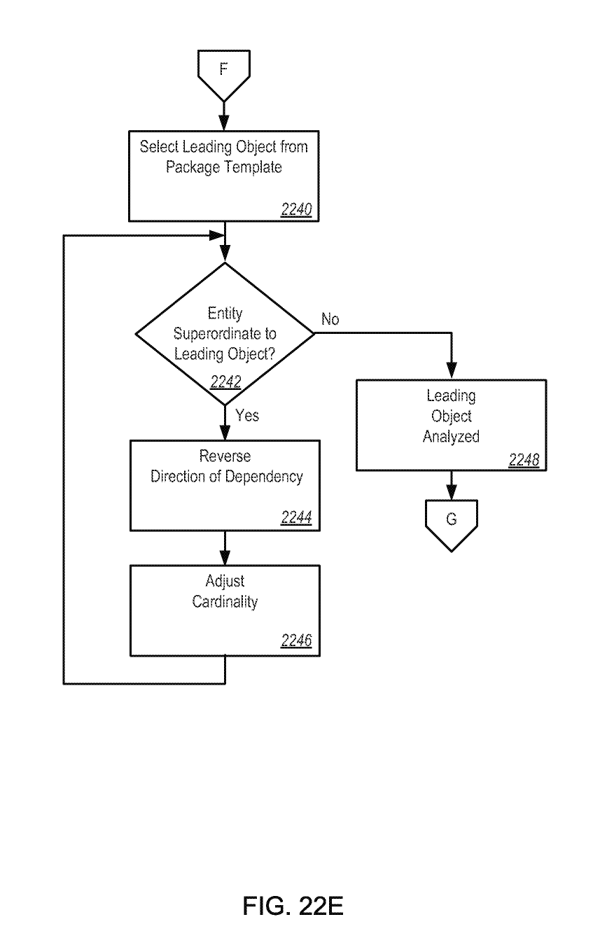

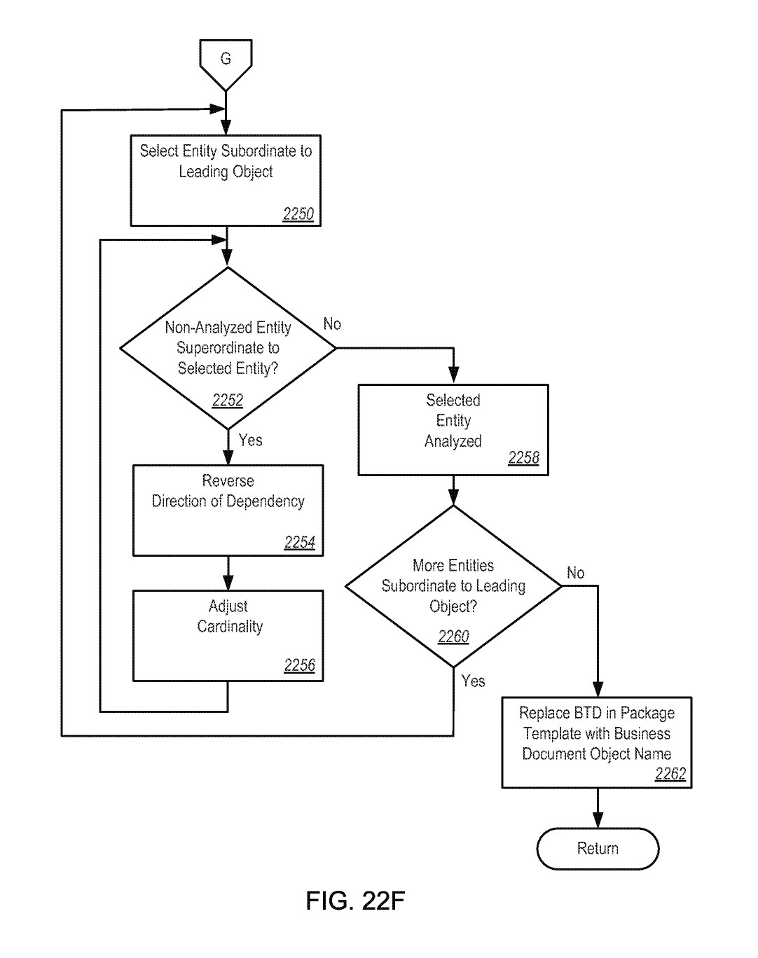

FIGS. 22A-F depict a flow diagram of the steps performed by methods and systems consistent with the subject matter described herein to generate an interface from the business object model. Although described as being performed by a computer, these steps may alternatively be performed manually, or using any combination thereof. The process begins when the system receives an indication of a package template from the designer, i.e., the designer provides a package template to the system (step 2200).

Package templates specify the arrangement of packages within a business transaction document. Package templates are used to define the overall structure of the messages sent between business entities. Methods and systems consistent with the subject matter described herein use package templates in conjunction with the business object model to derive the interfaces.

The system also receives an indication of the message type from the designer (step 2202). The system selects a package from the package template (step 2204), and receives an indication from the designer whether the package is required for the interface (step 2206). If the package is not required for the interface, the system removes the package from the package template (step 2208). The system then continues this analysis for the remaining packages within the package template (step 2210).

If, at step 2206, the package is required for the interface, the system copies the entity template from the package in the business object model into the package in the package template (step 2212, FIG. 22B). The system determines whether there is a specialization in the entity template (step 2214). If the system determines that there is a specialization in the entity template, the system selects a subtype for the specialization (step 2216). The system may either select the subtype for the specialization based on the message type, or it may receive this information from the designer. The system then determines whether there are any other specializations in the entity template (step 2214). When the system determines that there are no specializations in the entity template, the system continues this analysis for the remaining packages within the package template (step 2210, FIG. 22A).

At step 2210, after the system completes its analysis for the packages within the package template, the system selects one of the packages remaining in the package template (step 2218, FIG. 22C), and selects an entity from the package (step 2220). The system receives an indication from the designer whether the entity is required for the interface (step 2222). If the entity is not required for the interface, the system removes the entity from the package template (step 2224). The system then continues this analysis for the remaining entities within the package (step 2226), and for the remaining packages within the package template (step 2228).

If, at step 2222, the entity is required for the interface, the system retrieves the cardinality between a superordinate entity and the entity from the business object model (step 2230, FIG. 22D). The system also receives an indication of the cardinality between the superordinate entity and the entity from the designer (step 2232). The system then determines whether the received cardinality is a subset of the business object model cardinality (step 2234). If the received cardinality is not a subset of the business object model cardinality, the system sends an error message to the designer (step 2236). If the received cardinality is a subset of the business object model cardinality, the system assigns the received cardinality as the cardinality between the superordinate entity and the entity (step 2238). The system then continues this analysis for the remaining entities within the package (step 2226, FIG. 22C), and for the remaining packages within the package template (step 2228).

The system then selects a leading object from the package template (step 2240, FIG. 22E). The system determines whether there is an entity superordinate to the leading object (step 2242). If the system determines that there is an entity superordinate to the leading object, the system reverses the direction of the dependency (step 2244) and adjusts the cardinality between the leading object and the entity (step 2246). The system performs this analysis for entities that are superordinate to the leading object (step 2242). If the system determines that there are no entities superordinate to the leading object, the system identifies the leading object as analyzed (step 2248).

The system then selects an entity that is subordinate to the leading object (step 2250, FIG. 22F). The system determines whether any non-analyzed entities are superordinate to the selected entity (step 2252). If a non-analyzed entity is superordinate to the selected entity, the system reverses the direction of the dependency (step 2254) and adjusts the cardinality between the selected entity and the non-analyzed entity (step 2256). The system performs this analysis for non-analyzed entities that are superordinate to the selected entity (step 2252). If the system determines that there are no non-analyzed entities superordinate to the selected entity, the system identifies the selected entity as analyzed (step 2258), and continues this analysis for entities that are subordinate to the leading object (step 2260). After the packages have been analyzed, the system substitutes the BusinessTransactionDocument (“BTD”) in the package template with the name of the interface (step 2262). This includes the “BTD” in the BTDItem package and the “BTD” in the BTDItemScheduleLine package.

6. Use of an Interface

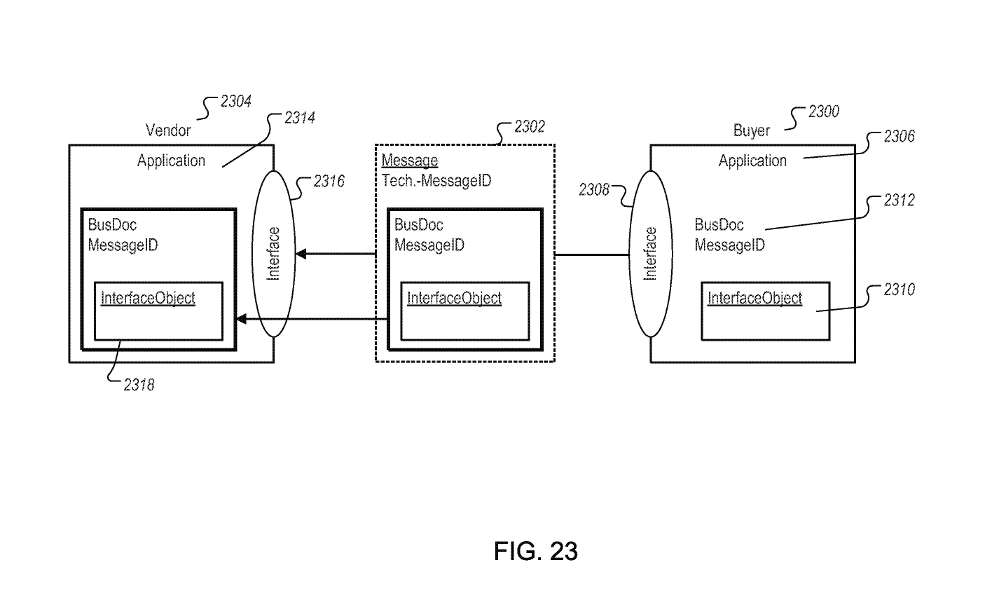

The XI stores the interfaces (as an interface type). At runtime, the sending party's program instantiates the interface to create a business document, and sends the business document in a message to the recipient. The messages are preferably defined using XML. In the example depicted in FIG. 23, the Buyer 2300 uses an application 2306 in its system to instantiate an interface 2308 and create an interface object or business document object 2310. The Buyer's application 2306 uses data that is in the sender's component-specific structure and fills the business document object 2310 with the data. The Buyer's application 2306 then adds message identification 2312 to the business document and places the business document into a message 2302. The Buyer's application 2306 sends the message 2302 to the Vendor 2304. The Vendor 2304 uses an application 2314 in its system to receive the message 2302 and store the business document into its own memory. The Vendor's application 2314 unpacks the message 2302 using the corresponding interface 2316 stored in its XI to obtain the relevant data from the interface object or business document object 2318.

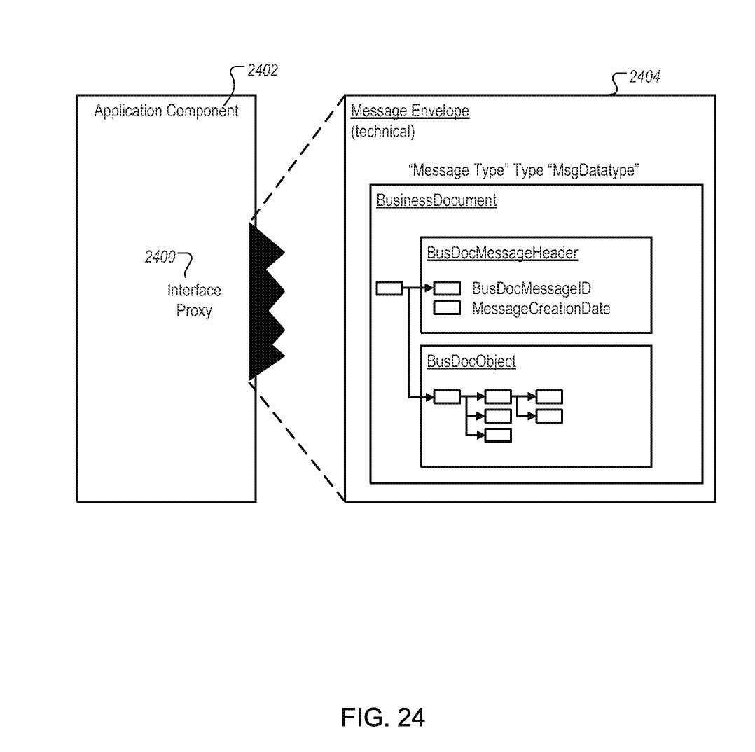

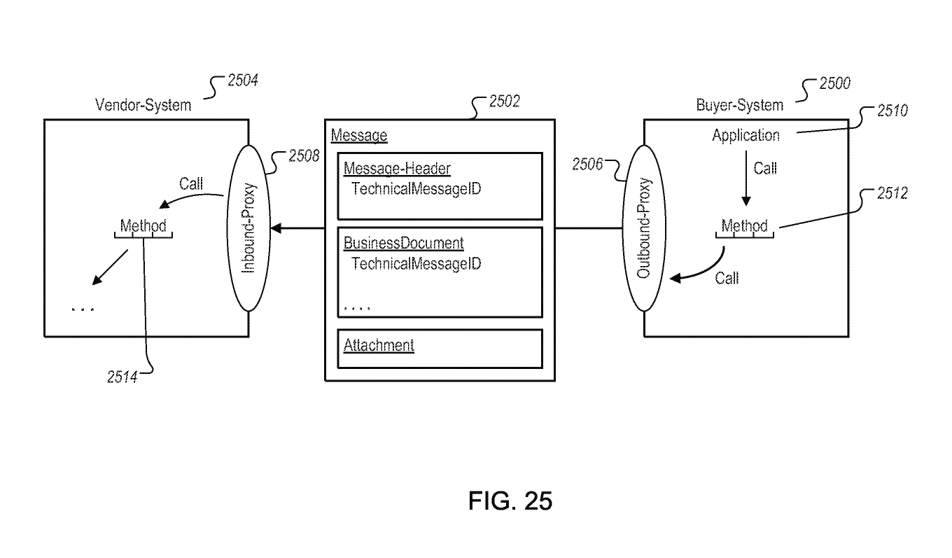

From the component's perspective, the interface is represented by an interface proxy 2400, as depicted in FIG. 24. The proxies 2400 shield the components 2402 of the sender and recipient from the technical details of sending messages 2404 via XI. In particular, as depicted in FIG. 25, at the sending end, the Buyer 2500 uses an application 2510 in its system to call an implemented method 2512, which generates the outbound proxy 2506. The outbound proxy 2506 parses the internal data structure of the components and converts them to the XML structure in accordance with the business document object. The outbound proxy 2506 packs the document into a message 2502. Transport, routing and mapping the XML message to the recipient 28304 is done by the routing system (XI, modeling environment 516, etc.).

When the message arrives, the recipient's inbound proxy 2508 calls its component-specific method 2514 for creating a document. The proxy 2508 at the receiving end downloads the data and converts the XML structure into the internal data structure of the recipient component 2504 for further processing.

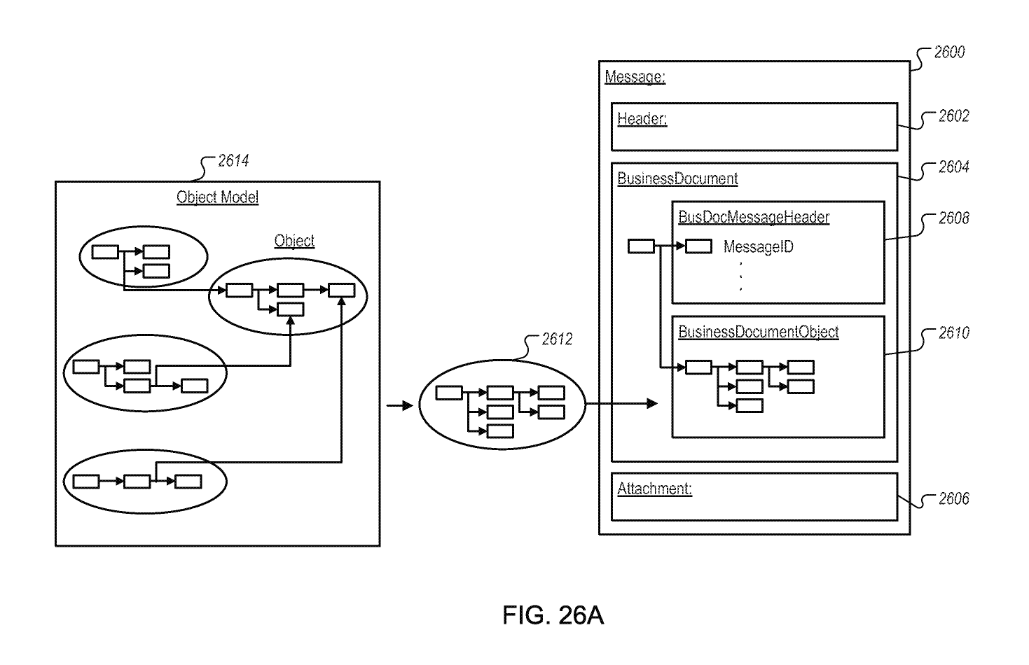

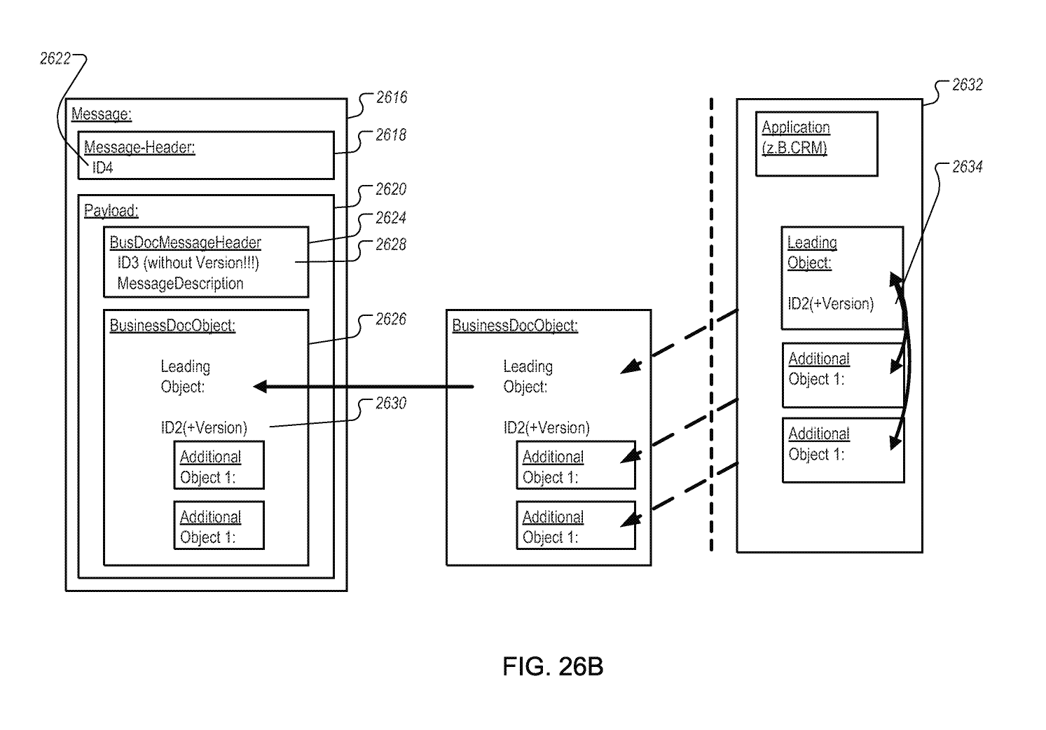

As depicted in FIG. 26A, a message 2600 includes a message header 2602 and a business document 2604. The message 2600 also may include an attachment 2606. For example, the sender may attach technical drawings, detailed specifications or pictures of a product to a purchase order for the product. The business document 2604 includes a business document message header 2608 and the business document object 2610. The business document message header 2608 includes administrative data, such as the message ID and a message description. As discussed above, the structure 2612 of the business document object 2610 is derived from the business object model 2614. Thus, there is a strong correlation between the structure of the business document object and the structure of the business object model. The business document object 2610 forms the core of the message 2600.

In collaborative processes as well as Q&A processes, messages should refer to documents from previous messages. A simple business document object ID or object ID is insufficient to identify individual messages uniquely because several versions of the same business document object can be sent during a transaction. A business document object ID with a version number also is insufficient because the same version of a business document object can be sent several times. Thus, messages require several identifiers during the course of a transaction.

As depicted in FIG. 26B, the message header 2618 in message 2616 includes a technical ID (“ID4”) 2622 that identifies the address for a computer to route the message. The sender's system manages the technical ID 2622.

The administrative information in the business document message header 2624 of the payload or business document 2620 includes a BusinessDocumentMessageID (“ID3”) 2628. The business entity or component 2632 of the business entity manages and sets the BusinessDocumentMessageID 2628. The business entity or component 2632 also can refer to other business documents using the BusinessDocumentMessageID 2628. The receiving component 2632 requires no knowledge regarding the structure of this ID. The BusinessDocumentMessageID 2628 is, as an ID, unique. Creation of a message refers to a point in time. No versioning is typically expressed by the ID. Besides the BusinessDocumentMessageID 2628, there also is a business document object ID 2630, which may include versions.

The component 2632 also adds its own component object ID 2634 when the business document object is stored in the component. The component object ID 2634 identifies the business document object when it is stored within the component. However, not all communication partners may be aware of the internal structure of the component object ID 2634. Some components also may include a versioning in their ID 2634.

7. Use of Interfaces Across Industries

Methods and systems consistent with the subject matter described herein provide interfaces that may be used across different business areas for different industries. Indeed, the interfaces derived using methods and systems consistent with the subject matter described herein may be mapped onto the interfaces of different industry standards. Unlike the interfaces provided by any given standard that do not include the interfaces required by other standards, methods and systems consistent with the subject matter described herein provide a set of consistent interfaces that correspond to the interfaces provided by different industry standards. Due to the different fields provided by each standard, the interface from one standard does not easily map onto another standard. By comparison, to map onto the different industry standards, the interfaces derived using methods and systems consistent with the subject matter described herein include most of the fields provided by the interfaces of different industry standards. Missing fields may easily be included into the business object model. Thus, by derivation, the interfaces can be extended consistently by these fields. Thus, methods and systems consistent with the subject matter described herein provide consistent interfaces or services that can be used across different industry standards.

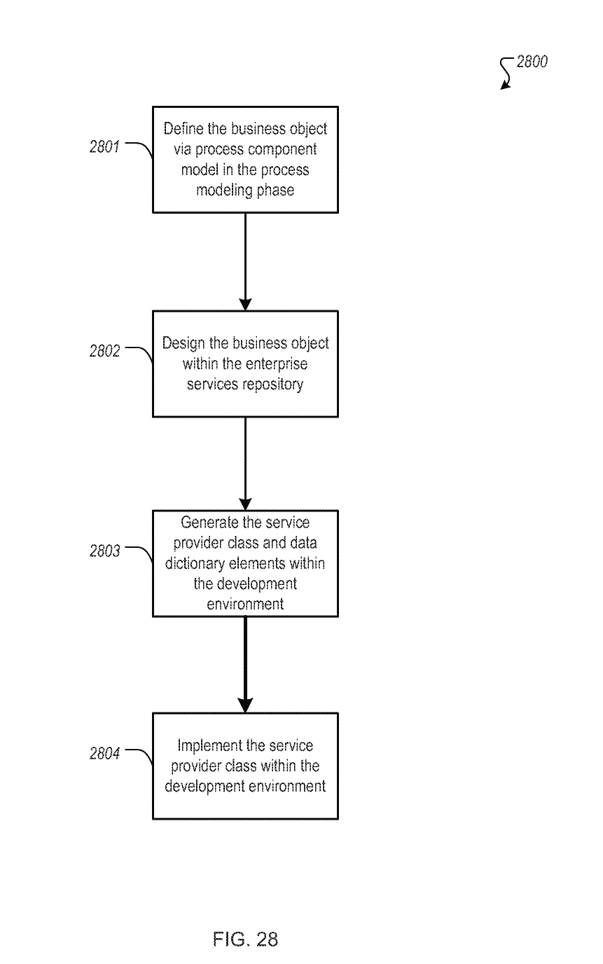

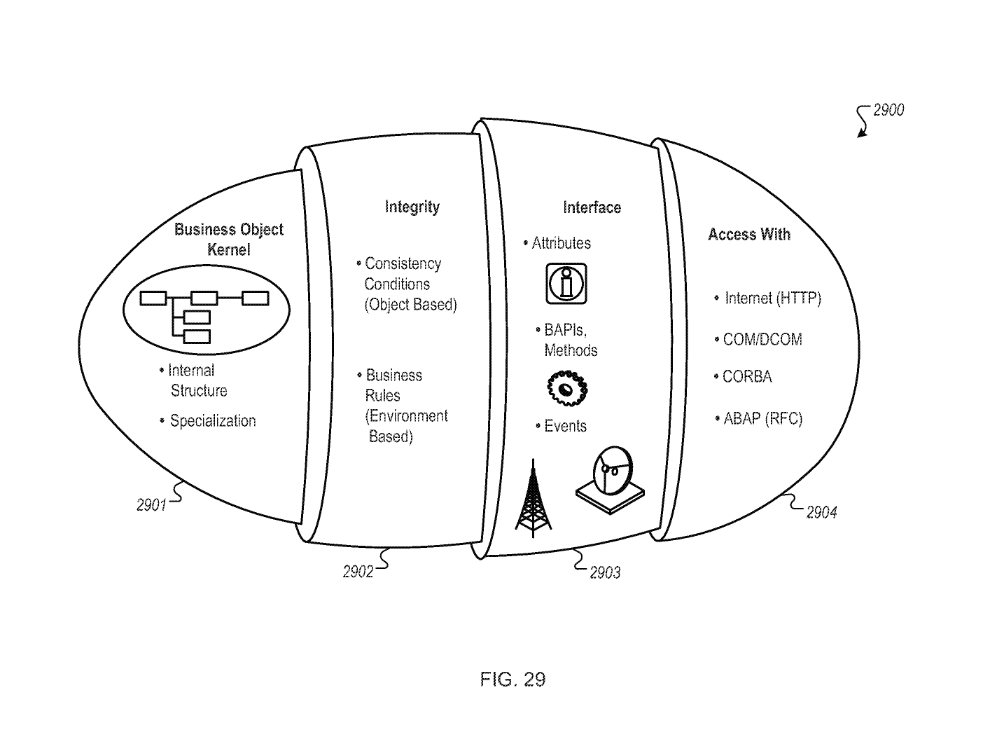

For example, FIG. 28 illustrates an example method 2800 for service enabling. In this example, the enterprise services infrastructure may offer one common and standard-based service infrastructure. Further, one central enterprise services repository may support uniform service definition, implementation and usage of services for user interface, and cross-application communication. In step 2801, a business object is defined via a process component model in a process modeling phase. Next, in step 2802, the business object is designed within an enterprise services repository. For example, FIG. 29 provides a graphical representation of one of the business objects 2900. As shown, an innermost layer or kernel 2901 of the business object may represent the business object's inherent data. Inherent data may include, for example, an employee's name, age, status, position, address, etc. A second layer 2902 may be considered the business object's logic. Thus, the layer 2902 includes the rules for consistently embedding the business object in a system environment as well as constraints defining values and domains applicable to the business object. For example, one such constraint may limit sale of an item only to a customer with whom a company has a business relationship. A third layer 2903 includes validation options for accessing the business object. For example, the third layer 2903 defines the business object's interface that may be interfaced by other business objects or applications. A fourth layer 2904 is the access layer that defines technologies that may externally access the business object.

Accordingly, the third layer 2903 separates the inherent data of the first layer 2901 and the technologies used to access the inherent data. As a result of the described structure, the business object reveals only an interface that includes a set of clearly defined methods. Thus, applications access the business object via those defined methods. An application wanting access to the business object and the data associated therewith usually includes the information or data to execute the clearly defined methods of the business object's interface. Such clearly defined methods of the business object's interface represent the business object's behavior. That is, when the methods are executed, the methods may change the business object's data. Therefore, an application may utilize any business object by providing the information or data without having any concern for the details related to the internal operation of the business object. Returning to method 2800, a service provider class and data dictionary elements are generated within a development environment at step 2803. In step 2804, the service provider class is implemented within the development environment.

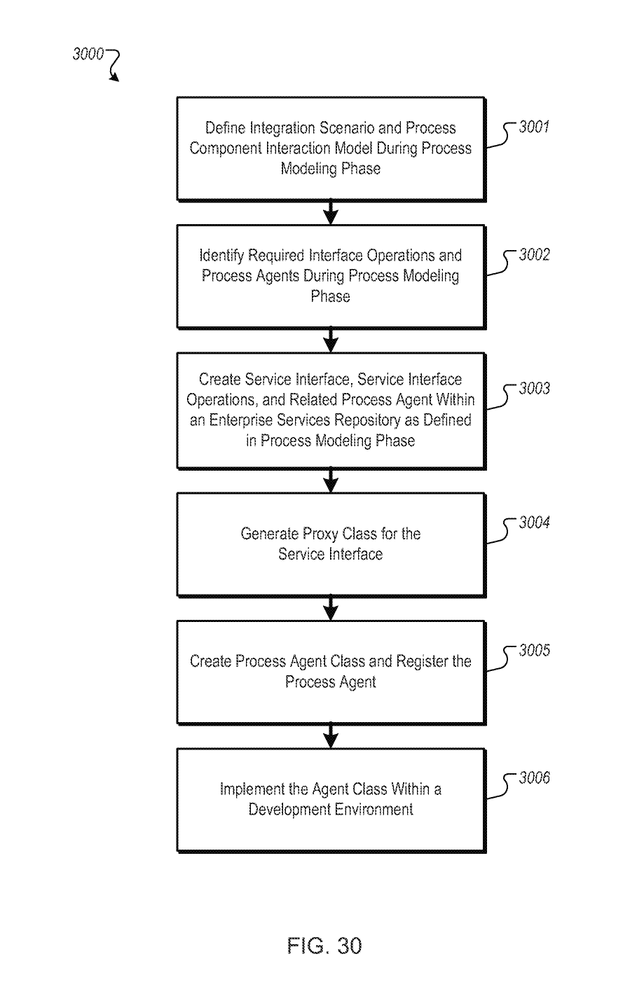

FIG. 30 illustrates an example method 3000 for a process agent framework. For example, the process agent framework may be the basic infrastructure to integrate business processes located in different deployment units. It may support a loose coupling of these processes by message based integration. A process agent may encapsulate the process integration logic and separate it from business logic of business objects. As shown in FIG. 30, an integration scenario and a process component interaction model are defined during a process modeling phase in step 3001. In step 3002, required interface operations and process agents are identified during the process modeling phase also. Next, in step 3003, a service interface, service interface operations, and the related process agent are created within an enterprise services repository as defined in the process modeling phase. In step 3004, a proxy class for the service interface is generated. Next, in step 3005, a process agent class is created and the process agent is registered. In step 3006, the agent class is implemented within a development environment.

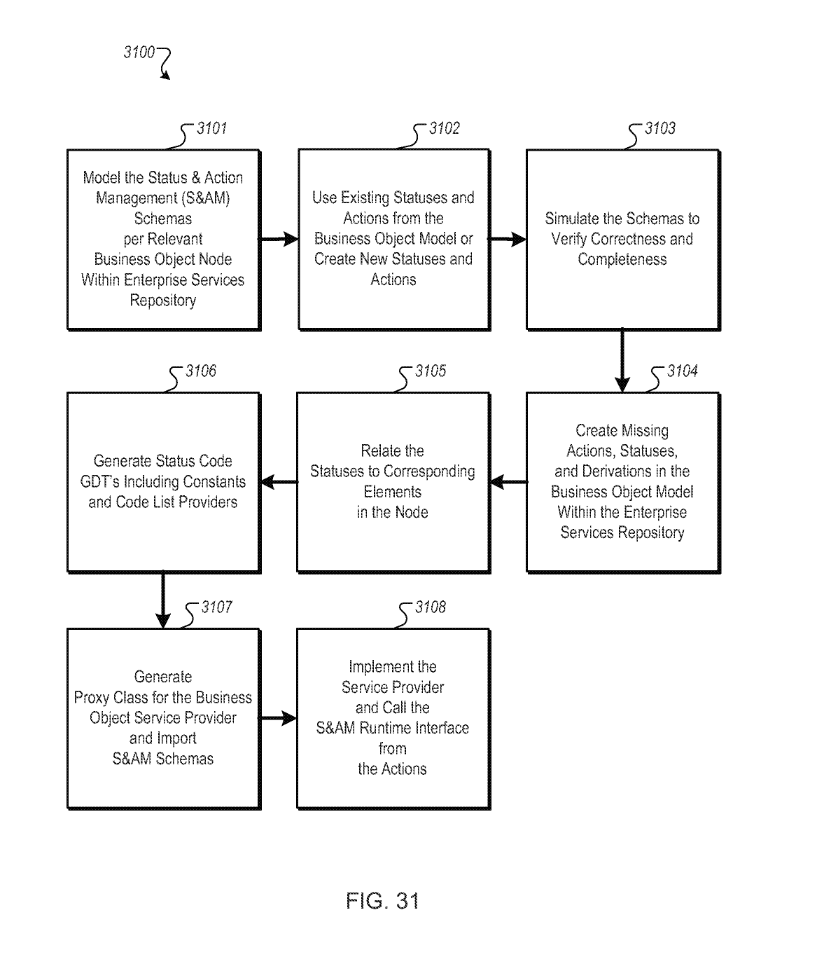

FIG. 31 illustrates an example method 3100 for status and action management (S&AM). For example, status and action management may describe the life cycle of a business object (node) by defining actions and statuses (as their result) of the business object (node), as well as, the constraints that the statuses put on the actions. In step 3101, the status and action management schemas are modeled per a relevant business object node within an enterprise services repository. In step 3102, existing statuses and actions from the business object model are used or new statuses and actions are created. Next, in step 3103, the schemas are simulated to verify correctness and completeness. In step 3104, missing actions, statuses, and derivations are created in the business object model with the enterprise services repository. Continuing with method 3100, the statuses are related to corresponding elements in the node in step 3105. In step 3106, status code GDT's are generated, including constants and code list providers. Next, in step 3107, a proxy class for a business object service provider is generated and the proxy class S&AM schemas are imported. In step 3108, the service provider is implemented and the status and action management runtime interface is called from the actions.

Regardless of the particular hardware or software architecture used, the disclosed systems or software are generally capable of implementing business objects and deriving (or otherwise utilizing) consistent interfaces that are suitable for use across industries, across businesses, and across different departments within a business in accordance with some or all of the following description. In short, system 100 contemplates using any appropriate combination and arrangement of logical elements to implement some or all of the described functionality.

Moreover, the preceding flowcharts and accompanying description illustrate example methods. The present services environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the services environment may use methods with additional steps, fewer steps, and/or different steps, so long as the methods remain appropriate.

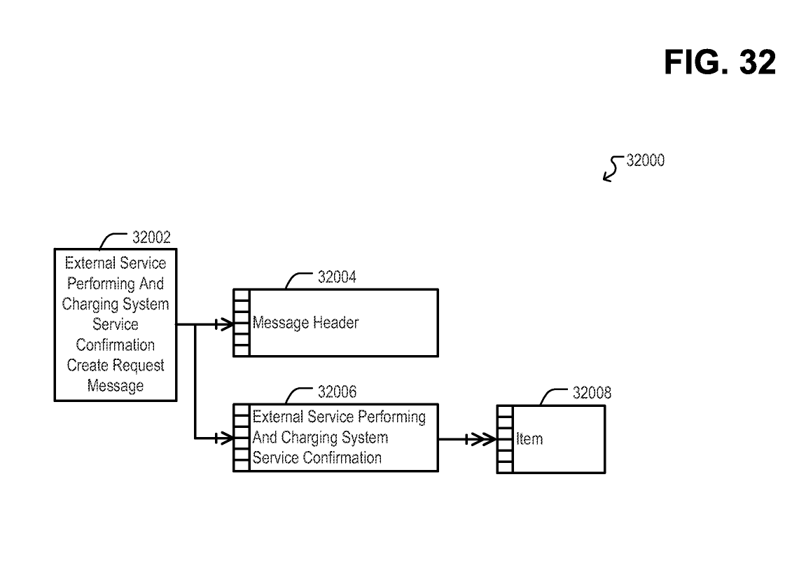

FIG. 32 illustrates one example logical configuration of an External Service Performing and Charging System Service Confirmation Create Request message 32000. Specifically, this figure depicts the arrangement and hierarchy of various components such as one or more levels of packages, entities, and data types, shown here as 32000 through 32008. As described above, packages may be used to represent hierarchy levels, and different types of cardinality relationships among entities can be represented using different arrowhead styles. Entities are discrete business elements that are used during a business transaction. Data types are used to type object entities and interfaces with a structure. For example, the External Service Performing and Charging System Service Confirmation Create Request message 32000 includes, among other things, the Item entity 32008. Accordingly, heterogeneous applications may communicate using this consistent message configured as such.

The message type External Service Performing And Charging System Service Confirmation Create Request is derived from the business object Service Confirmation as a leading object together with its operation signature. The message type External Service Performing And Charging System Service Confirmation Create Request is a request from an external service performing and charging system to create a service confirmation with reference to a customer contract. The structure of the message type External Service Performing And Charging System Service Confirmation Create Request is determined by the message data type ExternalServicePerformingAndChargingSystemServiceConfirmationCreateMessage. The message data type ExternalServicePerformingAndChargingSystemServiceConfirmationCreateMessage includes the MessageHeader package and the ExternalServicePerformingAndChargingSystemServiceConfirmation package.

The package MessageHeader includes the sub-packages Party and the Business Scope, and the entity MessageHeader. MessageHeader is typed by datatype BusinessDocumentMessageHeader. The package ExternalServicePerformingAndChargingSystemServiceConfirmation includes the sub-package Item and the entity ExternalServicePerformingAndChargingSystemServiceConfirmation.

ExternalServicePerformingAndChargingSystemServiceConfirmation includes the following non-node elements: CustomerContractID, Name, TextCollection, and AttachmentFolder. CustomerContractID may have a multiplicity of 0..1 and may be based on datatype BGDT:BusinessTransactionDocumentID. Name may have a multiplicity of 0..1 and may be based on datatype CDT:EXTENDED_Name. TextCollection may have a multiplicity of 0..1 and may be based on datatype MAGDT:TextCollection. AttachmentFolder may have a multiplicity of 0..1 and may be based on datatype MAGDT:AttachmentFolder. ExternalServicePerformingAndChargingSystemServiceConfirmation includes the following node elements: Item, in a 1:CN cardinality relationship.

The package ExternalServicePerformingAndChargingSystemServiceConfirmationItem includes the entity Item. Item includes the following non-node elements: CustomerContractItemID, Description, Product, Quantity, ServicePerformerParty, SellerID, ActualFulfillmentPeriod, ConfirmedDuration, ConfirmedServiceWorkingConditionsCode, ResourceID, TextCollection, and FinishFulfillmentProcessingRequestedIndicator. CustomerContractItemID may have a multiplicity of 0..1 and may be based on datatype BGDT:BusinessTransactionDocumentItemID Description may have a multiplicity of 0..1 and may be based on datatype BGDT:SHORT_Description. Product may have a multiplicity of 0..1 and may be based on datatype MAGDT:BUYERSELLER_BusinessTransactionDocumentProduct. Quantity may have a multiplicity of 0..1 and may be based on datatype CDT:Quantity. ServicePerformerParty may have a multiplicity of 0..1 and may be based on datatype MIDT:ExternalServicePerformingAndChargingSystemServiceConfirmationItemServicePerformerParty. SellerID may have a multiplicity of 0..1 and may be based on datatype BGDT:PartyPartyID. ActualFulfillmentPeriod may have a multiplicity of 0..1 and may be based on datatype AGDT:UPPEROPEN_LOCALNORMALISED_DateTimePeriod. ConfirmedDuration may have a multiplicity of 0..1 and may be based on datatype CDT:Duration, with a qualifier of Confirmed. ConfirmedServiceWorkingConditionsCode may have a multiplicity of 0..1 and may be based on datatype BGDT:ServiceWorkingConditionsCode. ResourceID may have a multiplicity of 0..1 and may be based on datatype BGDT:ResourceID. TextCollection may have a multiplicity of 0..1 and may be based on datatype MAGDT: TextCollection. FinishFulfillmentProcessingRequestedIndicator may have a multiplicity of 0..1 and may be based on datatype CDT:Indicator, with a qualifier of Requested.

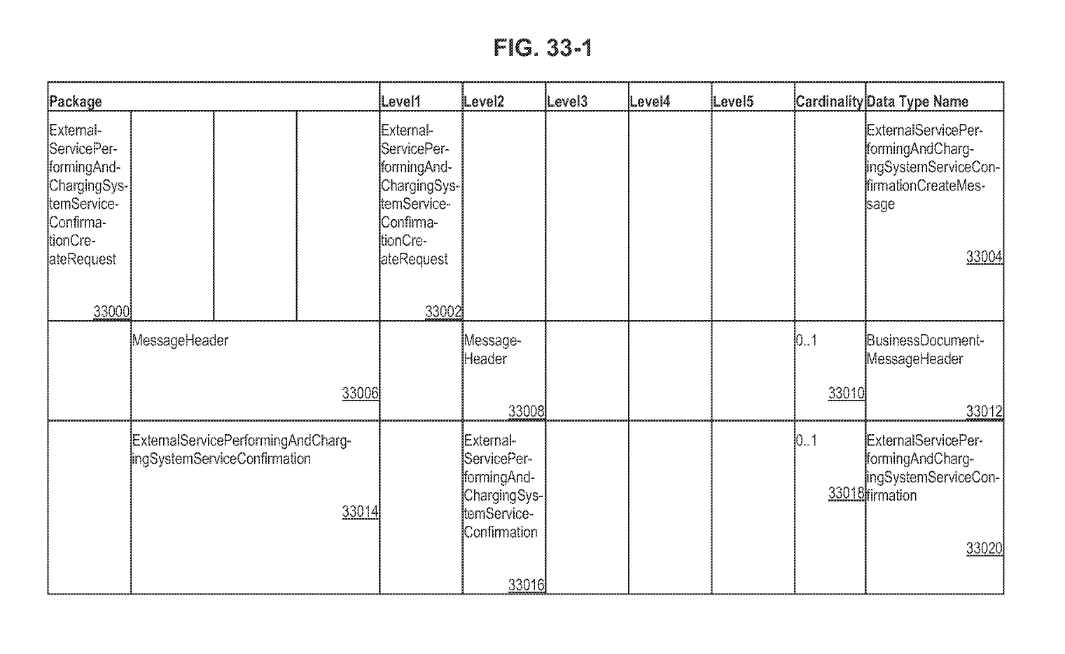

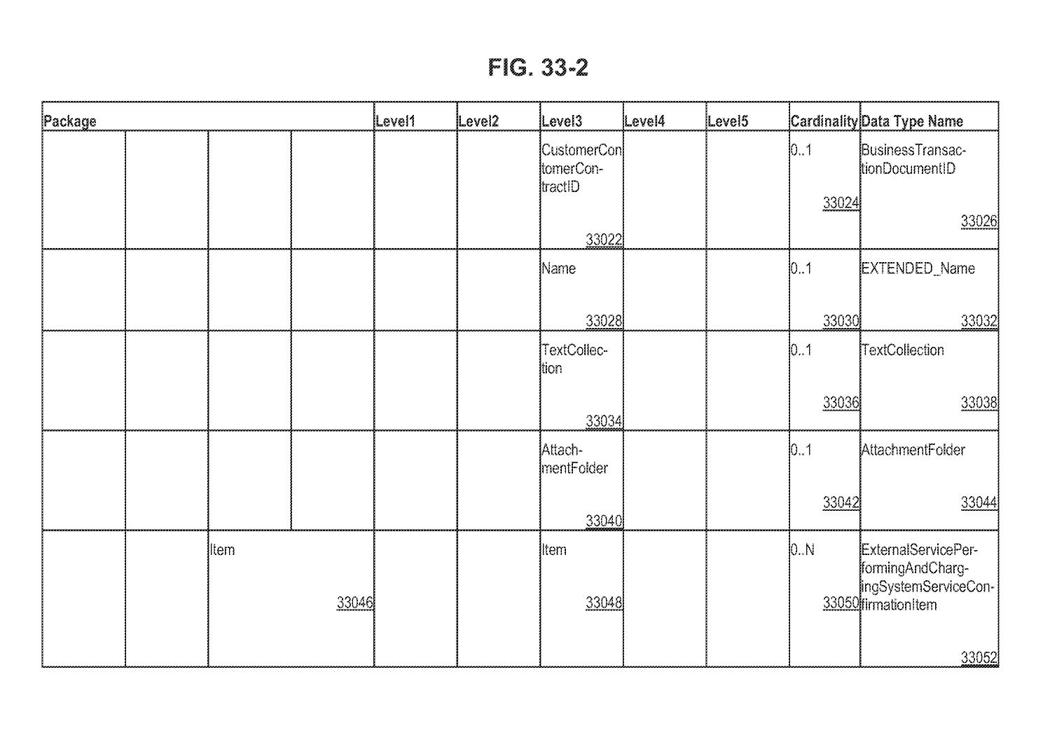

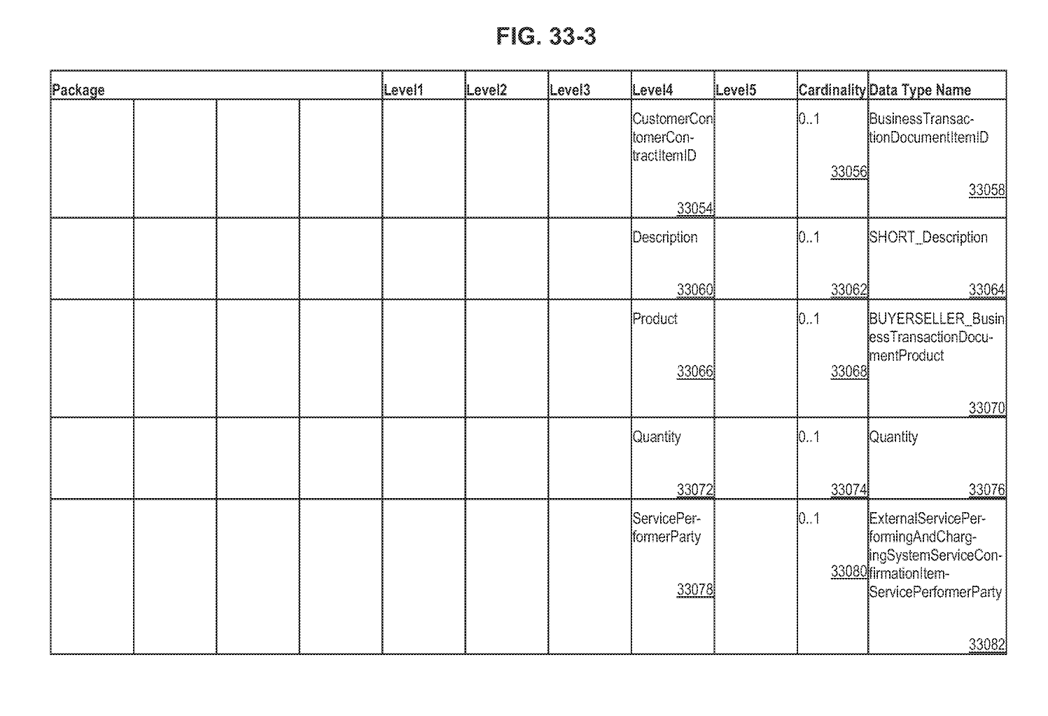

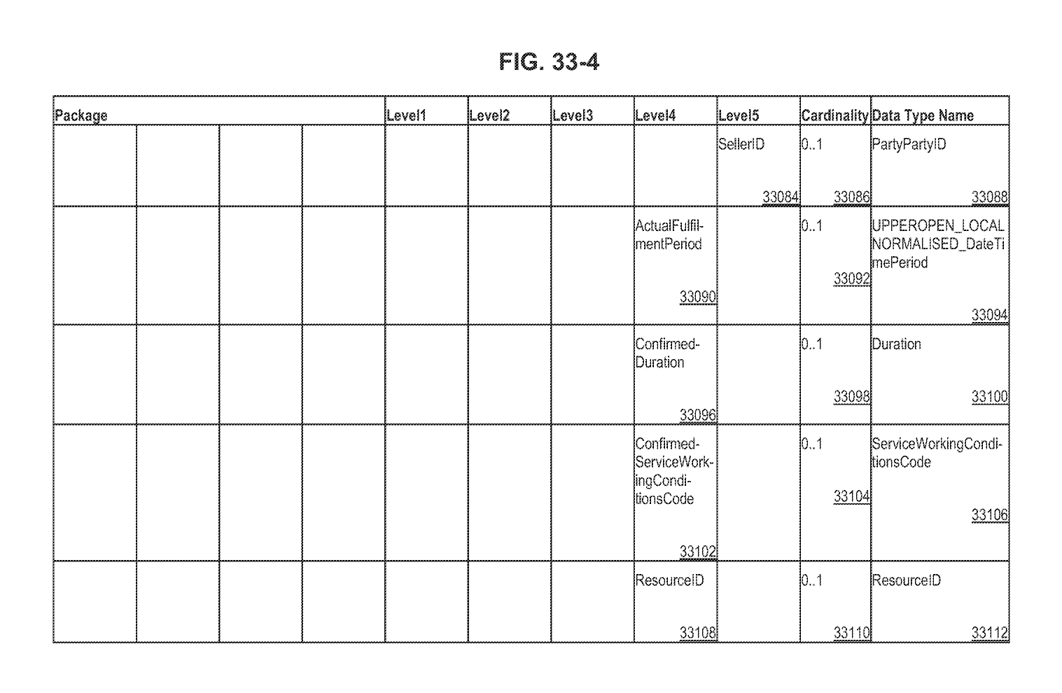

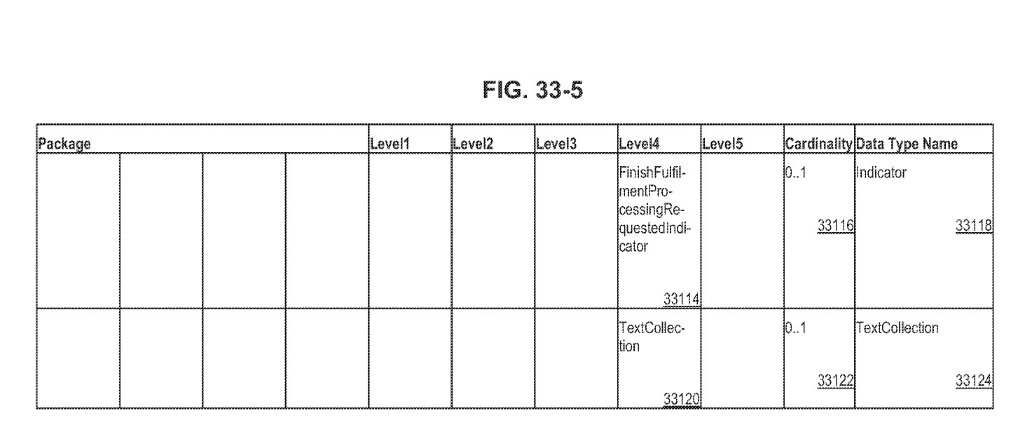

FIGS. 33-1 through 33-5 show an example configuration of an Element Structure that includes an ExternalServicePerformingAndChargingSystemServiceConfirmationCreateRequest 33000 package. Specifically, these figures depict the arrangement and hierarchy of various components such as one or more levels of packages, entities, and datatypes, shown here as 33000 through 33124. As described above, packages may be used to represent hierarchy levels. Entities are discrete business elements that are used during a business transaction. Data types are used to type object entities and interfaces with a structure. For example, the ExternalServicePerformingAndChargingSystemServiceConfirmationCreateRequest 33000 includes, among other things, an ExternalServicePerformingAndChargingSystemServiceConfirmationCreateRequest 33002. Accordingly, heterogeneous applications may communicate using this consistent message configured as such.

The ExternalServicePerformingAndChargingSystemServiceConfirmationCreateRequest 33000 package is an ExternalServicePerformingAndChargingSystemServiceConfirmationCreateMessage 33004 data type. The ExternalServicePerformingAndChargingSystemServiceConfirmationCreateRequest 33000 package includes an ExternalServicePerformingAndChargingSystemServiceConfirmationCreateRequest 33002 entity. The ExternalServicePerformingAndChargingSystemServiceConfirmationCreateRequest 33000 package includes various packages, namely a MessageHeader 33006 and an ExternalServicePerformingAndChargingSystemServiceConfirmation 33014.

The MessageHeader 33006 package is a BusinessDocumentMessageHeader 33012 data type. The MessageHeader 33006 package includes a MessageHeader 33008 entity. The MessageHeader 33008 entity has a cardinality of 0..1 33010 meaning that for each instance of the MessageHeader 33006 package there may be one MessageHeader 33008 entity.

The ExternalServicePerformingAndChargingSystemServiceConfirmation 33014 package is an ExternalServicePerformingAndChargingSystemServiceConfirmation 33020 data type. The ExternalServicePerformingAndChargingSystemServiceConfirmation 33014 package includes an ExternalServicePerformingAndChargingSystemServiceConfirmation 33016 entity. The ExternalServicePerformingAndChargingSystemServiceConfirmation 33014 package includes an Item 33046 package. The ExternalServicePerformingAndChargingSystemServiceConfirmation 33016 entity has a cardinality of 0..1 33018 meaning that for each instance of the ExternalServicePerformingAndChargingSystemServiceConfirmation 33014 package there may be one ExternalServicePerformingAndChargingSystemServiceConfirmation 33016 entity. The ExternalServicePerformingAndChargingSystemServiceConfirmation 33016 entity includes various attributes, namely a CustomerContractID 33022, a Name 33028, a TextCollection 33034 and an AttachmentFolder 33040.

The CustomerContractID 33022 attribute is a BusinessTransactionDocumentID 33026 data type. The CustomerContractID 33022 attribute has a cardinality of 0..1 33024 meaning that for each instance of the ExternalServicePerformingAndChargingSystemServiceConfirmation 33016 entity there may be one CustomerContractID 33022 attribute. The Name 33028 attribute is an EXTENDED_Name 33032 data type. The Name 33028 attribute has a cardinality of 0..1 33030 meaning that for each instance of the ExternalServicePerformingAndChargingSystemServiceConfirmation 33016 entity there may be one Name 33028 attribute.

The TextCollection 33034 attribute is a TextCollection 33038 data type. The TextCollection 33034 attribute has a cardinality of 0..1 33036 meaning that for each instance of the ExternalServicePerformingAndChargingSystemServiceConfirmation 33016 entity there may be one TextCollection 33034 attribute. The AttachmentFolder 33040 attribute is an AttachmentFolder 33044 data type. The AttachmentFolder 33040 attribute has a cardinality of 0..1 33042 meaning that for each instance of the ExternalServicePerformingAndChargingSystemServiceConfirmation 33016 entity there may be one AttachmentFolder 33040 attribute.

The Item 33046 package is an ExternalServicePerformingAndChargingSystemServiceConfirmationItem 33052 data type. The Item 33046 package includes an Item 33048 entity. The Item 33048 entity has a cardinality of 0..N 33050 meaning that for each instance of the Item 33046 package there may be one or more Item 33048 entities. The Item 33048 entity includes various attributes, namely a CustomerContractItemID 33054, a Description 33060, a Product 33066, a Quantity 33072, an ActualFulfillmentPeriod 33090, a ConfirmedDuration 33096, a ConfirmedServiceWorkingConditionsCode 33102, a ResourceID 33108, a FinishFulfillmentProcessingRequestedIndicator 33114 and a TextCollection 33120. The Item 33048 entity includes a ServicePerformerParty 33078 subordinate entity.

The CustomerContractItemID 33054 attribute is a Business TransactionDocumentItemID 33058 data type. The CustomerContractItemID 33054 attribute has a cardinality of 0..1 33056 meaning that for each instance of the Item 33048 entity there may be one CustomerContractItemID 33054 attribute. The Description 33060 attribute is a SHORT_Description 33064 data type. The Description 33060 attribute has a cardinality of 0..1 33062 meaning that for each instance of the Item 33048 entity there may be one Description 33060 attribute.

The Product 33066 attribute is a BUYERSELLER_BusinessTransactionDocumentProduct 33070 data type. The Product 33066 attribute has a cardinality of 0..1 33068 meaning that for each instance of the Item 33048 entity there may be one Product 33066 attribute. The Quantity 33072 attribute is a Quantity 33076 data type. The Quantity 33072 attribute has a cardinality of 0..1 33074 meaning that for each instance of the Item 33048 entity there may be one Quantity 33072 attribute.

The ActualFulfillmentPeriod 33090 attribute is an UPPEROPEN_LOCALNORMALISED_DateTimePeriod 33094 data type. The ActualFulfillmentPeriod 33090 attribute has a cardinality of 0..1 33092 meaning that for each instance of the Item 33048 entity there may be one ActualFulfillmentPeriod 33090 attribute.

The ConfirmedDuration 33096 attribute is a Duration 33100 data type. The ConfirmedDuration 33096 attribute has a cardinality of 0..1 33098 meaning that for each instance of the Item 33048 entity there may be one ConfirmedDuration 33096 attribute.

The ConfirmedServiceWorkingConditionsCode 33102 attribute is a ServiceWorkingConditionsCode 33106 data type. The ConfirmedServiceWorkingConditionsCode 33102 attribute has a cardinality of 0..1 33104 meaning that for each instance of the Item 33048 entity there may be one ConfirmedServiceWorkingConditionsCode 33102 attribute. The ResourceID 33108 attribute is a ResourceID 33112 data type. The ResourceID 33108 attribute has a cardinality of 0..1 33110 meaning that for each instance of the Item 33048 entity there may be one ResourceID 33108 attribute.

The FinishFulfillmentProcessingRequestedIndicator 33114 attribute is an Indicator 33118 data type. The FinishFulfillmentProcessingRequestedIndicator 33114 attribute has a cardinality of 0..1 33116 meaning that for each instance of the Item 33048 entity there may be one FinishFulfillmentProcessingRequestedIndicator 33114 attribute. The TextCollection 33120 attribute is a TextCollection 33124 data type. The TextCollection 33120 attribute has a cardinality of 0..1 33122 meaning that for each instance of the Item 33048 entity there may be one TextCollection 33120 attribute.

The ServicePerformerParty 33078 entity has a cardinality of 0..1 33080 meaning that for each instance of the Item 33048 entity there may be one ServicePerformerParty 33078 entity. The ServicePerformerParty 33078 entity includes a SellerID 33084 attribute. The SellerID 33084 attribute is a PartyPartyID 33088 data type. The SellerID 33084 attribute has a cardinality of 0..1 33086 meaning that for each instance of the ServicePerformerParty 33078 entity there may be one SellerID 33084 attribute.

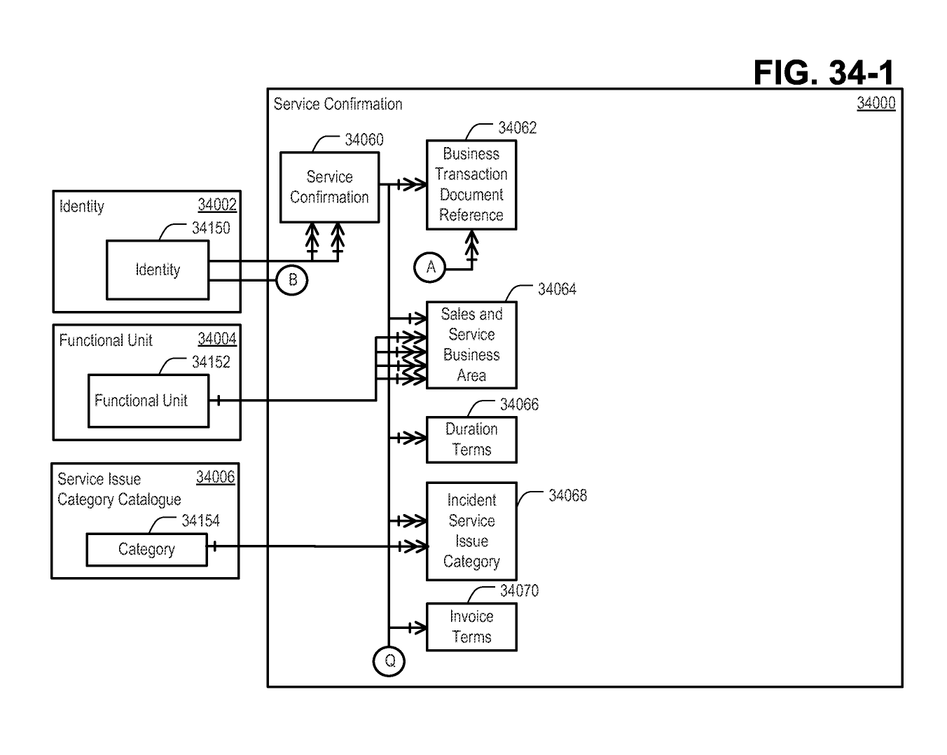

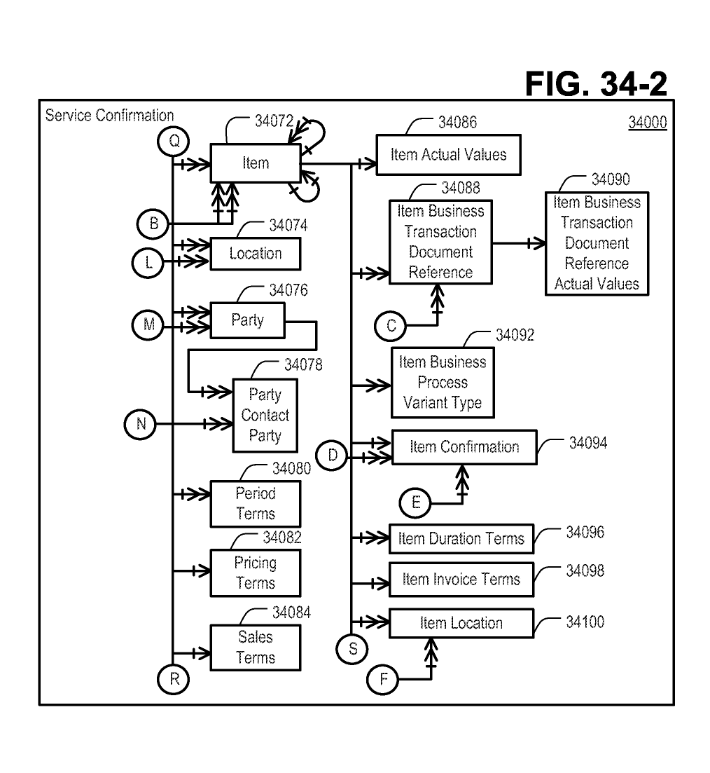

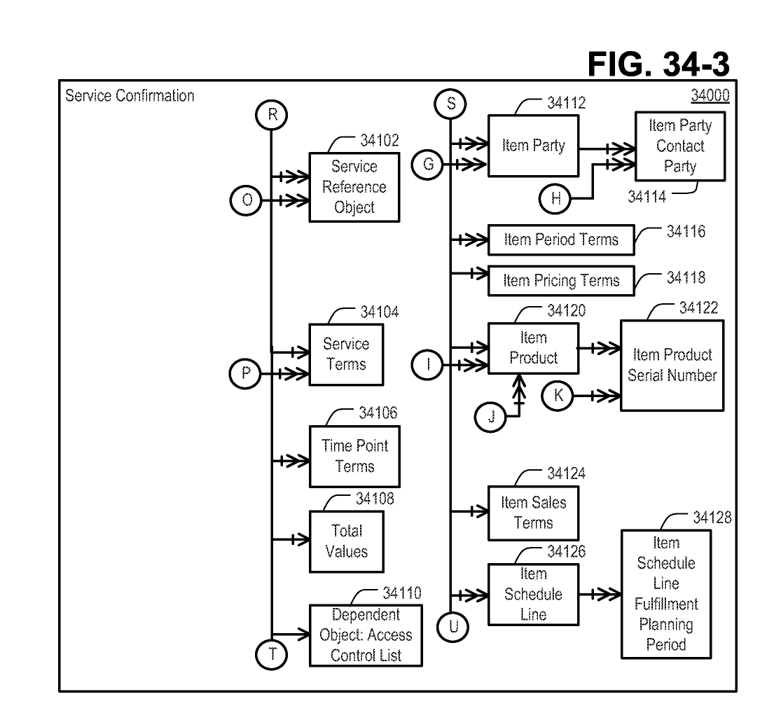

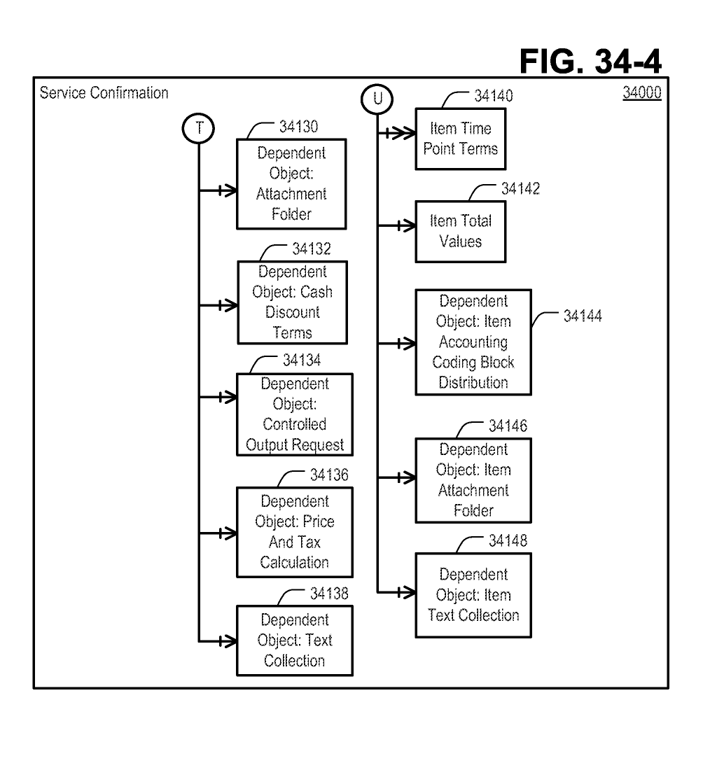

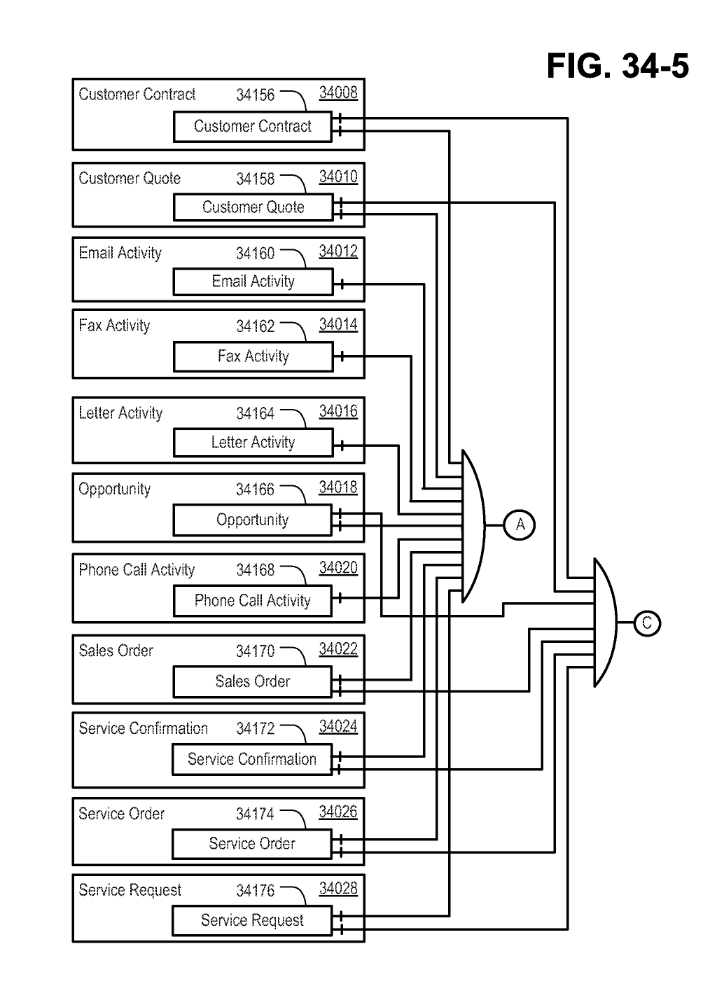

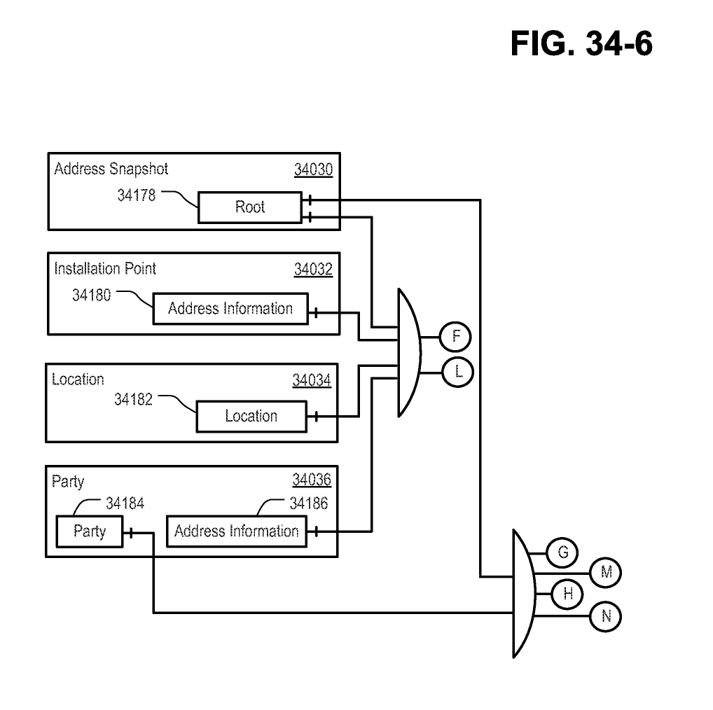

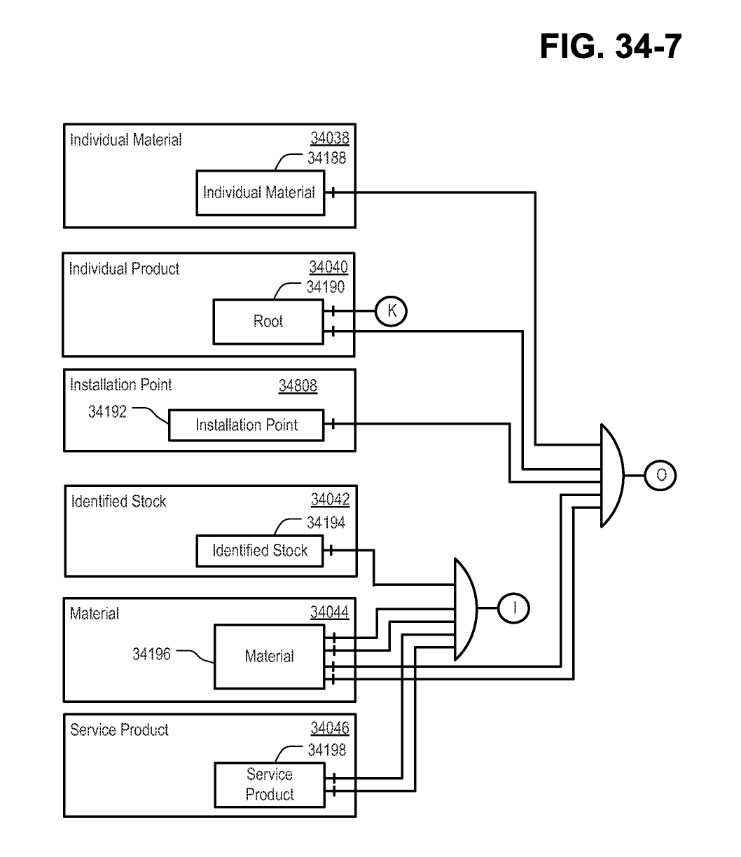

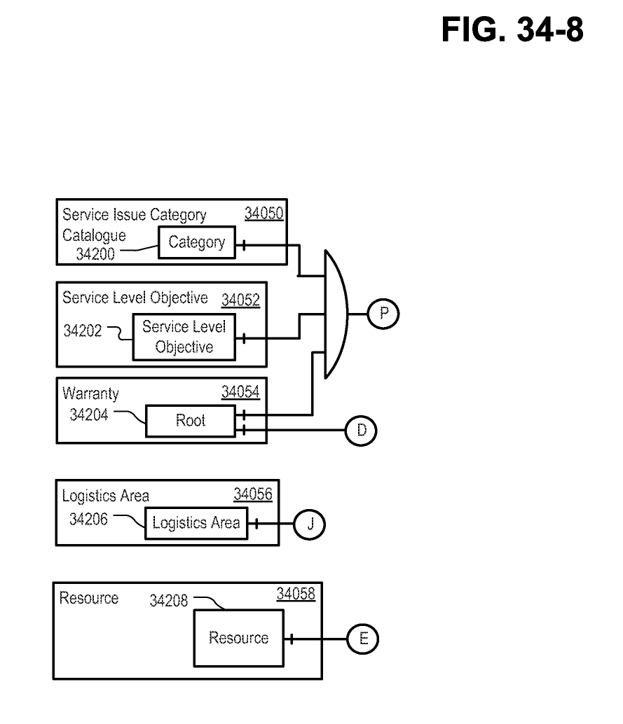

FIG. 34 illustrates an example object model for a Service Confirmation business object 34000. Specifically, the object model depicts interactions among various components of the Service Confirmation business object 34000, as well as external components that interact with the Service Confirmation business object 34000 (shown here as 34002 through 34058 and 34150 through 34208). The Service Confirmation business object 34000 includes elements 34060 through 34148, which can be hierarchical, as depicted. For example, the Service Confirmation entity 34060 hierarchically includes entities 34062 through 34070, among others. Some or all of the entities 34060 through 34148 can correspond to packages and/or entities in the message data types described above.

The business object Service Confirmation is a record of services, spare parts, and expenses that a service performer reports after carrying out a service for a customer. The Service Confirmation business object belongs to the process component Service Confirmation Processing. The Service Confirmation business object belongs to the deployment unit Customer Relationship Management. The Service Confirmation business object is a projection of Customer Transaction Document Template. A service confirmation can be used to document actual working times spent and spare parts used for a service. Such information can be used as a basis for processing customer invoices, updating stock levels for spare parts, carrying out cost accounting, and keeping track of working times, for example. The business object Service Confirmation has an object category of Business Transaction Document and a technical category of Standard Business Object.

A Service Confirmation can include the following groups of information: general header and item information related to the provision of services, including information on business partners, products, organization, service location, and related activities; service-specific information on planned and actual services, spare parts, consumables, and expenses; pricing and invoicing information; and information from related documents, such as statuses from a service request and service order.

The business object Service Confirmation can be involved in the following process component interactions: External Service Performing And Charging System_Service Confirmation Processing, Goods and Service Acknowledgement_Service Confirmation Processing, Service Confirmation Processing_Accounting, Service Confirmation Processing_Customer Invoice Processing, Service Confirmation Processing_Financial Accounting Master Data Management, Service Confirmation Processing_Form External Accounting, Service Confirmation Processing_Form External Inventory Processing, and Service Confirmation Processing_Inventory Processing.

A service interface External Service Performing And Charging System Request Service Confirmation Maintenance In has a technical name of ExternalServicePerformingAndChargingSystemRequestServiceConfirmationMaintenanceIn. The service interface External Service Performing And Charging System Request Service Confirmation Maintenance In is part of the process component interaction External Service Performing And Charging System_Service Confirmation Processing, and is an interface to maintain a service confirmation with reference to a customer contract with data from an external service performing and charging system. A Create Service Confirmation operation has a technical name of ExternalServicePerformingAndChargingSystemRequestServiceConfirmationMaintenanceIn. CreateServiceConfirmation, can be used to create a service confirmation with reference to a customer contract with data from an external service performing and charging system, and can be based on message type External Service Performing And Charging System Service Confirmation Create Request derived from business object Service Confirmation.

A service interface Inventory Changing Out has a technical name of ServiceConfirmationProcessingInventoryChangingOut. The service interface Inventory Changing Out is part of the following process component interactions: Service Confirmation Processing_Form External Inventory Processing, and Service Confirmation Processing_Inventory Processing. The service interface Inventory Changing Out is an interface to notify Inventory Processing of actual spare parts consumed. A Notify of Spare Part Consumption operation has a technical name of ServiceConfirmationProcessingInventoryChangingOut.NotifyOfSparePartConsumption, can be used to notify Inventory Processing about consumption of spare parts, and can be based on message type Goods and Activity Confirmation Inventory Change Notification derived from business object Goods and Activity Confirmation.

A service interface Product and Resource Valuation Out has a technical name of ServiceConfirmationProcessingProductAndResourceValuationOut. The service interface Product and Resource Valuation Out is part of the process component interaction Service Confirmation Processing_Financial Accounting Master Data Management, and is an interface to request product valuation data for service confirmation items. A Request Product Valuation operation has a technical name of ServiceConfirmationProcessingProductAndResourceValuationOut.RequestProductValuation, can be used to request product valuation data for service confirmation items, and can be based on message type Product and Resource Valuation Query and on message type Product and Resource Valuation Response.

A service interface Request Invoicing In has a technical name of ServiceConfirmationProcessingRequestInvoicingIn. The service interface Request Invoicing In is part of the process component interaction Service Confirmation Processing_Customer Invoice Processing, and is an interface to update a service confirmation. A Change Service Confirmation based on Customer Invoice operation has a technical name of ServiceConfirmationProcessingRequestInvoicingIn.ChangeServiceConfirmationBasedOnCustomerInvoice, can be used to update a service confirmation based on information from related customer invoices, and can be based on message type Customer Invoice Issued Confirmation derived from business object Customer Invoice.

A service interface Request Invoicing Out has a technical name of ServiceConfirmationProcessingRequestInvoicingOut. The service interface Request Invoicing Out is part of the process component interaction Service Confirmation Processing_Customer Invoice Processing, and is an interface to request invoicing of a service confirmation. A Request Invoicing operation has a technical name of ServiceConfirmationProcessingRequestInvoicingOut.RequestInvoicing, can be used to request invoicing of services provided and spare parts consumed based on information in a service confirmation, and can be based on message type Customer Invoice Request Request derived from business object Customer Invoice Request.

A service interface Sales And Purchasing Accounting Out has a technical name of ServiceConfirmationProcessingSalesAndPurchasingAccountingOut. The service interface Sales And Purchasing Accounting Out is part of the following process component interactions: Service Confirmation Processing_Accounting, and Service Confirmation Processing_Form External Accounting. The service interface Sales And Purchasing Accounting Out is an interface to notify Accounting that a service confirmation has been processed. A Notify of Service Confirmation operation has a technical name of ServiceConfirmationProcessingSalesAndPurchasingAccountingOut.NotifyOfServiceConfirmation, notifies Accounting about a creation/change/deletion of a service confirmation, including a notification about a corresponding service provision, and can be based on message type Sales And Purchasing Accounting Notification derived from business object Accounting Notification.

A service interface Service Confirmation In has a technical name of ServiceConfirmationProcessingServiceConfirmationIn. The service interface Service Confirmation In is part of the process component interaction Goods and Service Acknowledgement_Service Confirmation Processing, and is an interface to maintain a service confirmation. A Maintain operation has a technical name of ServiceConfirmationProcessingServiceConfirmationIn.Maintain, can be used to maintain a service confirmation, and can be based on message type Service Confirmation Request derived from business object Service Confirmation.

The business object Service Confirmation has a Root node, which can be time dependent on a Time Point object. The elements located directly at the node Service Confirmation are defined by the data type CustomerTransactionDocumentElements. These elements include: ID, BuyerID, TypeCode, ProcessingTypeCode, DateTime, Name, BuyerDateTime, BuyerName, DataOriginTypeCode, SystemAdministrativeData, UUID, FulfillmentBlockingReasonCode, MigratedDataAdaptationTypeCode, and Status. Status can include Status/ItemListCancellationStatusCode, Status/ItemListCustomerOrderLifeCycleStatusCode, Status/ItemListFulfillmentProcessingStatusCode, Status/ItemListInvoiceProcessingStatusCode, Status/ConsistencyStatusCode, Status/GeneralDataCompletenessStatusCode, and Status/InvoicingBlockingStatusCode.

ID may be an alternative key, is a unique identifier assigned by a seller for a Customer Transaction Document, and may be based on datatype GDT: BusinessTransactionDocumentID. BuyerID is a unique identifier for a Customer Transaction Document assigned by a buyer, and may be based on datatype GDT: BusinessTransactionDocumentID. TypeCode may be optional, is an encoded representation of a type of Customer Transaction Document, may be based on datatype GDT: BusinessTransactionDocumentTypeCode, can be set internally, can include a fixed value CustomerTransactionDocumentTemplate, and can be used to display the type in cross-business object lists, for example. ProcessingTypeCode is an encoded representation of Customer Transaction Document processing in a process component, and may be based on datatype GDT: BusinessTransactionDocumentProcessingTypeCode. The ProcessingTypeCode “transaction type” includes standard orders, for example. DateTime may be optional, is a creation date time of a Customer Transaction Document from a business perspective, and may be based on datatype GDT: GLOBAL_DateTime. Name is a name of a Customer Transaction Document, and may be based on datatype GDT: EXTENDED_Name. BuyerDateTime may be optional, is a date time assigned by a buyer for a Customer Transaction Document, and may be based on datatype GDT: GLOBAL_DateTime, with a qualifier of Buyer. BuyerName is a short-text description for a Customer Transaction Document assigned by a buyer, and may be based on datatype GDT: MEDIUM_Name. DataOriginTypeCode is a type of a source of a Customer Transaction Document, and may be based on datatype GDT: CustomerTransactionDocumentDataOriginTypeCode. SystemAdministrativeData includes administrative data stored in a system, such as system users and change dates/times, and may be based on datatype GDT: SystemAdministrativeData. UUID may be an alternative key, is a universally unique Customer Transaction Document identifier, can be assigned internally, and may be based on datatype GDT: UUID. FulfillmentBlockingReasonCode may be optional, specifies why a Customer Transaction Document document is blocked for the delivery of goods or the provision of services, and may be based on datatype GDT: CustomerTransactionDocumentFulfillmentBlockingReasonCode. MigratedDataAdaptationTypeCode may be optional, is a coded representation of the type of data adaptation performed during migration of a customer transaction document, and may be based on datatype GDT: MigratedDataAdaptationTypeCode. When migrating data from a source system to a target system data may be adapted. For example, a business object or business document may be taken over completely or partially. In some implementations, MigratedDataAdaptationTypeCode is used when a CustomerTransactionDocument is migrated. Status may be optional, describes statuses of a Customer Transaction Document, and may be based on datatype BOIDT: CustomerTransactionDocumentStatus. Status/ItemListCancellationStatusCode may be optional, aggregates a cancellation status of one or more items, and may be based on datatype GDT: CancellationStatusCode. Status/ItemListCustomerOrderLifeCycleStatusCode may be optional, aggregates a life cycle status of one or more items, and may be based on datatype GDT: CustomerOrderLifeCycleStatusCode. Status/ItemListFulfillmentProcessingStatusCode may be optional, aggregates a fulfillment status of one or more items, and may be based on datatype GDT: ProcessingStatusCode, with a qualifier of Fulfillment. Status/ItemListInvoiceProcessingStatusCode may be optional, represents an aggregated representation of InvoicingStatus of one or more items, and may be based on datatype GDT: ProcessingStatusCode, with a qualifier of Invoice. Status/ConsistencyStatusCode may be optional, describes a status consisting of errors, such as where business data is not consistent, or where data includes errors, and may be based on datatype GDT: ConsistencyStatusCode. Status/GeneralDataCompletenessStatusCode may be optional, indicates whether all or part of general business data is missing, and may be based on datatype GDT: DataCompletenessStatusCode, with a qualifier of General. Status/InvoicingBlockingStatusCode may be optional, represents a block of an invoicing process, and may be based on datatype GDT: BlockingStatusCode, with a qualifier of Invoicing.

The following composition relationships to subordinate nodes exist: BusinessTransactionDocumentReference, with a cardinality of 1:CN; SalesAndServiceBusinessArea, with a cardinality of 1:C; DurationTerms, with a cardinality of 1:CN; IncidentServiceIssueCategory, with a cardinality of 1:CN; InvoiceTerms, with a cardinality of 1:C; Item, with a cardinality of 1:CN; Location, with a cardinality of 1:CN; PeriodTerms, with a cardinality of 1:CN; PricingTerms, with a cardinality of 1:C; SalesTerms, with a cardinality of 1:C; ServiceReferenceObject, with a cardinality of 1:CN; ServiceTerms, with a cardinality of 1:C; TimePointTerms, with a cardinality of 1:CN; TotalValues, with a cardinality of 1:C; and Party, with a cardinality of 1:CN, which may be filtered. The filter elements are defined by the data type PartyFilterElements. These elements include: RoleCategoryCode and MainIndicator. RoleCategoryCode may be optional and may be based on datatype GDT: PartyRoleCategoryCode. MainIndicator may be optional and may be based on datatype GDT: Indicator.

The following composition relationships to dependent objects exist: AccessControlList, with a cardinality of 1:1, which is a list of access groups that have access to a CustomerTransactionDocument; AttachmentFolder, with a cardinality of 1:C, which is a collection of documents attached for a CustomerTransactionDocument; CashDiscountTerms, with a cardinality of 1:C, which include data used for a CustomerTransactionDocument for handling payments; ControlledOutputRequest, with a cardinality of 1:C, which is a controller of output requests and processed output requests related to a CustomerTransactionDocument; PriceAndTaxCalculation, with a cardinality of 1:C, which includes price and tax components determined by price and tax determination/valuation that are valid for a CustomerTransactionDocument; and TextCollection, with a cardinality of 1:C, which is a collection of natural-language texts that refer to a CustomerTransactionDocument.

The following inbound association relationships may exist: Creation Identity, from the business object Identity/node Identity, with a cardinality of 1:CN, which is an identity of a user who created a Customer Transaction Document; and Last Change Identity, from the business object Identity/node Identity, with a cardinality of 1:CN, which is an identity of a user who last changed a Customer Transaction Document.

The following specialization associations for navigation may exist: Business Document Flow, to the business object Business Document Flow/node Business Document Flow, with a target cardinality of C, which is an association from a BusinessDocumentFlow which is a view on a set of preceding and succeeding business transaction documents for a current CustomerTransactionDocumentTemplate document; Main Incident Service Issue Category, to the node Incident Service Issue Category, with a target cardinality of C, which is an association to an IncidentServiceIssueCategory representing a main issue category of an individual issue; Customer Service Confirmation Item, to the node Item, with a target cardinality of CN, which is an association to an item that occurs in the CustomerServiceConfirmationItem specialization; Customer Spare Part Confirmation Item, to the node Item, with a target cardinality of CN, which is an association to an item that occurs in the CustomerSparePartConfirmationItem specialization; Requested Fulfillment Period, to the node Period Terms, with a target cardinality of C, which is an association to a PeriodTerms that occurs in the RequestedFulfillmentPeriod specialization; Validity Period, to the node Period Terms, with a target cardinality of C, which is an association to a PeriodTerms that occurs in the ValidityPeriod specialization; Main Service Reference Object, to the node Service Reference Object, with a target cardinality of C, which is an association to an object to which a service refers; and Incident Description Text Collection Text, to the node Text, with a target cardinality of C, which is an association to text of type incident description in a text collection.

The following specialization associations for navigation may exist to the node Business Transaction Document Reference: Activity Reference, with a target cardinality of CN, which is an association to a reference that occurs in the EmailActivityReference specialization; Base Business Transaction Document Reference, with a target cardinality of C, which is an association to a reference that occurs in a specialization which can be used as a basis, e.g., in a use case of returns, the BaseBusinessTransactionDocumentReference can be either a sales order or a customer invoice; Base Service Order Reference, with a target cardinality of C, which is an association to a reference that occurs in the ServiceOrderReference specialization and is used as a basis; Customer Complaint Reference, with a target cardinality of CN, which is an association to a reference that occurs in the CustomerComplaintReference specialization; Customer Invoice Reference, with a target cardinality of CN, which is an association to a reference that occurs in the InvoiceReference specialization; Email Activity Reference, with a target cardinality of CN, which is an association to a reference that occurs in the EmailActivityReference specialization; PhoneCallActivityReference, with a target cardinality of CN, which is an association to a reference that occurs in the PhoneCallActivityReference specialization; LetterActivityReference, with a target cardinality of CN, which is an association to a reference that occurs in the LetterActivityReference specialization; FaxActivityReference, with a target cardinality of CN, which is an association to a reference that occurs in the FaxActivityReference specialization; AppointmentActivityReference, with a target cardinality of CN, which is an association to a reference that occurs in the AppointmentActivityReference specialization; OpportunityReference, with a target cardinality of CN, which is an association to a reference that occurs in the OpportunityReference specialization; SelectedDocumentReference, with a target cardinality of CN, which is an association for navigation to selected business document references that are important for a business document flow; ActivityReference, with a target cardinality of CN, which is an association to a reference that occurs in the ActivityReference specialization; Fax Activity Reference, with a target cardinality of CN, which is an association to a reference that occurs in the FaxActivityReference specialization; Letter Activity Reference, with a target cardinality of CN, which is an association to a reference that occurs in the LetterActivityReference specialization; Outbound Delivery Reference, with a target cardinality of CN, which is an association to a reference that occurs in the OutboundDeliveryReference specialization; Phone Call Activity Reference, with a target cardinality of CN, which is an association to a reference that occurs in the PhoneCallActivityReference specialization; Preceding Customer Quote Reference, with a target cardinality of CN, which is an association to a reference that occurs in the CustomerQuoteReference specialization and that are preceding; Purchase Order Reference, with a target cardinality of C, which is an association to a reference that occurs in the PurchaseOrderReference specialization; Sales Order Reference, with a target cardinality of CN, which is an association to a BTDReference that occurs in the SalesOrderReference specialization; Selected Document Reference, with a target cardinality of CN, which is an association for navigation to selected business document references that are used with a business document flow; ActivityReference, with a target cardinality of CN, which is an association to a reference that occurs in the ActivityReference specialization; Service Confirmation Reference, with a target cardinality of CN, which is an association to a reference that occurs in the ServiceConfirmationReference specialization; Service Contract Reference, with a target cardinality of CN, which is an association to a reference that occurs in the ServiceOrderReference specialization; and Service Request Reference, with a target cardinality of C, which is an association to a reference that occurs in the ServiceRequestReference specialization.

The following specialization associations for navigation may exist to the node Duration Terms Maximum Completion Duration, with a target cardinality of C, which is an association to a DurationTerms that occurs in the MaximumCompletionDuration specialization; Maximum First Reaction Duration, with a target cardinality of C, which is an association to a DurationTerms that occurs in the MaximumFirstReactionDuration specialization; Request Maximum Provider Completion Duration, with a target cardinality of C, which is an association to a DurationTerms that occurs in the RequestMaximumProviderCompletionDuration specialization; Request Total Processing Duration, with a target cardinality of C, which is an association to a DurationTerms that occurs in the RequestTotalProcessingDuration specialization; Request Total Provider Processing Duration, with a target cardinality of C, which is an association to a DurationTerms that occurs in the RequestTotalProviderProcessingDuration specialization; Request Total Requestor Duration, with a target cardinality of C, which is an association to a DurationTerms that occurs in the RequestTotalRequestorDuration specialization; Request Total Initial Reaction Duration, with a target cardinality of C, which is an association to a DurationTerms that occurs in the RequestTotalInitialReactionDuration specialization.

The following specialization associations for navigation may exist to the node Location: Service Point Location, with a target cardinality of C, which is a Location that occurs in the ServicePointLocation specialization; Ship From Location, with a target cardinality of C, which is an association to a Location that occurs in the ShipFromLocation specialization; and Ship to Location, with a target cardinality of C, which is an association to a Location that occurs in the ShipToLocation specialization.

The following specialization associations for navigation may exist to the node Party: Bill to Party, with a target cardinality of C, which is an association to a Party that occurs in the BillToParty specialization; Buyer Party, with a target cardinality of C, which is an association to a Party that occurs in the BuyerParty specialization; Employee Responsible Party, with a target cardinality of C, which is an association to a Party that occurs in the EmployeeResponsible specialization; Service Execution Team Party, with a target cardinality of C, which is an association to a Party that occurs in the ServiceExecutionTeam specialization; Freight Forwarder Party, with a target cardinality of C, which is an association to a Party that occurs in the FreightForwarderParty specialization; Payer Party, with a target cardinality of C, which is an association to a Party that occurs in the PayerParty specialization; Processor Party, with a target cardinality of C, which is an association to a Party that occurs in the Processor specialization; Product Recipient Party, with a target cardinality of C, which is an association to a Party that occurs in the ProductRecipientParty specialization; Sales Unit Party, with a target cardinality of C, which is an association to a Party that occurs in the SalesUnit specialization; Seller Party, with a target cardinality of C, which is an association to a Party that occurs in the SellerParty specialization; Service Performer Party, with a target cardinality of C, which is an association to a Party that occurs in the ServicePerformer specialization; Service Support Team Party, with a target cardinality of C, which is an association to a Party that occurs in the ServiceSupportTeam specialization; and Vendor Party, with a target cardinality of C, which is an association to a Party that occurs in the VendorParty specialization.

The following specialization associations for navigation may exist to the node Time Point Terms Actual Arrival at Customer Time Point, with a target cardinality of C, which is an association to a TimePointTerms that occurs in the ActualArrivalAtCustomer TimePoint specialization; Completion Due Time Point, with a target cardinality of C, which is an association to a TimePointTerms that occurs in the CompletionDueTimePoint specialization; Completion Time Point, with a target cardinality of C, which is an association to a TimePointTerms that occurs in the CompletionTimePoint specialization; First Reaction Due Time Point, with a target cardinality of C, which is an association to a TimePointTerms that occurs in the FirstReactionDueTimePoint specialization; Incident Completion Time Point, with a target cardinality of C, which is an association to a TimePointTerms that occurs in the IncidentCompletionTimePoint specialization; Request Closed at Time Point, with a target cardinality of C, which is an association to a TimePointTerms that occurs in the RequestClosedAtTimePoint specialization; Request Completion by Provider Due Time Point, with a target cardinality of C, which is an association to a TimePointTerms that occurs in the RequestCompletionByProviderDueTimePoint specialization; Request Finished at Time Point, with a target cardinality of C, which is an association to a TimePointTerms that occurs in the RequestFinishedAtTimePoint specialization; Request Initial Receipt Time Point, with a target cardinality of C, which is an association to a TimePointTerms that occurs in the RequestInitialReceiptTimePoint specialization; Request in Process at Time Point, with a target cardinality of C, which is an association to a TimePointTerms that occurs in the RequestlnProcessAtTimePoint specialization; Request Receipt Time Point, with a target cardinality of C, which is an association to a TimePointTerms that occurs in the RequestReceiptTimePoint specialization; Request Received From Provider at Time Point, with a target cardinality of C, which is an association to a TimePointTerms that occurs in the RequestReceivedFromProviderAtTimePoint specialization; Request Sent to Provider at Time Point, with a target cardinality of C, which is an association to a TimePointTerms that occurs in the RequestSentToProviderAtTimePoint specialization; and Warranty Start Reference Time Point, with a target cardinality of C, which is an association to a TimePointTerms that occurs in the WarrantyStartReferenceTimePoint specialization.

In some implementations, TypeCode and ProcessingTypeCode are not changed after they have been created. In some implementations, SystemAdministrativeData is set internally by the system and subsequently is not assigned or changed externally. In some implementations, once a CustomerTransactionDocumentTemplate has been created, the document may only be deleted if no subsequent processes have been started that are mapped via statuses that forbid a delete action. In such a case, the document can be canceled but not deleted.

An Add Reference with Data Provision action adds a BusinessTransactionDocumentReference and provides relevant data from a referenced document to a CustomerTransactionDocument. The action elements are defined by the data type CustomerTransactionDocumentAddReferenceWithDataProvisionActionElements. These elements include BusinessTransactionDocumentKey, which may include BusinessTransactionDocumentID and BusinessTransactionDocumentTypeCode. BusinessTransactionDocumentKey may be optional, is a unique key assigned by a seller for a Customer Transaction Document, and may be based on datatype KDT: BusinessTransactionDocumentKey. BusinessTransactionDocumentKey/BusinessTransactionDocumentID may be optional, is a unique identifier for a business transaction document, and may be based on datatype GDT: BusinessTransactionDocumentID. Business TransactionDocumentKey/BusinessTransactionDocumentTypeCode may be optional, is a coded representation of a document type that occurs in business transactions, and may be based on datatype GDT: BusinessTransactionDocumentTypeCode. A document type describes a business nature of similar documents and defines basic features of such a type of documents.

A Block Invoicing action blocks one or more CustomerTransactionDocuments for invoicing by setting an invoicing block. The Block Invoicing action can be valid for invoice-relevant CustomerTransactionDocumentTemplate documents. The Block Invoicing action sets a status variable ‘InvoicingBlocking’ to ‘blocked’. The action elements are defined by the data type CustomerTransactionDocumentBlockInvoicingActionElements. These elements include InvoicingBlockingReasonCode, which may be optional, specifies why processing of invoicing documents is blocked for a business transaction item, and may be based on datatype GDT: InvoicingBlockingReasonCode.

A Check Consistency action checks a CustomerTransactionDocument for errors and sets a ConsistencyStatus to either ‘Consistent’ or ‘Inconsistent’. A Check General Data Completeness action checks for general data completeness. A Copy action creates a customer transaction document from an existing customer transaction document, from which relevant data is copied. The two customer transaction documents are not necessarily linked in a business sense. A Create From Business Partner action creates a CustomerTransactionDocument with a provided Business Partner as a buyer party. A Create with Reference action creates a CustomerTransactionDocument with reference to an existing document, from which relevant data is transferred.

A Take Over for Processing action replaces a ProcessorParty of a CustomerTransactionDocument with an Employee derived from a system user. The Employee can thus become a processor for the CustomerTransactionDocument. The Take Over for Processing action can be called from a user interface.

An Unblock Invoicing action removes an invoice block. The Unblock Invoicing action can be valid for invoice-relevant CustomerTransactionDocumentTemplate documents with an invoice block and can change an InvoiceBlock status from ‘blocked’ to ‘not blocked’.

A Select All query provides the NodeIDs of all instances of the node and can be used to enable an initial load of data for a Fast Search Infrastructure. A Query By Elements query returns a list of CustomerTransactionDocumentTemplate documents including specified selection criteria. The selection criteria can be specified by a logical ‘AND’ combination of query elements. The query elements are defined by the data type CustomerTransactionDocumentElementsQueryElements. These elements include: ID, DateTime, Name, SystemAdministrativeData, CreationBusinessPartnerCommonPersonNameGivenName, CreationBusinessPartnerCommonPersonNameFamilyName, LastChangeBusinessPartnerCommonPersonNameGivenName, LastChangeBusinessPartnerCommonPersonNameFamilyName, SalesAndServiceBusinessAreaServiceOrganisationID, PartyBuyerPartyKey, BuyerPartyContactPartyPartyKey, PartySalesUnitPartyKey, PartyEmployeeResponsiblePartyKey, PartyProcessorPartyKey, PartyServicePerformerPartyKey, PartyServiceSupportTeamPartyKey, PartyPartyKey, PartyName, PartyAdditionalName, PartySortingFormattedName, PartyServiceExecutionTeamPartyKey, PartyRoleCode, ItemDescription, ItemProductProductKey, ItemProductProductInternalID, ItemProductProductRequirementSpecificationKey, ItemCustomerOrderLifeCycleStatusCode, ItemCustomerContractLifeCycleStatusCode, ItemLastChangeDateTime, ServiceTermsServiceIssueCategoryCatalogueCategoryKey, SolutionProposalCustomerProblemAndSolutionKey, ServiceReferenceObjectMainMaterialKey, ServiceReferenceObjectMainIndividualMaterialKey, IncidentServiceIssueCategoryMainServiceIssueCategoryCatalogueCategoryKey, BusinessTransactionDocumentReferenceBusinessTransactionDocumentReferenceID, BusinessTransactionDocumentReferenceBusinessTransactionDocumentReferenceTypeCode, TimePointTermsFirstReactionDueTimePoint, TimePointTermsCompletionDueTimePoint, ItemTimePointTermsCompletionDueTimePoint, TimePointTermsRequestInitialReceiptTimePoint, ValidityPeriod, PricingTermsWarrantyGoodwillCode, SolutionProposalExternalKnowledgeBaseArticleID, PeriodTermsRequestedFulfillmentPeriod, SearchText, and Status.

ItemProductProductKey can include ItemProductProductKey/ProductTypeCode, ItemProductProductKey/ProductidentifierTypeCode, and ItemProductProductKey/ProductID. Status can include Status/ItemListCancellationStatusCode, Status/ItemListCustomerOrderLifeCycleStatusCode, Status/ItemListFulfillmentProcessingStatusCode, Status/ItemListInvoiceProcessingStatusCode, Status/ConsistencyStatusCode, Status/InvoicingBlockingStatusCode, Status/ItemListCustomerContractLifeCycleStatusCode, Status/ItemListValidityStatusCode, Status/ItemListReleaseStatusCode, Status/CustomerContractTemplateLifeCycleStatusCode, Status/CreditWorthinessStatusCode, and Status/ItemListFollowUpProcessingStatusCode.

ID is a unique identifier assigned by a seller for a Customer Transaction Document, and may be based on datatype GDT: BusinessTransactionDocumentID. DateTime is a creation time posting time of a Customer Transaction Document, from a business perspective, and may be based on datatype GDT: GLOBAL_DateTime, with a qualifier of Posting. Name is a name of a Customer Transaction Document, and may be based on datatype GDT: MEDIUM_Name. SystemAdministrativeData includes administrative data stored in a system, such as system users and change dates/times, and may be based on datatype GDT: SystemAdministrativeData. CreationBusinessPartnerCommonPersonNameGivenName may be based on datatype GDT: MEDIUM_Name. CreationBusinessPartnerCommonPersonNameFamilyName may be based on datatype GDT: MEDIUM_Name. LastChangeBusinessPartnerCommonPersonNameGivenName may be based on datatype GDT: MEDIUM_Name. LastChangeBusinessPartnerCommonPersonNameFamilyName may be based on datatype GDT: MEDIUM_Name. SalesAndServiceBusinessAreaServiceOrganisationID is an identifier for a service organization, and may be based on datatype GDT: OrganisationalCentreID. PartyBuyerPartyKey is an identifier for a BuyerParty, and may be based on datatype KDT: PartyKey. PartyBuyerPartyKey can include PartyBuyerPartyKey/PartyID, which is an identifier for a party, and may be based on datatype GDT: PartyID. BuyerPartyContactPartyPartyKey may be based on datatype KDT: PartyKey. BuyerPartyContactPartyPartyKey can include BuyerPartyContactPartyPartyKey/PartyID, which is an identifier for a party, and may be based on datatype GDT: PartyID.

PartySalesUnitPartyKey is a key to identify a sales unit party, and may be based on datatype KDT: PartyKey. PartyEmployeeResponsiblePartyKey is an identifier of a responsible employee, and may be based on datatype KDT: PartyKey. PartyProcessorPartyKey is an identifier of a processor of a Customer Transaction Document document, and may be based on datatype KDT: PartyKey. PartyServicePerformerPartyKey is an identifier of a service performer, and may be based on datatype KDT: PartyKey. PartyServicePerformerPartyKey can include PartyServicePerformerPartyKey/PartyID, which is an identifier for a party, and may be based on datatype GDT: PartyID. PartyServiceSupportTeamPartyKey may be based on datatype KDT: PartyKey. PartyPartyKey is an identifier for a Party or ItemParty in a business document, and may be based on datatype KDT: PartyKey. PartyPartyKey can include PartyPartyKey/PartyID, which is an identifier for a party, and may be based on datatype GDT: PartyID. PartyName is a name of a party that occurs in a customer transaction document, such as a FamilyName based on BusinessPartnerCommonPersonNameFamilyName, and may be based on datatype GDT: MEDIUM_Name, with a qualifier of Party. PartyAdditionalName is an additional name of a party that occurs in a customer transaction document, such as a given name of a business partner based on BusinessPartnerCommonPersonNameGivenName, and may be based on datatype GDT: LANGUAGEINDEPENDENT_MEDIUM_Name, with a qualifier of PartyAdditional. PartySortingFormattedName is a sorting formatted name of a party that occurs in a customer transaction document, such as a SortingFormattedName of a business partner based on BusinessPartnerCommonSortingFormattedName, and may be based on datatype GDT: LONG Name. PartyServiceExecutionTeamPartyKey may be based on datatype KDT: PartyKey. PartyServiceExecutionTeamPartyKey may include PartyServiceExecutionTeamPartyKey/PartyID, which is an identifier for a party, and may be based on datatype GDT: PartyID. PartyRoleCode is a party role for a Party or ItemParty in a business document, and may be based on datatype GDT: PartyRoleCode. ItemDescription may be based on datatype GDT: SHORT_Description. ItemProductProductKey is an identifier specified for a product, and may be based on datatype KDT: ProductUnformattedKey. ItemProductProductKey/ProductTypeCode is a coded representation of a product type, such as material or service, and may be based on datatype GDT: ProductTypeCode. ItemProductProductKey/ProductidentifierTypeCode is a coded representation of a product identifier type, and may be based on datatype GDT: ProductidentifierTypeCode. ItemProductProductKey/ProductID is an identifier for a product, and may be based on datatype GDT: NOCONVERSION_ProductID. ItemProductProductInternalID is a unique identifier for a product assigned by a seller, and may be based on datatype GDT: ProductInternalID. ItemProductProductRequirementSpecificationKey is a key to identify a product requirement specification of an item, and may be based on datatype KDT: RequirementSpecificationKey. ItemCustomerOrderLifeCycleStatusCode represents a basic processing progress on an item of a Customer Transaction Document, and may be based on datatype GDT: CustomerOrderLifeCycleStatusCode. ItemCustomerContractLifeCycleStatusCode may be based on datatype GDT: CustomerContractLifeCycleStatusCode_V1. ItemLastChangeDateTime is a date time at which a customer transaction document is last changed, and may be based on datatype GDT: GLOBAL_DateTime. ServiceTermsServiceIssueCategoryCatalogueCategoryKey is a key to identify a category that schedules a service business transaction, and may be based on datatype KDT: ServiceIssueCategoryCatalogueCategoryKey. ServiceTermsServiceIssueCategoryCatalogueCategoryKey can include ServiceTermsServiceIssueCategoryCatalogueCategoryKey/ServiceIssueCategoryID, which is an identifier of an issue category, and may be based on datatype GDT: ServiceIssueCategoryID. SolutionProposalCustomerProblemAndSolutionKey is a key to identify a customer problem and solution, and may be based on datatype KDT: CustomerProblemAndSolutionKey. ServiceReferenceObjectMainMaterialKey is a material to which a service primarily refers, and may be based on datatype KDT: ProductKey. ServiceReferenceObjectMainMaterialKey/ProductID is an identifier for a product, and may be based on datatype GDT: ProductID. ServiceReferenceObjectMainIndividualMaterialKey is an individual material to which a service primarily refers, and may be based on datatype KDT: ProductKey.

ServiceReferenceObjectMainIndividualMaterialKey can include ServiceReferenceObjectMainIndividualMaterialKey/ProductID, which is an identifier for a product, and may be based on datatype GDT: ProductID. IncidentServiceIssueCategoryMainServiceIssueCategoryCatalogueCategoryKey is a key to identify a main category that is used to categorize an individual incident in a service process, and may be based on datatype KDT: ServiceIssueCategoryCatalogueCategoryKey. IncidentServiceIssueCategoryMainServiceIssueCategoryCatalogueCategoryKey can include IncidentServiceIssueCategoryMainServiceIssueCategoryCatalogueCategoryKey/ServiceIssue CategoryID, which is an identifier of an issue category, and may be based on datatype GDT: ServiceIssueCategoryID. BusinessTransactionDocumentReferenceBusinessTransactionDocumentReferenceID is an identifier of a referenced business document and may be based on datatype GDT: BusinessTransactionDocumentID. In some implementations, the BusinessTransactionDocumentReferenceBusinessTransactionDocumentReferenceID or the ItemBusinessTransactionDocumentReferenceBusinessTransactionDocumentReferenceID corresponds with the query element BusinessTransactionDocumentReferenceBusinessTransactionDocumentReferenceID. BusinessTransactionDocumentReferenceBusinessTransactionDocumentReferenceTypeCode is a type of a referenced business transaction document, and may be based on datatype GDT: BusinessTransactionDocumentTypeCode. TimePointTermsFirstReactionDueTimePoint is a point-in-time by which a response to a newly received service request or service order is expected, and may be based on datatype GDT: TimePoint, with a qualifier of FirstReactionDue. TimePointTermsCompletionDueTimePoint is a point-in-time by which a service request or service order is to be fully processed, and may be based on datatype GDT: TimePoint, with a qualifier of CompletionDue. ItemTimePointTermsCompletionDueTimePoint is a point-in-time by which a service order item is to be fully processed, and may be based on datatype GDT: TimePoint, with a qualifier of CompletionDue. TimePointTermsRequestInitialReceiptTimePoint is a point-in-time by which a request is initially received, and may be based on datatype GDT: TimePoint, with a qualifier of RequestInitialReceipt. ValidityPeriod is a period when a Customer Transaction Document document is valid, and may be based on datatype GDT: TimePointPeriod, with a qualifier of Validity. PricingTermsWarrantyGoodwillCode may be based on datatype GDT: WarrantyGoodwillCode. SolutionProposalExternalKnowledgeBaseArticleID may be based on datatype GDT: KnowledgeBaseArticleID, with a qualifier of External. PeriodTermsRequestedFulfillmentPeriod may be based on datatype GDT: TimePointPeriod. SearchText includes free text including one or several word search terms used to search for a customer transaction document, and may be based on datatype GDT: SearchText. Status includes statuses of a Customer Transaction Document, and may be based on datatype BOIDT: CustomerTransactionDocumentStatus.

Status/ItemListCancellationStatusCode aggregates a cancellation status of one or more items, and may be based on datatype GDT: CancellationStatusCode. Status/ItemListCustomerOrderLifeCycleStatusCode aggregates a life cycle status of one or more items, and may be based on datatype GDT: CustomerOrderLifeCycleStatusCode. Status/ItemListFulfillmentProcessingStatusCode aggregates a fulfillment status of one or more items, and may be based on datatype GDT: ProcessingStatusCode, with a qualifier of Fulfillment. Status/ItemListInvoiceProcessingStatusCode represents an aggregated representation of InvoicingStatus of one or more items, and may be based on datatype GDT: ProcessingStatusCode, with a qualifier of Invoice. Status/ConsistencyStatusCode describes a status consisting of errors, such as where business data is not consistent or data that includes errors, and may be based on datatype GDT: ConsistencyStatusCode. Status/InvoicingBlockingStatusCode represents a block of an invoicing process, and may be based on datatype GDT: BlockingStatusCode, with a qualifier of Invoicing. Status/ItemListCustomerContractLifeCycleStatusCode aggregates a contract life cycle status of one or more items, and may be based on datatype GDT: CustomerContractLifeCycleStatusCode_V1. Status/ItemListValidityStatusCode aggregates a validity status of one or more items, and may be based on datatype GDT: ValidityStatusCode. Status/ItemListReleaseStatusCode aggregates a release status of one or more items, and may be based on datatype GDT: ReleaseStatus Code. Status/CustomerContractTemplateLifeCycleStatusCode may be based on datatype GDT: CustomerContractTemplateLifeCycleStatusCode. Status/CreditWorthinessStatusCode may be based on datatype GDT: CreditWorthinessStatusCode. Status/ItemListFollowUpProcessingStatusCode aggregates a follow-up processing status of one or more items, and may be based on datatype GDT: ProcessingStatusCode.

A BusinessTransactionDocumentReference is a unique reference between a CustomerTransactionDocument and another business document or another business document item. References can be used to access the business documents or business document items that are linked directly to a CustomerTransactionDocument. BusinessTransactionDocumentReference can occur in the following incomplete and disjoint specializations: PurchaseOrderReference, CustomerQuoteReference, SalesOrderReference, OutboundDeliveryReference, InboundDeliveryReference, CustomerInvoiceReference, ServiceRequestReference, ServiceContractReference, ServiceConfirmationReference, ServiceOrderReference, CustomerComplaintReference, EmailActivityReference, PhoneCallActivityReference, LetterActivityReference, FaxActivityReference, AppointmentActivityReference, OpportunityReference, and ActivityReference.

The elements located directly at the node Business Transaction Document Reference are defined by the data type CustomerTransactionDocumentBusinessTransactionDocumentReferenceElements. These elements include: BusinessTransactionDocumentReference, BusinessTransactionDocumentRelationshipRoleCode, and DataProviderIndicator. BusinessTransactionDocumentReference includes a unique reference to a business document or to an item of a business document, and may be based on datatype GDT: BusinessTransactionDocumentReference. BusinessTransactionDocumentRelationshipRoleCode may be optional, is a coded representation of a role that a referenced business document or item of a referenced business document adopts in a reference relationship, and may be based on datatype GDT: BusinessTransactionDocumentRelationshipRoleCode. DataProviderIndicator specifies whether a business document provides data for a referenced business document, and may be based on datatype GDT: Indicator, with a qualifier of DataProvider.

The following inbound association relationships may exist: Customer Contract, from the business object Customer Contract/node Customer Contract, with a cardinality of C:CN; CustomerQuote, from the business object Customer Quote/node Customer Quote, with a cardinality of C:CN, which is a CustomerQuote that is referenced through specialisation CustomerQuoteReference; EmailActivity, from the business object Email Activity/node Email Activity, with a cardinality of C:CN, which is EmailActivity that is referenced through specialisation EmailActivityReference; FaxActivity, from the business object Fax Activity/node Fax Activity, with a cardinality of C:CN, which is FaxActivity that is referenced through specialisation FaxActivity; LetterActivity, from the business object Letter Activity/node Letter Activity, with a cardinality of C:CN, which is LetterActivity that is referenced through specialisation LetterActivity; Opportunity, from the business object Opportunity/node Opportunity, with a cardinality of C:CN, which is an Opportunity that is referenced through specialisation OpportunityReference; PhoneCallActivity, from the business object Phone Call Activity/node Phone Call Activity, with a cardinality of C:CN, which is PhoneCallActivity that is referenced through specialisation PhoneCallActivity; SalesOrder, from the business object Sales Order/node Sales Order, with a cardinality of C:CN, which is a SalesOrder that is referenced through specialisation SalesOrderReference; ServiceConfirmation, from the business object Service Confirmation/node Service Confirmation, with a cardinality of C:CN, which is a ServiceConfirmation that is referenced through specialisation ServiceConfirmationReference; ServiceOrder, from the business object Service Order/node Service Order, with a cardinality of C:CN, which is a ServiceOrder that is referenced through specialisation ServiceOrderReference; and ServiceRequest, from the business object Service Request/node Service Request, with a cardinality of C:CN, which is a ServiceRequest that is referenced through specialisation ServiceRequestReference.

The following specialization associations for navigation may exist to the node Service Confirmation: Parent, with a target cardinality of 1; and Root, with a target cardinality of 1. In some implementations, BusinessTransactionDocumentReference includes the immediate neighbors of a CustomerTransactionDocumentTemplate document.

The following associations from the referenced business transaction documents are used by the listed projections of the CustomerTransactionDocuemnt_Template: for Service Request: ServiceRequest, ServiceOrder, EmailActivity, PhoneCallActivity, LetterActivity, FaxActivity, and AppointmentActivity; for Service Order: CustomerQuote, OutboundDelivery, CustomerInvoice, ServiceRequest, ServiceContract, ServiceConfirmation, ServiceOrder, CustomerComplaint, EmailActivity, PhoneCallActivity, LetterActivity, FaxActivity, and AppointmentActivity; for Service Confirmation: SalesOrder, OutboundDelivery, CustomerInvoice, ServiceRequest, ServiceConfirmation, ServiceOrder, EmailActivity, PhoneCallActivity, LetterActivity, FaxActivity, and AppointmentActivity; for Sales Order PurchaseOrder, CustomerQuote, SalesOrder, OutboundDelivery, CustomerInvoice, ServiceConfirmation, and Opportunity; for Customer Quote: CustomerQuote, SalesOrder, and Opportunity; for Customer Return: SalesOrder, InboundDelivery, and CustomerInvoice; and for Support Request: ServiceRequest.

A SalesAndServiceBusinessArea is a business or service specific area within an enterprise that is valid for a CustomerTransactionDocument, such as, for example, sales organization, service organization, distribution channel, or division. Such elements can be derived from an organizational unit Sales Unit or Service Unit (e.g., see Party responsible for the CustomerTransactionDocument), and can be overwritten manually.

The elements located directly at the node Sales And Service Business Area are defined by the data type CustomerTransactionDocumentSalesAndServiceBusinessAreaElements. These elements include: SalesOrganisationID, SalesGroupID, SalesOfficeID, DistributionChannelCode, ServiceOrganisationID, SalesOrganisationUUID, SalesGroupUUID, SalesOfficeUUID, and ServiceOrganisationUUID. SalesOrganisationID may be optional, is an identifier for a sales organization that is responsible for a Customer Transaction Document, and may be based on datatype GDT: OrganisationalCentreID. SalesGroupID may be optional, is an identifier for a sales group that is responsible for a Customer Transaction Document, and may be based on datatype GDT: OrganisationalCentreID. SalesOfficeID may be optional, is an identifier for a sales office that is responsible for a Customer Transaction Document, and may be based on datatype GDT: OrganisationalCentreID. DistributionChannelCode is a coded representation of a distribution channel by which goods and services reach customers, and may be based on datatype GDT: DistributionChannelCode. ServiceOrganisationID may be optional, is an identifier for a service organization, and may be based on datatype GDT: OrganisationalCentreID. SalesOrganisationUUID is a universally unique identifier for a sales organization, and may be based on datatype GDT: UUID. SalesGroupUUID is a universally unique identifier for a sales group, and may be based on datatype GDT: UUID. SalesOfficeUUID is a universally unique identifier for a sales office, and may be based on datatype GDT: UUID. ServiceOrganisationUUID is a universally unique identifier for a service organization, and may be based on datatype GDT: UUID.

The following inbound aggregation relationships may exist: Sales Group, from the business object Functional Unit/node Functional Unit, with a cardinality of C:CN, which is a Functional Unit within a specialisation Sales Group; Sales Office, from the business object Functional Unit/node Functional Unit, with a cardinality of C:CN, which is a functional Unit within a specialization Sales Office; Sales Organisation, from the business object Functional Unit/node Functional Unit, with a cardinality of C:CN, which is a FunctionalUnit with a specializations Sales Organisation; and Service Organisation, from the business object Functional Unit/node Functional Unit, with a cardinality of C:CN, which is a Functional Unit within a specialisation Service Organisation. The following specialization associations for navigation may exist to the node Service Confirmation: Parent, with a target cardinality of 1; and Root, with a target cardinality of 1.

DurationTerms is a duration related agreement for goods and services that can occur in a CustomerTransactionDocument. DurationTerms can occur in the following disjoint specializations incomplete with reference to the role of the duration DurationRoleCode: MaximumFirstReactionDuration, MaximumCompletionDuration, RequestMaximumProviderCompletionDuration, RequestTotalProcessingDuration, RequestTotalInitialReactionDuration, and RequestTotalRequestorDuration. MaximumFirstReactionDuration is a duration before an expiration of which a reaction to a newly received service request or a newly received service order is to occur, where the duration can be calculated from a Service Level Objective. MaximumCompletionDuration is a duration before an expiration of which a service request or service order is to have been completed, where the duration period can be calculated from a Service Level Objective SLO. RequestMaximumProviderCompletionDuration is a duration before an expiration of which a provider is to complete a request, where the duration period can be calculated from a Service Level Objective. RequestTotalInitialReactionDuration is a total duration that elapses before a request is accessed for processing, can be calculated using status changes of a document, and can be represented by the expression ‘“In Process since”−“Opened At”+TotalInitialReactionDuration-old’. RequestTotalProcessingDuration is a total duration of the processing of a request, can be calculated using status changes of a document, and can be represented by the expression ‘“Finished At”−“Opened At”+“TotalProcessingDuration-old”’. RequestTotalRequestorDuration is a total duration that a requestor uses for processing a request, can be calculated using status changes of a document, and can be represented by the expression ‘“Finished At”−“Opened At”+“TotalRequestorDuration-old”’. RequestTotalProviderProcessingDuration is a total duration that a provider uses for processing a request, can be calculated using status changes of a document, and can be represented by the expression ‘“Received from Provider At”−“Sent to Provider At”+“TotalProviderProcessingDuration old”’.

The elements located directly at the node Duration Terms are defined by the data type CustomerTransactionDocumentDurationTermsElements. These elements include: DurationRoleCode, Duration, and DateCalculationFunctionReference. DurationRoleCode is a role of a specified duration, and may be based on datatype GDT: DurationRoleCode. Duration is a specification of a duration, and may be based on datatype GDT: Duration. DateCalculationFunctionReference is a reference to a function with which a duration is calculated, and may be based on datatype GDT: DateCalculationFunctionReference. The following specialization associations for navigation may exist to the node Service Confirmation: Parent, with a target cardinality of 1; and Root, with a target cardinality of 1.

IncidentServiceIssueCategory is a categorization of an individual incident or aspect in a CustomerTransactionDocument. The elements located directly at the node Incident Service Issue Category are defined by the data type CustomerTransactionDocumentIncidentServiceIssueCategoryElements. These elements include: ID, ServiceIssueCategoryCatalogueKey, ServiceIssueCategoryCatalogueCategoryKey, ServiceIssueCategoryUUID, and MainIndicator. ID may be optional, may be an alternative key, and may be based on datatype GDT: CustomerTransactionDocumentIncidentServiceIssueCategoryID. ServiceIssueCategoryCatalogueKey is a key to identify a category catalog in which a category is included, and may be based on datatype KDT: ServiceIssueCategoryCatalogueKey. ServiceIssueCategoryCatalogueKey/ServiceIssueCategoryCatalogueID is an identifier of an issue category catalog, and may be based on datatype GDT: ServiceIssueCategoryCatalogueID. ServiceIssueCategoryCatalogueKey/ServiceIssueCategoryCatalogueVersionID is an identifier of a version of an issue category catalog, and may be based on datatype GDT: VersionID. ServiceIssueCategoryCatalogueCategoryKey is a key structure to identify a category that is used to categorize an individual incident in a service process, and may be based on datatype KDT: ServiceIssueCategoryCatalogueCategoryKey. ServiceIssueCategoryCatalogueCategoryKey can include ServiceIssueCategoryCatalogueCategoryKey/ServiceIssueCategoryID, which is an identifier of an issue category, and may be based on datatype GDT: ServiceIssueCategoryID. ServiceIssueCategoryCatalogueCategoryKey can include ServiceIssueCategoryCatalogueCategoryKey/ServiceIssueCategoryCatalogueUUID, which is a universally unique identifier of an issue category catalog and its version, and may be based on datatype GDT: UUID. ServiceIssueCategoryUUID is a globally unique identifier for a business subject category that is used to categorize an individual incident in a service process, and may be based on datatype GDT: UUID. MainIndicator specifies whether an instance is a main issue, and may be based on datatype GDT: Indicator, with a qualifier of Main.

A ServiceIssueCategory inbound aggregation relationship may exist from the business object Service Issue Category Catalogue/node Category, with a cardinality of C:CN, which is a ServiceIssueCategory that categorizes an individual incident. The following specialization associations for navigation may exist to the node Service Confirmation: Parent, with a target cardinality of 1; and Root, with a target cardinality of 1. In some implementations, only one issue category is flagged as a main issue category at any one time.

InvoiceTerms are agreements that apply for invoicing goods and services in a CustomerTransactionDocument. The elements located directly at the node Invoice Terms are defined by the data type CustomerTransactionDocumentInvoiceTermsElements. These elements include: ProposedInvoiceDate, ProposedInvoiceDateDateCalculationFunctionReference, and InvoicingBlockingReasonCode. ProposedInvoiceDate may be optional, is a date on which an invoice is proposed to be created with a rule for automatic scheduling, and may be based on datatype GDT: Date, with a qualifier of Invoice. ProposedInvoiceDateDateCalculationFunctionReference is a date rule for determining a proposed price date, and may be based on datatype GDT: DateCalculationFunctionReference. InvoicingBlockingReasonCode may be optional, specifies why processing of invoicing documents is blocked for a business transaction item, and may be based on datatype GDT: InvoicingBlockingReasonCode. The following specialization associations for navigation may exist to the node Service Confirmation: Parent, with a target cardinality of 1; and Root, with a target cardinality of 1. In some implementations, at least one element is set.

Item is an item of a customer-specific business transaction that focuses on delivering goods or providing a service, on prices, and on preparing an invoice. Item includes identifying and administrative item information in a CustomerTransactionDocument which, in addition to schedule lines, includes data that applies to an item, for example, product information, parties involved, sales, delivery, or customer invoicing-specific agreements, status, and references.

Item can occur in the following specializations: Sales Service Item, Sales Service Quote Item, Service Contract Item, Customer Service Confirmation Item, Customer Spare Part Quote Item, Customer Service Quote Item, Customer Spare Part Confirmation Item, Customer Service Item, Customer Spare Part Item, Sales Item, Sales Quote Item, Complaint Item, Customer Return Item, Compensation Delivery Item, Refund Item, and Sales Contract Item. The elements located directly at the node Item are defined by the data type CustomerTransactionDocumentItemElements. These elements include: ID, BuyerID, TypeCode, ProcessingTypeCode, DateTime, Description, BuyerDateTime, BuyerName, HierarchyRelationship, UUID, SystemAdministrativeData, FulfillmentPartyCategoryCode, MigratedDataAdaptationTypeCode, and Status.

ID is a unique identifier for an item of a Customer Transaction Document assigned by a seller in a Customer Transaction Document, and may be based on datatype GDT: BusinessTransactionDocumentItemID BuyerID may be optional, is a unique identifier for a Customer Transaction Document item assigned by a buyer, and may be based on datatype GDT: BusinessTransactionDocumentItemID TypeCode is a coded representation of a type of a Customer Transaction Document item, may be based on datatype GDT: BusinessTransactionDocumentItemTypeCode, can be set internally from a ProcessingTypeCode, and includes a permissible item specialization of a CustomerTransactionDocumentTemplate. An example of a TypeCode is a SalesItem. ProcessingTypeCode may be optional, is a coded representation of item processing of a Customer Transaction Document in a process component, and may be based on datatype GDT: BusinessTransactionDocumentItemProcessingTypeCode. ProcessingTypeCode “Item type” or “item category” can include standard order items, for example. DateTime may be optional, is a creation time posting time of a Customer Transaction Document item from a business perspective, and may be based on datatype GDT: GLOBAL_DateTime. Description is a short description of a Customer Transaction Document item, and may be based on datatype GDT: SHORT_Description. BuyerDateTime may be optional, is a date/time assigned by a buyer for a Customer Transaction Document item, and may be based on datatype GDT: GLOBAL_DateTime, with a qualifier of Buyer. BuyerName is a name of an item assigned by a buyer, and may be based on datatype GDT: MEDIUM_Name. HierarchyRelationship is a relationship between a subitem and a main item to describe item hierarchies, and may be based on datatype BOIDT: CustomerTransactionDocumentItemHierarchyRelationship. HierarchyRelationship can include HierarchyRelationship/ParentItemID, which may be optional, is an identifier of a higher-level item in an item hierarchy of a Customer Transaction Document, and may be based on datatype GDT: BusinessTransactionDocumentItemID HierarchyRelationship can include HierarchyRelationship/ParentItemUUID, which is a UUID of a higher-level item in an item hierarchy of a Customer Transaction Document, and may be based on datatype GDT: UUID. HierarchyRelationship can include HierarchyRelationship/TypeCode, which is a relationship type of an item hierarchy in a customer transaction document, and may be based on datatype GDT: BusinessTransactionDocumentItemHierarchyRelationshipTypeCode. UUID may be an alternative key, is an identifier for a Customer Transaction Document item, can be assigned internally, and may be based on datatype GDT: UUID. A UUID can serve as an alternate key, with which other business objects can define foreign keys. SystemAdministrativeData is administrative data stored in a system that can include system users and change dates/times, and may be based on datatype GDT: SystemAdministrativeData. FulfillmentPartyCategoryCode is a party category of a fulfillment of a customer transaction document item, may be based on datatype GDT: FulfillmentPartyCategoryCode, and defines if a delivery of a material or provision of a service is done by an owning company or by an external supplier. MigratedDataAdaptationTypeCode may be optional, is a coded representation of a type of data adaption performed during migration of a customer transaction document item, and may be based on datatype GDT: MigratedDataAdaptationTypeCode. In some implementations, data may be adapted when migrating data from a source system to a target system, for example. In some implementations, a MigratedDataAdaptationTypeCode is used when a CustomerTransactionDocument item is migrated.

Status may be optional, may be based on CustomerTransactionDocumentItemStatus, may describe statuses of a Customer Transaction Document at an item level, and may be based on datatype BOIDT: CustomerTransactionDocumentItemStatus. Status can include Status/ConsistencyStatusCode, Status/FulfillmentDataCompletenessStatusCode, Status/InvoicingDataCompletenessStatusCode, Status/PricingDataCompletenessStatusCode, Status/GeneralDataCompletenessStatusCode, Status/FulfillmentProcessingStatusCode, Status/InvoiceProcessingStatusCode, Status/CustomerOrderLifeCycleStatusCode, and Status/CancellationStatusCode.

Status/ConsistencyStatusCode may be optional, denotes whether a Customer Transaction Document has errors, and may be based on datatype GDT: ConsistencyStatusCode. Status/FulfillmentDataCompletenessStatusCode may be optional, describes whether data has been completely entered in an area Fulfillment, and may be based on datatype GDT: DataCompletenessStatusCode, with a qualifier of Fulfillment. Status/InvoicingDataCompletenessStatusCode may be optional, describes whether data has been completely entered in an area Invoicing, and may be based on datatype GDT: DataCompletenessStatusCode, with a qualifier of Invoicing. Status/PricingDataCompletenessStatusCode may be optional, describes whether data has been completely entered in an area Pricing, and may be based on datatype GDT: DataCompletenessStatusCode, with a qualifier of Pricing. Status/GeneralDataCompletenessStatusCode may be optional, describes whether general data has been completely entered, and may be based on datatype GDT: DataCompletenessStatusCode, with a qualifier of General. Status/FulfillmentProcessingStatusCode may be optional, describes a processing progress regarding a delivery or provision of a service, and may be based on datatype GDT: ProcessingStatusCode, with a qualifier of Fulfillment. Status/InvoiceProcessingStatusCode may be optional, describes processing progress during invoicing, and may be based on datatype GDT: ProcessingStatusCode, with a qualifier of Invoice. Status/CustomerOrderLifeCycleStatusCode may be optional, represents basic processing progress on an item of a Customer Transaction Document, and may be based on datatype GDT: CustomerOrderLifeCycleStatusCode. Status/CancellationStatusCode may be optional, indicates whether a cancellation for a Customer Transaction Document exists, and may be based on datatype GDT: CancellationStatusCode.

The following composition relationships to subordinate nodes exist: ItemActualValues, in a 1:C cardinality relationship; ItemBusinessTransactionDocumentReference, in a 1:CN cardinality relationship; and ItemBusinessProcessVariantType, in a 1:N cardinality relationship, which may be filtered. The filter elements are defined by the data type BusinessProcessVariantTypeFilterElements and these elements include BusinessProcessVariantTypeCode, which may be optional, and may be based on datatype GDT: BusinessProcessVariantTypeCode.

The following composition relationships to subordinate nodes exist: ItemConfirmation, in a 1:C cardinality relationship; ItemPeriodTerms, in a 1:CN cardinality relationship; ItemPricingTerms, in a 1:C cardinality relationship; ItemProduct, in a 1:C cardinality relationship; ItemSalesTerms, in a 1:C cardinality relationship; ItemScheduleLine, in a 1:CN cardinality relationship; ItemTimePointTerms, in a 1:C cardinality relationship; ItemTotalValues, in a 1:C cardinality relationship; ItemDurationTerms, in a 1:CN cardinality relationship; ItemInvoiceTerms, in a 1:C cardinality relationship; ItemLocation, in a 1:CN cardinality relationship; and ItemParty, in a 1:CN cardinality relationship, which may be filtered. The filter elements are defined by the data type PartyFilterElements and these elements include RoleCategoryCode and MainIndicator. RoleCategoryCode may be optional and may be based on datatype GDT: PartyRoleCategoryCode. MainIndicator may be optional and may be based on datatype GDT: Indicator.

The following composition relationships to dependent objects exist: Item Accounting Coding Block Distribution, with a cardinality of 1:C, which distributes value changes from a customer transaction document item to coding blocks, whereby the distribution may occur on the basis of amounts or quantities. The distribution of coding blocks can include an identification of the distribution and information that is valid for some or all coding blocks, such as company performing reporting, a date on which the coding blocks are valid, or a quantity-based or amount-based total for which assignments are to be made. The following composition relationships to dependent objects exist: ItemAttachmentFolder, with a cardinality of 1:C, which is a collection of documents attached for an item of a CustomerTransactionDocument; and ItemTextCollection, with a cardinality of 1:C, which is a collection of natural-language texts that refer to an item in a CustomerTransactionDocument.

The following inbound association relationships may exist: CreationIdentity, from the business object Identity/node Identity, with a cardinality of 1:CN, which is an identity of a user that created a Customer Transaction Document Item; Last Change Identity, from the business object Identity/node Identity, with a cardinality of 1:CN, which is an identity of a user that last changed a Customer Transaction Document Item; Child Item, from the business object Service Confirmation/node Item, with a cardinality of C:CN, which is a child item in an item hierarchy; and Parent Item, from the business object Service Confirmation/node Item, with a cardinality of C:C, which is a parent item in an item hierarchy. An Item can include other items, thus creating item hierarchies. Items that are a part of an item hierarchy and do not have any further higher-level items can be called main items, e.g., root nodes of the hierarchy. All other items can be called subitems.

The following are example types of hierarchy relationships: Bill of Material, which is a product with a bill of materials that is mapped in a CustomerTransactionDocumentTemplate as an item hierarchy, where a product is mapped as a main item and components of the bill of materials as the subitems; Free Goods—e.g., if free goods are granted for an item, an item hierarchy can be generated with subitems which include free goods information; and Sourcing—e.g., if a product used by a customer is not able to be procured, an item hierarchy can be generated for the item, with subitems which include information on substituted products.

The following specialization associations for navigation can exist to the node Item: Price and Tax Calculation Item, with a target cardinality of C, which is an association to an item in the results of price and tax calculation. The following specialization associations for navigation can exist to the node Item Business Process Variant Type: Main Item Business Process Variant Type, with a target cardinality of C, which is an association to a main ItemBusinessProcessVariantType. The following specialization associations for navigation can exist to the node Item Business Transaction Document Reference: Base Item Business Transaction Document Item Reference, with a target cardinality of C, which is an association to a reference that occurs in a specialization and is used as a basis, and for returns where the BaseItemBusinessTransactionDocumentItemReference is either a sales order item or a customer invoice item; Base Item Customer Quote Item Reference, with a target cardinality of C, which is an association to a reference that occurs in an ItemCustomerQuoteItemReference specialization and is used as a basis; Base Item Service Order Item Reference, with a target cardinality of C, which is an association to a reference of an item to Service Order that is used as a basis; BaseItemBusinessTransactionDocumentItemReference, with a target cardinality of C, which is an association to a reference that occurs in a specialization and is used as a basis, and where for returns, the BaseItemBusinessTransactionDocumentItemReference is either a sales order item or a customer invoice item; Item Customer Invoice Item Reference, with a target cardinality of CN, which is an association to a reference that occurs in an ItemCustomerInvoiceItemReference specialization; Item Inbound Delivery Item Reference, with a target cardinality of CN, which is an association to a reference that occurs in an ItemInboundDeliveryItemReference specialization; Item Outbound Delivery Item Reference, with a target cardinality of CN, which is an association to a reference that occurs in an ItemOutboundDeliveryItemReference specialization; Item Purchase Order Item Reference, with a target cardinality of C, which is an association to a reference that occurs in an ItemPurchaseOrderItemReference specialization; Item Sales Order Item Reference, with a target cardinality of CN, which is an association to a reference that occurs in an ItemSalesOrderItemReference specialization; Item Service Confirmation Item Reference, with a target cardinality of CN, which is an association to a reference that occurs in an ItemServiceConfirmationItemReference specialization; and Item Service Order Item Reference, with a target cardinality of CN, which is an association to a reference of an item of a Service Order that can be used as a basis.

The following specialization associations for navigation can exist to the node Item Duration Terms Maximum Completion Item Duration, with a target cardinality of C, which is an association to an ItemDurationTerms that occurs in the MaximumCompletionItemDuration specialization; and Maximum First Reaction Item Duration, with a target cardinality of C, which is an association to an ItemDurationTerms that occurs in the MaximumFirstReactionItemDurationTerms specialization.

The following specialization associations for navigation can exist to the node Item Location: Ship From Item Location, with a target cardinality of C, which is an association to a Party that occurs in a ShipFromItemLocation specialization; Ship to Item Location, with a target cardinality of C, which is an association to a party that occurs in a ShipToItemLocation specialization; and Service Point Item Location, with a target cardinality of C, which is an association to a party that occurs in a ServicePointItemLocation specialization.

The following specialization associations for navigation can exist to the node Item Party: Bill to Item Party, with a target cardinality of C, which is an association to a Party that occurs in a BillToItemParty specialization; Buyer Item Party, with a target cardinality of C, which is an association to a Party that occurs in a BuyerItemParty specialization; Employee Responsible Item Party, with a target cardinality of C, which is an association to a party that occurs in an EmployeeResponsibleItemParty specialization; Payer Item Party, with a target cardinality of C, which is an association to a Party that occurs in a PayerItemParty specialization; Product Recipient Item Party, with a target cardinality of C, which is an association to a Party that occurs in a ProductRecipientItemParty specialization; Sales Unit Item Party, with a target cardinality of C, which is an association to a Party that occurs in a SalesUnitItemParty specialization; Seller Item Party, with a target cardinality of C, which is an association to a Party that occurs in a SellerItemParty specialization; Service Execution Team Item Party, with a target cardinality of C, which is an association to a Party that occurs in a specialization ServiceExecutionTeamItemParty; Service Performer Item Party, with a target cardinality of C, which is an association to a Party that occurs in a ServicePerformerItemParty specialization; ContractReleaseAuthorizedItemParty, with a target cardinality of C, which is an association to a Party that occurs in a ContractReleaseAuthorizedItemParty specialization; Tax Reporting Unit Item Party, with a target cardinality of C, which is a party that has a tax reporting unit role category assigned; Vendor Item Party, with a target cardinality of C, which is an association to a Party that occurs in a VendorItemParty; and Service Support Team Item Party, with a target cardinality of C.

The following specialization associations for navigation can exist to the node Item Period Terms Actual Fulfillment Item Period, with a target cardinality of C, which is an association to an ItemPeriodTerms that occurs in an ActualFulfillmentItemPeriodTerms specialization; and Requested Fulfillment Item Period, with a target cardinality of C, which is an association to an ItemPeriodTerms that occurs in a RequestedFulfillmentItemPeriodTerms specialization.

The following specialization associations for navigation can exist to the node Item Schedule Line Confirmed Item Schedule Line, with a target cardinality of CN, which is an association to a Schedule Line that occurs in the ConfirmedItemScheduleLine specialization; Confirmation Relevant Item Schedule Line, with a target cardinality of CN, which is an association to an item schedule line relevant to order confirmation, where confirmation relevant schedule lines occur in a ConfirmedItemScheduleLine or a PromisedItemScheduleLine specialization; First Fulfilled Item Schedule Line, with a target cardinality of C, which is an association to a first ItemScheduleLine that occurs in a FulfilledItemScheduleLine specialization; First Promised Item Schedule Line, with a target cardinality of C, which is an association to a first ScheduleLine that occurs in a PromisedItemScheduleLine specialization; First Requested Item Schedule Line, with a target cardinality of C, which is an association to a ScheduleLine that occurs in a RequestedItemScheduleLine specialization; Promised Item Schedule Line, with a target cardinality of CN, which is an association to a ScheduleLine that occurs in a PromisedItemScheduleLine specialization; and Requested Item Schedule Line, with a target cardinality of CN, which is an association to an ItemScheduleLine that occurs in a RequestedItemScheduleLine specialization.

The following specialization associations for navigation can exist to the node Service Confirmation: Parent, with a target cardinality of 1; and Root, with a target cardinality of 1. The following specialization associations for navigation can exist to the node Item Time Point Terms Completion Due Item Time Point, with a target cardinality of C, which is an association to an ItemTimePointTerms that occurs in the CompletionDueItemTimePoint specialization; Completion Item Time Point, with a target cardinality of C, which is an association to an ItemTimePointTerms that occurs in the CompletionItemTimePoint specialization; and First Reaction Due Item Time Point, with a target cardinality of C, which is an association to an ItemTimePointTerms that occurs in the FirstReactionDueItemTimePoint specialization.

In some implementations, the BuyerID and the ID are not changed after an item has been created. In some implementations, the ParentItemID and the HierarchyRelationshipTypeCode are not changed after an item has been created. In some implementations, SystemAdministrativeData is set internally by the system and is not assigned or changed externally. In some implementations, the ParentItemID is not changed after an item has been created. In some implementations, the HierarchyRelationshipTypeCode is not changed after an item has been created. In some implementations, the ParentItemID, ParentItemUUID and HierarchyRelationshipTypeCode are set together.

A Cancel action cancels items by setting a cancellation reason. In some implementations, a precondition of the Cancel action is that the Cancel action is allowed only if an item has not been cancelled or completed. The Cancel action can set the status variable ‘CancellationStatus’ to ‘Cancelled’. The Cancel action elements are defined by the data type CustomerTransactionDocumentItemCancelActionElements. These elements include CancellationReasonCode, which may be optional, is a reason for canceling a sales transaction, and may be based on datatype GDT: CancellationReasonCode.

A Check Consistency action checks a CustomerTransactionDocument for errors and sets a ConsistencyStatus to either ‘Consistent’ or ‘Inconsistent’. A Check Fulfillment Data Completeness action evaluates if all data needed for fulfillment has been entered and sets a FulfillmentDataCompletenessStatus to either ‘Incomplete’ or ‘Complete’. A Check General Data Completeness action checks for general data completeness. A Check Invoicing Data Completeness action evaluates if all data needed for invoicing has been entered and sets a InvoicingDataCompletenessStatus to either ‘Incomplete’ or ‘Complete’.

A Check Invoicing Relevance action determines if a created item is configured as ‘invoice relevant’, and can set an InvoiceProcessingStatus to either ‘Not Started’ or ‘Not relevant’. A Check Pricing Data Completeness action evaluates if data needed for pricing has been entered and sets a PricingDataCompletenessStatus to either ‘Incomplete’ or ‘Complete’. A Confirm Customer Invoice Issue action updates an invoice quantity and sets an Invoicing status according to an update in a Customer Invoice Processing System. The Confirm Customer Invoice Issue action may be performed inside an agent. The Confirm Customer Invoice Issue action sets the Invoice Status according to an update in a Customer Invoice Processing System. Action elements for the Confirm Customer Invoice Issue action are defined by the data type CustomerTransactionDocumentItemConfirmCustomerInvoiceIssueActionElements. These elements include InvoiceProcessingStatusCode, which may be optional, describes a processing progress during invoicing, and may be based on datatype GDT: ProcessingStatusCode, with a qualifier of Invoice.

A Confirm Execution action can be used in a CustomerTransactionDocument to confirm that a referenced Service Order Item is executed. The Confirm Execution action can call an action ‘FinishFulfillment’ in a Service Order Item, which sets a FullfillmentStatus of the Service Order Item to ‘Finished’. Preconditions of the Confirm Execution action can include the CustomerTransactionDocumentTemplate having a service order item as a predecessor and the FullfillmentStatus of the referenced service order item being ‘In process’.

A Finish Fulfillment Processing action sets a FulfillmentProcessingStatus of an item of a CustomerTransactionDocument to “Finished” and may be valid for items that have a FulfillmentProcessingStatus of “In Process”.

A Flag Fulfillment Processing As Not Relevant action sets the FulfillmentProcessingStatus of an item of a CustomerTransactionDocument to “Not Relevant”. Thus the item can be not relevant for subsequent processes. For example, a spare part can be planned in a Sales Order or Service Order but not used in service execution, and a service can be planned in a Sales Order or Service Order, but not executed. The Flag Fulfillment Processing As Not Relevant action can be valid for items that have the FulfillmentProcessingStatus “Not Started”.

A Notify Of Sales Order Creation action notifies of a creation of a reference to a sales order item, may be valid if either an approval process is not used and an approval status has the value ‘Approval Not Necessary’ or the approval status has the value ‘Approved’, and sets an OrderingProcessingStatus to either ‘In Process’ or “Finished”. A Notify Of Sales Order Deletion action notifies of a deletion of a reference to a sales order item, may be valid if OrderingProcessingStatus is ‘In Process’ or ‘Finished’, and sets an OrderingProcessingStatus to either ‘Not Started’ or ‘In Process’.

A Revoke Cancellation action undoes the action Cancel, can only be carried out with items that have been cancelled, and changes a ‘CancellationStatus’ status variable from ‘cancelled’ to ‘not cancelled’.

A Split Quantity action splits a customer spare part confirmation item in order to confirm a fulfilled quantity of a same spare part with different identified stock. Preconditions of the Split Quantity action can include the spare part to be confirmed being managed via identified stock, and a fulfillment status of an original item being not “Finished”. The Split Quantity action creates a new customer spare part confirmation item pointing to a same reference document as an original. In some implementations, an identified stock of the original item is not copied. A quantity of the new item can be proposed based on a planned quantity and already confirmed quantities. The Split Quantity action may be performed from a user interface.

ItemActualValues are cumulated data quantities or values of an item in a CustomerTransactionDocument that are derived from a particular business process or a reference document. The elements located directly at the node Item Actual Values are defined by the data type CustomerTransactionDocumentItemActualValuesElements. These elements include: FulfilledQuantity, FulfilledQuantityTypeCode, AcceptedFulfilledQuantity, AcceptedFulfilledQuantityTypeCode, RejectedFulfilledQuantity, RejectedFulfilledQuantityTypeCode, InvoicedQuantity, InvoicedQuantityTypeCode, InvoicedAmount, OrderedQuantity, and OrderedQuantityTypeCode.

FulfilledQuantity is a cumulated, fulfilled quantity in an item in a Customer Transaction Document document, can be used in a context of order and returns, and may be based on datatype GDT: Quantity, with a qualifier of Fulfilled. FulfilledQuantityTypeCode qualifies a type of a fulfilled quantity, and may be based on datatype GDT: QuantityTypeCode, with a qualifier of Fulfilled. AcceptedFulfilledQuantity is a cumulated, accepted fulfilled quantity in a Customer Transaction Document item, can be used in a context of returns, and may be based on datatype GDT: Quantity, with a qualifier of Fulfilled. AcceptedFulfilledQuantityTypeCode qualifies a type of an accepted fulfilled quantity, and may be based on datatype GDT: QuantityTypeCode, with a qualifier of Fulfilled. RejectedFulfilledQuantity is a cumulated, rejected fulfilled quantity in a Customer Transaction Document item, can be used in a context of returns, and may be based on datatype GDT: Quantity, with a qualifier of Fulfilled. RejectedFulfilledQuantityTypeCode qualifies a type of a rejected fulfilled quantity, and may be based on datatype GDT: QuantityTypeCode, with a qualifier of Fulfilled. InvoicedQuantity is a cumulated, invoiced quantity in a SalesOrder item, and may be based on datatype GDT: Quantity, with a qualifier of Invoiced. InvoicedQuantityTypeCode qualifies a type of an invoiced quantity, and may be based on datatype GDT: QuantityTypeCode, with a qualifier of Invoiced. InvoicedAmount is a cumulated, invoiced amount in a Customer Transaction Document item, and may be based on datatype GDT: Amount, with a qualifier of Invoiced. OrderedQuantity is a cumulated, ordered quantity for a Customer Transaction Document item, can be used in a context of quotes and contracts, and may be based on datatype GDT: Quantity, with a qualifier of Ordered. OrderedQuantityTypeCode qualifies a type of an ordered quantity, and may be based on datatype GDT: QuantityTypeCode, with a qualifier of Ordered.

The following specialization associations for navigation may exist to the node Item: Parent, with a target cardinality of 1. The following specialization associations for navigation may exist to the node Service Confirmation: Root, with a target cardinality of 1.

An ItemBusinessTransactionDocumentReference is a unique reference between an item in a CustomerTransactionDocument and another business document or another business document item. References can result in business documents or business document items that are linked directly to an item of a CustomerTransactionDocument.

ItemBusinessTransactionDocumentReference can occur in the following specializations: ItemPurchaseOrderItemReference, ItemCustomerQuotehemReference, ItemSalesOrderItemReference, ItemOutboundDeliveryItemReference, ItemInboundDeliveryhemReference, ItemConfirmedlnboundDeliveryItemReference, ItemCustomerInvoicehemReference, ItemServiceConfirmationItemReference, ItemServiceOrderhemReference, ItemCustomerComplaintItemReference, ItemOpportunityItemReference, and ItemCustomerContractReference.

The elements located directly at the node Item Business Transaction Document Reference are defined by the data type CustomerTransactionDocumentItemBusinessTransactionDocumentReferenceElements. These elements include: BusinessTransactionDocumentReference, BusinessTransactionDocumentRelationshipRoleCode, and DataProviderIndicator. BusinessTransactionDocumentReference includes a unique reference to a different business document or to an item of a different business document, and may be based on datatype GDT: BusinessTransactionDocumentReference. BusinessTransactionDocumentRelationshipRoleCode may be optional, is a coded representation of a role that a referenced business document or item of a referenced business document adopts in a reference relationship, and may be based on datatype GDT: BusinessTransactionDocumentRelationshipRoleCode. DataProviderIndicator specifies whether a business document provides data for a referenced business document, and may be based on datatype GDT: Indicator, with a qualifier of DataProvider.

The following composition relationships to subordinate nodes exist: ItemBusinessTransactionDocumentReferenceActualValues, in a 1:C cardinality relationship. The following inbound association relationship may exist: CustomerContract, from the business object Customer Contract/node Customer Contract, with a cardinality of C:CN; Customer Quote, from the business object Customer Quote/node Customer Quote, with a cardinality of C:CN, which is a CustomerQuote that is referenced through specialisation ItemCustomerQuoteItemReference; Opportunity, from the business object Opportunity/node Opportunity, with a cardinality of C:CN, which is an opportunity that is referenced through specialisation ItemOpportunityItemReference; SalesOrder, from the business object Sales Order/node Sales Order, with a cardinality of C:CN, which is a SalesOrder that is referenced through specialisation ItemSalesOrderItemReference; ServiceConfirmation, from the business object Service Confirmation/node Service Confirmation, with a cardinality of C:CN, which is a ServiceConfirmation that is referenced through specialisation ItemServiceConfirmationItemReference; ServiceOrder, from the business object Service Order/node Service Order, with a cardinality of C:CN, which is a ServiceOrder that is referenced through specialisation ItemServiceOrderItemReference; and ServiceRequest, from the business object Service Request/node Service Request, with a cardinality of C:CN, which is a ServiceRequest that is referenced through specialisation ItemServiceRequestItemReference.

The following specialization associations for navigation may exist: Parent, to the node Item, with a target cardinality of 1; and Root, to the node Service Confirmation, with a target cardinality of 1. In some implementations, an ItemBusinessTransactionDocumentReference includes a CustomerTransactionDocument's direct neighbors. The following associations from a referenced business transaction document items are used by listed projections of a CustomerTransactionDocument_Template: for Service Order—CustomerQuote, OutboundDelivery, CustomerInvoice, ServiceConfirmation, ServiceOrder, and CustomerComplaint; for Service Confirmation—SalesOrder, OutboundDelivery, CustomerInvoice, and ServiceOrder; for Sales Order—PurchaseOrder, CustomerQuote, SalesOrder, OutboundDelivery, CustomerInvoice, ServiceConfirmation, and Opportunity; for Customer Quote—CustomerQuote, SalesOrder, and Opportunity; for Customer Return—SalesOrder, InboundDelivery, and CustomerInvoice; and for Customer Contract—PurchaseOrder, ServiceConfirmation, and CustomerInvoice. The association from Customer Contract can be used by Sales Order.

An ItemBusinessTransactionDocumentReferenceActualValues includes data quantities and values of a reference of a CustomerTransactionDocument to a different document that is replicated from the referenced document. The elements located directly at the node Item Business Transaction Document Reference Actual Values are defined by the data type CustomerTransactionDocumenthemBusinessTransactionDocumentReferenceActualValuesElements. These elements include: QuantityRoleCode, Quantity, AmountRoleCode, Amount, TimePointRoleCode, and TimePoint. QuantityRoleCode may be optional, is a coded representation of a role of a quantity, and may be based on datatype GDT: QuantityRoleCode. Quantity is a non-monetary numeral specification of a quantity in a unit of measure, and may be based on datatype GDT: Quantity. AmountRoleCode may be optional, is a coded representation of a role of an amount, and may be based on datatype GDT: AmountRoleCode. Amount is an amount with a corresponding currency unit, and may be based on datatype GDT: Amount. TimePointRoleCode is a coded representation of a role of a time, and may be based on datatype GDT: TimePointRoleCode. TimePoint is a unique time point in a specific time context. A time point can be defined by means of a time and date value, as well as by a time zone, and may be based on datatype GDT: TimePoint. A DateTime representation can be used. The following specialization associations for navigation may exist: Parent, to the node Item Business Transaction Document Reference, with a target cardinality of 1; and Root, to the node Service Confirmation, with a target cardinality of 1.

ItemBusinessProcessVariantType defines a character of a business process variant of an item of a CustomerTransactionDocument. ItemBusinessProcessVariantType represents a typical way of processing an item of a CustomerTransactionDocument in a process component from a business point of view. The elements located directly at the node Item Business Process Variant Type are defined by the data type CustomerTransactionDocumentItemBusinessProcessVariantTypeElements. These elements include: BusinessProcessVariantTypeCode and MainIndicator. BusinessProcessVariantTypeCode is a coded representation of a business process variant type of a Customer Transaction Document item; and may be based on datatype GDT: BusinessProcessVariantTypeCode. MainIndicator is an type that specifies whether a current BusinessProcessVariantTypeCode is a main indicator, and may be based on datatype GDT: Indicator, with a qualifier of Main. The following specialization associations for navigation may exist: Parent, to the node Item, with a target cardinality of 1; and Root, to the node Service Confirmation, with a target cardinality of 1.

ItemConfirmation includes item-specific confirmation information relating to a service provided or a used spare part. The elements located directly at the node Item Confirmation are defined by the data type CustomerTransactionDocumentItemConfirmationElements. These elements include: ConfirmedDuration, ServiceProvisionLocationTypeCode, ConfirmedServiceWorkingConditionsCode, WarrantyKey, WarrantyUUID, WarrantyValidityPeriod, ResourceID, and ResourceUUID. ConfirmedDuration may be optional, is a duration of a service as confirmed in a confirmation, can be proposed from a product master of a service confirmed, can be overwritten, and may be based on datatype GDT: Duration, with a qualifier of Confirmed. ServiceProvisionLocationTypeCode is a coded representation of the type of a location at which a service has been provided, and may be based on datatype GDT: ServiceProvisionLocationTypeCode. ConfirmedServiceWorkingConditionsCode indicates working conditions under which a service is provided, and may be based on datatype GDT: ServiceWorkingConditionsCode. WarrantyKey is a key to identify a warranty that covers a service or spare part, and may be based on datatype KDT: ProductKey. WarrantyKey can include WarrantyKey/ProductID, which is an identifier for a product, and may be based on datatype GDT: ProductID. WanantyUUID is a unique identifier for a warranty, and may be based on datatype GDT: UUID. WarrantyValidityPeriod is a period specifying a warranty validity, and may be based on datatype GDT: CLOSED_DatePeriod, with a qualifier of Validity. ResourceID is a unique identification of a resource provided for a service product, and may be based on datatype GDT: ResourceID. A labour resource can be derived based on a service performer or a service execution team of an item. ResourceUUID is a universal unique identification of a resource provided for a service product, and may be based on datatype GDT: UUID.

A Warranty inbound aggregation relationship may exist from the business object Warranty/node Root, with a cardinality of C:CN, which is an association to Warranty. A Resource inbound association relationship may exist from the business object Resource/node Resource, with a cardinality of C:CN, which is a resource provided for a service product. The following specialization associations for navigation may exist: Parent, to the node Item, with a target cardinality of 1; and Root, to the node Service Confirmation, with a target cardinality of 1. In some implementations, the Elements WanantyID, WanantyUUID and WarrantyValidityDatePeriod are inherited from node ServiceTerms and are not changeable.

ItemDurationTerms is a duration related agreement for goods and services that can occur at an item level in a CustomerTransactionDocument. Item Duration Terms occurs in the following not complete, disjoint specializations: Maximum First Reaction Item Duration Terms, and Maximum Completion Item Duration Terms. A specialization type can be implemented by a type Attribute. The elements located directly at the node Item Duration Terms are defined by the data type CustomerTransactionDocumentItemDurationTermsElements. These elements include: DurationRoleCode, Duration, and DateCalculationFunctionReference. DurationRoleCode is a role of a specified duration, and may be based on datatype GDT: DurationRoleCode. Duration is a specification of the duration, and may be based on datatype GDT: Duration. DateCalculationFunctionReference is a reference to a function with which a duration is calculated, and may be based on datatype GDT: DateCalculationFunctionReference. The following specialization associations for navigation may exist: Parent, to the node Item, with a target cardinality of 1; and Root, to the node Service Confirmation, with a target cardinality of 1.

ItemInvoiceTerms are item-specific agreements that apply for invoicing goods and services in a CustomerTransactionDocument. The elements located directly at the node Item Invoice Terms are defined by the data type CustomerTransactionDocumentItemInvoiceTermsElements. These elements include: ProposedInvoiceDate, ProposedInvoiceDateDateCalculationFunctionReference, ToBeInvoicedQuantity, and ToBeInvoicedQuantityTypeCode. ProposedInvoiceDate may be optional, is a date on which an invoice is proposed to be created with a rule for automatic scheduling, and may be based on datatype GDT: Date, with a qualifier of Invoice. ProposedInvoiceDateDateCalculationFunctionReference may be optional, is a date rule for determining a proposed price date, and may be based on datatype GDT: DateCalculationFunctionReference. ToBeInvoicedQuantity is a quantity of a product to be invoiced, and may be based on datatype GDT: Quantity, with a qualifier of ToBeInvoiced. ToBeInvoicedQuantityTypeCode qualifies a type of quantity to be invoiced, and may be based on datatype GDT: QuantityTypeCode, with a qualifier of ToBeInvoiced. The following specialization associations for navigation may exist: Parent, to the node Item, with a target cardinality of 1; and Root, to the node Service Confirmation, with a target cardinality of 1. In some implementations, ItemInvoiceTerms are proposed from InvoiceTerms and can be changed.

An ItemLocation is a place to which and from which goods are delivered/supplied or where a service is provided. ItemLocation can occur in the same specializations as for Location. The elements located directly at the node Item Location are defined by the data type CustomerTransactionDocumentItemLocationElements. These elements include: LocationID, LocationUUID, AddressReference, RoleCode, RoleCategoryCode, and DeterminationMethodCode. LocationID is an identifier of a business object Location, and may be based on datatype GDT: LocationID. LocationUUID is a universally unique identifier of a business object Location, and may be based on datatype GDT: UUID. AddressReference includes information to reference an address of a business object, and may be based on datatype BOIDT: ObjectNodeLocationAddressReference. AddressReference may include AddressReference/AddressHostUUID, AddressReference/AddressHostTypeCode, AddressReference/BusinessObjectTypeCode, AddressReference/InstalledBaseID, AddressReference/InstallationPointID, and AddressReference/PartyKey. AddressReference/AddressHostUUID is a universally unique identifier for an address of a business partner, an organizational unit or its specializations, a business object InstalledBase, or a business object InstallationPoint. AddressReference/AddressHostUUID may be based on datatype GDT: UUID. AddressReference/AddressHostTypeCode may be optional, is a coded representation of an address host type of an address referenced by an AddressUUID or an address included using a Location Address composition, and may be based on datatype GDT: AddressHostTypeCode. AddressReference/BusinessObjectTypeCode may be optional, and is a coded representation of a type of a business object in which an address referenced in a LocationAddressUUID is integrated as a dependent object. AddressReference/BusinessObjectTypeCode may be based on datatype GDT: BusinessObjectTypeCode. AddressReference/InstalledBaseID is an identifier for an installed base that references an address using an AddressUUID, and may be based on datatype GDT: InstalledBaseID. AddressReference/InstallationPointID is an identifier for an installation point that references an address using an AddressUUID, and may be based on datatype GDT: InstallationPointID. AddressReference/PartyKey is an alternative identifier of a party that represents a business partner or an organizational unit that references an address using an AddressUUID. AddressReference/PartyKey may be based on datatype KDT: PartyKey. AddressReference/PartyKey may include AddressReference/PartyKey/PartyTypeCode, which is a coded representation of a type of party, and may be based on datatype GDT: BusinessObjectTypeCode. AddressReference/PartyKey may include AddressReference/PartyKey/PartyID, which is an identifier for a party, and may be based on datatype GDT: PartyID. RoleCode may be optional, is a coded representation of a role of a Node Location in a Customer Transaction Document document, and may be based on datatype GDT: LocationRoleCode. RoleCategoryCode may be optional, is a coded representation of a Role Category of a Node Location in a Customer Transaction Document document, and may be based on datatype GDT: LocationRoleCategoryCode. DeterminationMethodCode may be optional, is a coded representation of a LocationDeterminationMethod, and may be based on datatype GDT: LocationDeterminationMethodCode.

The following inbound aggregation relationships may exist: Address Snapshot, from the business object Address Snapshot/node Root, with a cardinality of C:CN; InstallationPointAddressInformation, from the business object Installation Point/node Address Information, with a cardinality of C:CN, which is an installation point address to which or at which goods are delivered or a service is provided, in the roles ShipFromLocation, ShipToLocation Returns and ServicePoint; Location, from the business object Location/node Location, with a cardinality of C:CN, which is a location to which or at which goods are delivered or a service is provided, in the roles ShipFromLocation, ShipToLocation Returns and ServicePoint; and PartyAddressInformation, from the business object Party/node Address Information, with a cardinality of C:CN, which is AddressInformation of a representative of a Business Partner or Organizational Centre corresponding to an ItemLocation.

The following specialization associations for navigation may exist: Address Snapshot Overview, to the business object Address Snapshot/node Overview, with a target cardinality of C; Parent, to the node Item, with a target cardinality of 1; and Root, to the node Service Confirmation, with a target cardinality of 1. The following specialization associations for navigation may exist to the business object Used Address/node Used Address: Used Address, with a target cardinality of C. An address used for a location can be a referenced address of a master data object. A node ID of a node in a master data object can be determined via the PartyTypeCode, AddressHostUUID and AddressHostTypeCode elements that have a composition relationship to a DO address that is to be represented by a TO UsedAddress.

In some implementations, there is either an aggregation or a composition relationship to a dependent object. In some implementations, if there is an aggregation relationship to a business object Location, the LocationID attribute is filled with the ID of a business object Location and other ID fields, e.g., PartyID, InstalledBaseID and InstallationPointID, remain blank. In some implementations, if an address of a party references a BusinessPartner or an OrganisationalCentre, the PartyID attribute is filled with the ID of the Party and other ID fields, e.g., LocationID, InstalledBaseID and InstallationPointID, remain blank. In some implementations, a reference is stored in the AddressUUID attribute. In some implementations, if there is an aggregation relationship to an address of an InstalledBase, the InstalledBaseID attribute is filled with the ID of the InstalledBase and other ID fields, e.g., LocationID, PartyID and InstallationPointID, remain blank. In some implementations, a reference is stored in the AddressUUID InstalledBaseAddressInformationUUID attribute. In some implementations, if there is an aggregation relationship to an address of an InstallationPoint, the InstallationPointID attribute is filled with the ID of the InstallationPoint and other ID fields, e.g., LocationID, PartyID and InstalledBaseID, remain blank. In some implementations, a reference is stored in the AddressUUID attribute. In some implementations, if an address is referenced via the element AddressUUID, then the elements AddressBusinessObjectTypeCode and AddressHostTypeCode are also filled.

An ItemParty is a natural or legal person, organization, organizational unit or group that is involved in a CustomerTransactionDocument in a PartyRole. ItemParty can occur in the same specializations as those in the node Party. In some implementations, ItemParty does not occur in the specialization VendorParty. The elements located directly at the node Item Party are defined by the data type CustomerTransactionDocumentItemPartyElements. These elements include: PartyKey, PartyUUID, RoleCategoryCode, RoleCode, AddressReference, DeterminationMethodCode, and MainIndicator. PartyKey is an identifier for a party in a PartyRole in a business document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. PartyUUID is a unique identifier for a business partner, organizational unit, or associated specializations, and may be based on datatype GDT: UUID. RoleCategoryCode may be optional, is a coded representation of a category of a party in a business document, and may be based on datatype GDT: PartyRoleCategoryCode. RoleCode may be optional, represents a party role of a party in a business document, and may be based on datatype GDT: PartyRoleCode. AddressReference is information used to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator is an indicator that specifies whether a current BusinessProcessVariantTypeCode is a main code, and may be based on datatype GDT: Indicator, with a qualifier of Main.

The following composition relationships to subordinate nodes can exist: ItemPartyContactParty, with a cardinality of 1:CN. The following inbound aggregation relationships may exist: Address Snapshot, from the business object Address Snapshot/node Root, with a cardinality of C:CN; and Party, from the business object Party/node Party, with a cardinality of C:CN, which is a referenced party in Master Data.

The following specialization associations for navigation can exist: Address Snapshot Overview, to the business object Address Snapshot/node Overview, with a target cardinality of C; Parent, to the node Item, with a target cardinality of 1; Main Party Contact Party, to the node Item Party Contact Party, with a target cardinality of C, which is an association to a PartyContact that occurs in a MainPartyContactParty specialization; Root, to the node Sales Order, with a target cardinality of 1; and UsedAddress, to the business object Used Address/node Used Address, with a target cardinality of C.

In some implementations, ItemBuyerParty and an associated ContactParty do not deviate in a party node from the BuyerParty. In some implementations, ItemPayerParty and an associated ContactParty do not deviate in the party node from the PayerParty. In some implementations, ItemSalesUnitParty does not deviate in the party node from the SalesUnitParty. In some implementations, the BuyerParty is not changed after a document has been created. In some implementations, the PayerParty is not be changed after being created. In some implementations, there is one aggregation relationship to a business partner, an organizational unit, or associated specializations. In some implementations, if the PartyUUID exists, the PartyTypeCode also exists. In some implementations, Parties are referenced via the Transformed Object Party that represents at least one of the following business objects: Company, SalesUnit, ServiceUnit, ReportingLineUnit, Supplier, Customer, Employee, or BusinessPartner.

An ItemPartyContactParty is a natural person or organizational unit that can be contacted for a respective ItemParty. A contact can be a contact person or a secretariat, for example. Communication data can be available for the contact. The elements located directly at the node Item Party Contact Party are defined by the data type CustomerTransactionDocumentItemPartyContactPartyElements. These elements include: PartyKey, PartyUUID, AddressReference, DeterminationMethodCode, and MainIndicator. PartyKey is an identifier for a contact party in a customer transaction document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. In some implementations, if a business partner or organizational unit are referenced, the PartyID attribute includes associated identifiers. PartyUUID is a unique identifier for a business partner, organizational unit or associated specializations, and may be based on datatype GDT: UUID. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator may be optional, specifies whether a PartyContactParty is emphasized in a number of contacts with a same PartyRole, and may be based on datatype GDT: Indicator, with a qualifier of Main.

The following inbound aggregation relationships may exist: Address Snapshot, from the business object Address Snapshot/node Root, with a cardinality of C:CN; and Party, from the business object Party/node Party, with a cardinality of C:CN, which includes a referenced Party in Master Data.

The following specialization associations for navigation may exist: Address Snapshot Overview, to the business object Address Snapshot/node Overview, with a target cardinality of C; Parent, to the node Item Party, with a target cardinality of 1; Root, to the node Sales Order, with a target cardinality of 1; and Used Address, to the business object Used Address/node Used Address, with a target cardinality of C. An address used for a Party can be: 1) a referenced address of a master data object; or 2) a PartyAddress used via a composition relationship. A determination can be made regarding which of the two cases applies by means of the PartyAddressHostTypeCode element, e.g., an instance of the TO UsedAddress represents such an address. In the first case mentioned above, a node ID of a node in the master data object can be determined via the PartyTypeCode, PartyAddressUUID and PartyAddressHostTypeCode elements that have a composition relationship to a DO address that is to be represented by a TO UsedAddress. Additionally, a TO UsedAddress in an implemented association can be provided with the following information: BusinessObjectTypeCode, BusinessObjectNodeTypeCode and Node ID of a <business object-Node>-Party node. These can be used in case changes to the TO UsedAddress take place. In this case, a master data address can be copied by the TO UsedAddress. Changes can take place to the copy, and a corresponding DO Address can be created at a <business object-Node>Party via a PartyAddress composition relationship. In the second case mentioned above, the TO UsedAddress can be informed of the BusinessObjectTypeCode, BusinessObjectNodeTypeCode and Node ID of an associated <business object-Node>-Party. Additionally, information can be provided indicating that such information is not an example of a referenced address. In this case, the TO UsedAddress represents the DO address used at the <business object-Node>-Party via the PartyAddress composition relationship.

ItemPeriodTerms is a period related agreement for goods and services that can occur at an item level in a CustomerTransactionDocument. Item Period Terms can occur in the following specializations: Requested Fulfillment Item Period Terms and Actual Fulfillment Item Period Terms. A specialization type can be implemented by a Type Attribute. The elements located directly at the node Item Period Terms are defined by the data type CustomerTransactionDocumentItemPeriodTermsElements. These elements include: PeriodRoleCode, TimePointPeriod, StartTimePointDateCalculationFunctionReference, and EndTimePointDateCalculationFunctionReference. PeriodRoleCode is a role of a specified period, and may be based on datatype GDT: PeriodRoleCode. TimePointPeriod is a specification of a period, and may be based on datatype GDT: TimePointPeriod. StartTimePointDateCalculationFunctionReference is a reference to a function with which a start point-in-time of a period can be calculated, and may be based on datatype GDT: DateCalculationFunctionReference. EndTimePointDateCalculationFunctionReference is a reference to a function with which an end point-in-time of a period can be calculated, and may be based on datatype GDT: DateCalculationFunctionReference. The following specialization associations for navigation may exist: Parent, to the node Item, with a target cardinality of 1; and Root, to the node Service Confirmation, with a target cardinality of 1.

ItemPricingTerms are item-specific characteristics used for pricing and value dating goods and services in a CustomerTransactionDocument. The elements located directly at the node Item Pricing Terms are defined by the data type CustomerTransactionDocumentItemPricingTermsElements. These elements include: CurrencyCode, CustomerPricingProcedureDeterminationCode, PriceDateTime, PriceSpecificationCustomerGroupCode, CustomerPriceListTypeCode, CustomerGroupCode, WarrantyGoodwillCode, PriceSpecificationLabourResourceGroupCode, and GrossAmountIndicator. CurrencyCode may be optional, is a currency for valuation of goods and services ordered, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date used to determine price specifications using a rule for automatic scheduling, and may be based on datatype GDT: LOCALNORMALISED_DateTime, with a qualifier of Price. PriceSpecificationCustomerGroupCode is a group of LabourResources for which same price specifications are valid, and may be based on datatype GDT: PriceSpecificationCustomerGroupCode. CustomerPriceListTypeCode may be optional, is a customer price list type proposed by a buyer or ordering party, and may be based on datatype GDT: CustomerPriceListTypeCode. CustomerGroupCode represents a group of customers for general purposes, such as pricing and statistics, that is proposed by a buyer or ordering party. CustomerGroupCode may be based on datatype GDT: CustomerGroupCode. WarrantyGoodwillCode specifies an extent to which a provision of services or materials are not or are only partially invoiced to a customer in the case of a warranty or compensation, and may be based on datatype GDT: WarrantyGoodwillCode. PriceSpecificationLabourResourceGroupCode represents a group of LabourResources for which same price specifications are valid, and may be based on datatype GDT: PriceSpecificationLabourResourceGroupCode. GrossAmountIndicator may be optional, is an indicator that specifies whether a price and/or value is given as a gross amount that includes taxes, and may be based on datatype GDT: Indicator, with a qualifier of GrossAmount.

The following specialization associations for navigation may exist: Parent, to the node Item, with a target cardinality of 1; and Root, to the node Service Confirmation, with a target cardinality of 1. In some implementations, a currency and associated elements for currency conversion are not changed at an item-level. In some implementations, a calculation procedure is not changed at an item level. In some implementations, ItemPricingTerms are set as defaults from PricingTerms and can be changed.

ItemProduct is an identification, description and classification of a product material or ServiceProduct in an item. The elements located directly at the node Item Product are defined by the data type CustomerTransactionDocumentItemProductElements. These elements include: ProductKey, ProductInternalID, ProductStandardID, QuantityMeasureUnitCode, QuantityTypeCode, ProductBuyerID, ProductCategoryHierarchyProductCategoryIDKey, PriceSpecificationProductGroupCode, CashDiscountDeductibleIndicator, IdentifiedStockKey, IdentifiedStockUUID, LogisticsAreaKey, LogisticsAreaUUID, ProductRequirementSpecificationKey, ProductRequirementSpecificationVersionUUID, ProductUUID, SerialidentifierProvisionRequirementCode, PricingProductKey, and PricingProductUUID. ProductKey can include ProductKey/ProductTypeCode, ProductKey/ProductidentifierTypeCode, and ProductKey/ProductID. ProductCategoryHierarchyProductCategoryIDKey can include ProductCategoryHierarchyProductCategoryIDKey/ProductCategoryHierarchyID and ProductCategoryHierarchyProductCategoryIDKey/ProductCategoryInternalID IdentifiedStockKey can include IdentifiedStockKey/MaterialKey/ProductidentifierTypeCode, IdentifiedStockKey/MaterialKey/ProductID, IdentifiedStockKey/ID, and IdentifiedStockKey/MaterialKey. LogisticsAreaKey can include LogisticsAreaKey/ID and LogisticsAreaKey/SiteID. PricingProductKey can include PricingProductKey/ProductTypeCode, PricingProductKey/ProductidentifierTypeCode, and PricingProductKey/ProductID.

ProductKey is a key to identify a product in a customer transaction document item, and may be based on datatype KDT: ProductUnformattedKey. ProductKey/ProductTypeCode is a coded representation of a product type, such as material or service, and may be based on datatype GDT: ProductTypeCode. ProductKey/ProductidentifierTypeCode is a coded representation of a product identifier type, and may be based on datatype GDT: ProductidentifierTypeCode. ProductKey/ProductID is an identifier for a product, and may be based on datatype GDT: NOCONVERSION_ProductID. ProductInternalID is an internal identifier of a product, and may be based on datatype GDT: ProductInternalID. ProductStandardID is a standard ID for a product, and may be based on datatype GDT: ProductStandardID. QuantityMeasureUnitCode may be optional, is a unit of measure in which quantities are used for a product in a Customer Transaction Document, and may be based on datatype GDT: MeasureUnitCode. QuantityTypeCode is a type code indicating which quantities are used for a product in a Customer Transaction Document, and may be based on datatype GDT: QuantityTypeCode. ProductBuyerID may be optional, is a unique identifier for a product assigned by a buyer, and may be based on datatype GDT: ProductPartyID. ProductCategoryHierarchyProductCategoryIDKey is a key to identify a product category assigned to a product, and may be based on datatype KDT: ProductCategoryHierarchyProductCategoryIDKey. ProductCategoryHierarchyProductCategoryIDKey/ProductCategoryHierarchyID is an identifier for a product category hierarchy, and may be based on datatype GDT: ProductCategoryHierarchyID. ProductCategoryHierarchyProductCategoryIDKey/ProductCategoryInternalID is an identifier for a product category, and may be based on datatype GDT: ProductCategoryInternalID. PriceSpecificationProductGroupCode is a coded representation of a product group to which a product is assigned and for which specific price specifications apply, and may be based on datatype GDT: PriceSpecificationProductGroupCode. CashDiscountDeductibleIndicator specifies if a discount can be granted for a product, and may be based on datatype GDT: Indicator, with a qualifier of CashDiscountDeductible. IdentifiedStockKey is a key to identify an Identified Stock related to a corresponding material, and may be based on datatype KDT: IdentifiedStockKey. IdentifiedStockKey/ID may be based on datatype GDT: IdentifiedStockID. IdentifiedStockKey/MaterialKey is a grouping of elements that uniquely identifies a material, a sub-quantity of which can be identified by an identified stock, and may be based on datatype KDT: ProductKey. IdentifiedStockKey/MaterialKey/ProductidentifierTypeCode is a coded representation of a product identifier type, and may be based on datatype GDT: ProductidentifierTypeCode. IdentifiedStockKey/MaterialKey/ProductID is an identifier for a product, and may be based on datatype GDT: ProductID. IdentifiedStockUUID is a unique identifier of an Identified Stock related to a corresponding material, and may be based on datatype GDT: UUID. LogisticsAreaKey may be optional, is a grouping of elements that uniquely identifies a logistics area by site at which a material is physically located and taken from, and may be based on datatype KDT: LogisticsAreaKey. LogisticsAreaKey/ID may be optional, is an identifier for a logistics area, and may be based on datatype GDT: LogisticsAreaID. LogisticsAreaKey/SiteID may be optional, is an identifier for a site at which a logistics area is located, and may be based on datatype GDT: LocationID. LogisticsAreaUUID may be optional, is a universally unique identifier for a logistics area at which a material is physically located and taken from, and may be based on datatype GDT: UUID. ProductRequirementSpecificationKey is a key to identify a product requirement specification, may be based on datatype KDT: RequirementSpecificationKey, describes a collection of requirements for a corresponding product used in a customer transaction document item, and includes corresponding specifications for fulfilling such requirements. A product requirement specification can belong to a corresponding product in a customer transaction document item. ProductRequirementSpecificationVersionUUID is a unique identification of a product requirement specification version, and may be based on datatype GDT: UUID. ProductUUID is a UUID of a product, and may be based on datatype GDT: UUID. SerialidentifierProvisionRequirementCode may be optional and may be based on datatype GDT: SerialidentifierProvisionRequirementCode. PricingProductKey is an identification of a product that is used for pricing, and may be based on datatype KDT: ProductKey. PricingProductKey/ProductTypeCode is a coded representation of a product type such as a material or service, and may be based on datatype GDT: ProductTypeCode. PricingProductKey/ProductidentifierTypeCode is a coded representation of a product identifier type, and may be based on datatype GDT: ProductidentifierTypeCode. PricingProductKey/ProductID is an identifier for a product, and may be based on datatype GDT: ProductID. PricingProductUUID is a UUID of a product that is used for pricing, and may be based on datatype GDT: UUID.

The following composition relationships to subordinate nodes exist: Item Product Serial Number, with a cardinality of 1:CN. The following inbound aggregation relationships may exist: IdentifiedStock, from the business object Identified Stock/node Identified Stock, with a cardinality of C:CN, which denotes an identified stock of a material in a customer transaction document item; Material, from the business object Material/node Material, with a cardinality of C:CN, which denotes a material in a customer transaction document item; Material V1, from the business object Material/node Material, with a cardinality of C:CN, which is a material in a customer transaction document item; ServiceProduct, from the business object Service Product/node Service Product, with a cardinality of C:CN, which denotes a service product in a customer transaction document item; and ServiceProduct V1, from the business object Service Product/node Service Product, with a cardinality of C:CN, which is a service product in a customer transaction document item.

The following inbound association relationship may exist: LogisticsArea, from the business object Logistics Area/node Logistics Area, with a cardinality of C:CN. The following specialization associations for navigation may exist: Parent, to the node Item, with a target cardinality of 1; and Root, to the node Service Confirmation, with a target cardinality of 1. In some implementations, ProductTypeCode is determined internally and is not subsequently changed. In some implementations, the elements of the ItemProduct are taken as defaults from a Material or a ServiceProduct and can be changed.

Item Product Serial Number is a serial number of an individual product within a customer transaction document item product. The elements located directly at the node Item Product Serial Number are defined by the inline structure: APCRM_S_CTD_IT_PROD_SRL_NO_EL. These elements include: UUID and IndividualProductSerialIDKey. UUID may be optional, is a universally unique identifier for an individual product to which a serial number belongs, and may be based on datatype GDT: UUID. IndividualProductSerialIDKey may be optional, is a grouping of elements that uniquely identifies an individual product serial number, and may be based on datatype KDT: IndividualProductSerialIDKey. IndividualProductSerialIDKey can include IndividualProductSerialIDKey/ReferenceProductUUID, which may be optional, is a universally unique identifier for a product, and may be based on datatype GDT: UUID. IndividualProductSerialIDKey can include IndividualProductSerialIDKey/SerialID, which may be optional, is an identifier for an individual product, and may be based on datatype GDT: SerialID.

In some implementations, a reference product UUID is equal to a product UUID of an item product node. An Individual Product inbound aggregation relationship may exist from the business object IndividualProduct/node Root, with a cardinality of C:CN, which is an individual product in an item product serial number to which a serial number belongs. The following specialization associations for navigation may exist: Parent, to the node Item Product, with a target cardinality of 1; and Root, to the node Service Confirmation, with a target cardinality of 1.

ItemSalesTerms are item-specific agreements and conditions that apply for selling goods and services in a CustomerTransactionDocument. The elements located directly at the node Item Sales Terms are defined by the data type CustomerTransactionDocumentItemSalesTermsElements. These elements include: IndustrialSectorCode, IndustryClassificationSystemCode, ProductUsageCode, CancellationReasonCode, and ProbabilityPercent. IndustrialSectorCode represents an industrial sector assigned to a buyer ordering party. An industrial sector is a division of an enterprise according to a focus of business activities. IndustrialSectorCode may be based on datatype GDT: IndustrialSectorCode. IndustryClassificationSystemCode is a code for an industry system assigned to a buyer ordering party. An industry system or industry classification system is a systematically structured hierarchy. IndustryClassificationSystemCode may be based on datatype GDT: IndustryClassificationSystemCode. ProductUsageCode defines what a buyer ordering party uses a product for in a current process, and may be based on datatype GDT: ProductUsageCode. CancellationReasonCode is a reason for canceling a sales transaction, can be set by both a buyer and seller, and may be based on datatype GDT: CancellationReasonCode. ProbabilityPercent may be optional, is a probability of a sales order or contract arising from a quote, and may be based on datatype GDT: SMALLNONNEGATIVE_Percent. The following specialization associations for navigation

may exist: Parent, to the node Item, with a target cardinality of 1; and Root, to the node Service Confirmation, with a target cardinality of 1. In some implementations, ItemSalesTerms are set as defaults from the SalesTerms and can subsequently be changed. In some implementations, the following elements are not overwritten on an item: RegionCode, IndustrialSectorCode, IndustryClassificationSystemCode and ProductUsageCode. In some implementations, ConfirmationFixedIndicator is always set.

An ItemScheduleLine is an agreement regarding when products of an item are requested or provided and in what amount. Item Schedule Line can occur in the following specializations: Requested Item Schedule Line, Confirmed Item Schedule Line, Promised Item Schedule Line, and Fulfilled Item Schedule Line. The elements located directly at the node Item Schedule Line are defined by the data type CustomerTransactionDocumentItemScheduleLineElements. These elements include: ID, BuyerID, TypeCode, Quantity, QuantityTypeCode, DateTimePeriod, ProductAvailabilityConfirmationCommitmentCode, UUID, RelatedUUID, and RelatedID.

ID may be optional, is a unique identifier for an ItemScheduleLine assigned by a seller, and may be based on datatype GDT: BusinessTransactionDocumentItemScheduleLineID. BuyerID may be optional, is a unique identifier for an ItemScheduleLine assigned by a buyer, and may be based on datatype GDT: BusinessTransactionDocumentItemScheduleLineID. TypeCode may be optional, is a coded representation of a type of an ItemScheduleLine, such as RequestedScheduleLine, and may be based on datatype GDT: BusinessTransactionDocumentItemScheduleLineTypeCode. In some implementations, for ServiceProductItem, BusinessTransactionDocumentItemScheduleLineTypeCode 1 Requested is allowed. In some implementations, for SparePartItem, BusinessTransactionDocumentItemScheduleLineTypeCodes “1” Requested, “2” Confirmed and Promised are allowed. In some implementations, BusinessTransactionDocumentItemScheduleLineTypeCode “4” Fulfilled is allowed. Quantity is a quantity with reference to a TypeCode, and may be based on datatype GDT: Quantity. QuantityTypeCode qualifies a type of a quantity, and may be based on datatype GDT: QuantityTypeCode. DateTimePeriod is a time period with reference to TypeCode, and may be based on datatype GDT: UPPEROPEN_LOCALNORMALISED_DateTimePeriod. ProductAvailabilityConfirmationCommitmentCode defines a binding character of a confirmed quantity and delivery period, and may be based on datatype GDT: ProductAvailabilityConfirmationCommitmentCode. UUID may be an alternative key, is a UUID of a scheduling line, and may be based on datatype GDT: UUID. RelatedUUID is a UUID of a corresponding schedule line that stands in relation to a current schedule line, and may be based on datatype GDT: UUID. RelatedID may be optional, is an identifier of a corresponding schedule line that stands in relation to a current schedule line, and may be based on datatype GDT: BusinessTransactionDocumentItemScheduleLineID.

The following composition relationships to subordinate nodes exist: ItemScheduleLineFulfillmentPlanningPeriod, with a cardinality of 1:CN. The following specialization associations for navigation may exist: Parent, to the node Item, with a target cardinality of 1; Issue Item Schedule Line Fulfillment Planning Period, to the node Item Schedule Line Fulfillment Planning Period, with a target cardinality of C, which is an association to an ItemScheduleLineFulfillmentPlanningDate that occurs in an IssuePeriod specialization; RelatedItemScheduleLine, to node ItemScheduleLine, with a target cardinality of CN, which is an association to the ItemScheduleLine node itself and which specifies a relationship between schedule lines (e.g., an ItemScheduleLine instance can also refer to another ItemSchedule line instance, such as references that indicate which confirmed schedule lines belong to a particular requested schedule line); Positioning Item Schedule Line Fulfillment Planning Period, with a target cardinality of C, which is an association to an ItemScheduleLineFulfillmentPlanningDate that occurs in a PositioningPeriod specialization; and Root, to the node Service Confirmation, with a target cardinality of 1.

In some implementations, a time period for a requested schedule line is proposed from a RequestedFulfillmentPeriod, and can be changed. In some implementations, in service product items, one RequestedScheduleLine is allowed. In some implementations, all ItemScheduleLines for an item use a same unit of measure.

Item Schedule Line Fulfillment Planning Period includes dates for front-end process steps for delivery of goods or provision of services. Item Schedule Line Fulfillment Planning Period can occur in the following specializations: Positioning Item Schedule Line Fulfillment Planning Period and Issue Item Schedule Line Fulfillment Planning Period. The elements located directly at the node Item Schedule Line Fulfillment Planning Period are defined by the data type CustomerTransactionDocumentItemScheduleLineFulfillmentPlanningPeriodElements. These elements include: PeriodRoleCode and DateTimePeriod. PeriodRoleCode is a coded representation of semantics of an ItemScheduleLineFulfillmentPlanningDateTimePeriod, for example ConfirmedProductAvailabilityDateTimePeriod, and may be based on datatype GDT: PeriodRoleCode. DateTimePeriod is a time period with reference to PeriodRoleCode, and may be based on datatype GDT: UPPEROPEN_LOCALNORMALISED_DateTimePeriod. The following specialization associations for navigation may exist: Parent, to the node Item Schedule Line, with a target cardinality of 1; and Root, to the node Service Confirmation, with a target cardinality of 1.

ItemTimePointTerms is a period related agreement for goods and services that can occur at an item level in a CustomerTransactionDocument. Item Time Point Terms can occur in the following not complete, disjoint specializations: First Reaction Due Item Time Point Terms, Completion Due Item Time Point Terms, and Completion Item Time Point Terms. A specialization type can be implemented by a type attribute. The elements located directly at the node Item Time Point Terms are defined by the data type CustomerTransactionDocumentItemTimePointTermsElements. These elements include: TimePointRoleCode, TimePoint, and DateCalculationFunctionReference. TimePointRoleCode is a role of a specified point-in-time, and may be based on datatype GDT: TimePointRoleCode. TimePoint is a specification of a point-in-time, and may be based on datatype GDT: TimePoint. DateCalculationFunctionReference is a reference to a function with which a point-in-time is calculated, and may be based on datatype GDT: DateCalculationFunctionReference. The following specialization associations for navigation may exist: Parent, to the node Item, with a target cardinality of 1; and Root, to the node Service Confirmation, with a target cardinality of 1.

ItemTotalValues are total values for an item resulting from the Item's dependent nodes. Examples include: a total desired delivery quantity or a confirmed quantity of an ItemScheduleLine, item-specific gross and net weight, a volume, a gross and net value and tax amount, and shipment costs. Quantities, weights, volumes, and values can be calculated by accumulation, and dates can be calculated by special logic, such as based on a first date and/or a last date. The elements located directly at the node Item Total Values are defined by the data type CustomerTransactionDocumentItemTotalValuesElements. These elements include: RequestedQuantity, RequestedQuantityTypeCode, ConfirmedQuantity, ConfirmedQuantityTypeCode, LastConfirmedDateTime, GrossWeightMeasure, NetWeightMeasure, VolumeMeasure, NetAmount, NetPrice, TaxAmount, FreightChargeAmount, GrossAmount, Net WithoutFreightChargeAmount, and NetWithoutFreightChargePrice.

RequestedQuantity is a total quantity requested of a Customer Transaction Document item, and may be based on datatype GDT: Quantity, with a qualifier of Requested. RequestedQuantityTypeCode qualifies a type of a requested quantity, and may be based on datatype GDT: QuantityTypeCode, with a qualifier of Requested. ConfirmedQuantity is a total confirmed quantity of a Customer Transaction Document item, and may be based on datatype GDT: Quantity, with a qualifier of Confirmed. ConfirmedQuantityTypeCode qualifies a type of a confirmed quantity, and may be based on datatype GDT: QuantityTypeCode, with a qualifier of Confirmed. LastConfirmedDateTime is a last confirmed date for a Customer Transaction Document item, and may be based on datatype GDT: LOCALNORMALISED_DateTime, with a qualifier of LastConfirmed. GrossWeightMeasure is a total gross weight of a product in a Customer Transaction Document item, and may be based on datatype GDT: Measure, with a qualifier of GrossWeight. NetWeightMeasure is a total net weight of a product in a Customer Transaction Document item, and may be based on datatype GDT: Measure, with a qualifier of NetWeight. VolumeMeasure is a total volume of a product in a Customer Transaction Document item, and may be based on datatype GDT: Measure, with a qualifier of Volume. NetAmount is a net amount of a Customer Transaction Document item, and may be based on datatype GDT: Amount, with a qualifier of Net. NetPrice is a net price of a product in a CustomerTransactionDocumentTemplate item, and may be based on datatype GDT: Price, with a qualifier of Net. TaxAmount is a tax amount of a Customer Transaction Document item, and may be based on datatype GDT: Amount, with a qualifier of Tax. FreightChargeAmount is a freight charge for a Customer Transaction Document item, and may be based on datatype GDT: Amount, with a qualifier of FreightCharge. GrossAmount is a gross amount of a Customer Transaction Document item, and may be based on datatype GDT: Amount, with a qualifier of Gross. NetWithoutFreightChargeAmount is a net value of a Customer Transaction Document item excluding freight charge, and may be based on datatype GDT: Amount, with a qualifier of NetWithoutFreightCharge. NetWithoutFreightChargePrice is a net price of a Customer Transaction Document item excluding freight charge, and may be based on datatype GDT: Price, with a qualifier of NetWithoutFreightCharge. The following specialization associations for navigation may exist: Parent, to the node Item, with a target cardinality of 1; and Root, to the node Service Confirmation, with a target cardinality of 1. In some implementations, ItemTotalValues are not changed.

Location is a place to which and from which goods are delivered or services are provided/procured. A Location can occur in the following specializations: ShipToLocation (a ShipToLocation is a place to which goods are delivered), ShipFromLocation (a ShipFromLocation is a place from which goods are delivered), and ServicePoint Location (a ServicePoint is a location at which a service is performed). The elements located directly at the node Location are defined by the data type CustomerTransactionDocumentLocationElements. These elements include: LocationID, LocationUUID, AddressReference, RoleCode, RoleCategoryCode, and DeterminationMethodCode. LocationID is an identifier of a business object Location, and may be based on datatype GDT: LocationID. LocationUUID is a universally unique identifier of a business object Location, and may be based on datatype GDT: UUID. AddressReference includes information used to reference an address of a business object, and may be based on datatype BOIDT: ObjectNodeLocationAddressReference. AddressReference can include AddressReference/AddressHostUUID, AddressReference/AddressHostTypeCode, AddressReference/BusinessObjectTypeCode, AddressReference/InstalledBaseID, AddressReference/InstallationPointID, AddressReference/PartyKey, AddressReference/PartyKey/PartyTypeCode, and AddressReference/PartyKey/PartyID. AddressReference/AddressHostUUID is a universally unique identifier for an address of a business partner, an organizational unit, associated specializations, a business object InstalledBase, or a business object InstallationPoint. AddressReference/AddressHostUUID may be based on datatype GDT: UUID. AddressReference/AddressHostTypeCode may be optional, is a coded representation of an address host type of an address referenced by an AddressUUID or an address included using the Location Address composition, and may be based on datatype GDT: AddressHostTypeCode. AddressReference/BusinessObjectTypeCode may be optional, is a coded representation of a type of a business object in which an address referenced in the LocationAddressUUID is integrated as a dependent object, and may be based on datatype GDT: BusinessObjectTypeCode. AddressReference/InstalledBaseID is an identifier for an installed base that references an address using the AddressUUID, and may be based on datatype GDT: InstalledBaseID. AddressReference/InstallationPointID is an identifier for an installation point that references an address using the AddressUUID, and may be based on datatype GDT: InstallationPointID. AddressReference/PartyKey is an alternative identifier of a party that represents a business partner or an organizational unit that references an address using the AddressUUID, and may be based on datatype KDT: PartyKey. AddressReference/PartyKey can include AddressReference/PartyKey/PartyTypeCode, which is a coded representation of a type of party, and may be based on datatype GDT: BusinessObjectTypeCode. AddressReference/PartyKey can include AddressReference/PartyKey/PartyID, which is an identifier for a party, and may be based on datatype GDT: PartyID. RoleCode is a coded representation of a role of a Node Location in a Customer Transaction Document document, and may be based on datatype GDT: LocationRoleCode. RoleCategoryCode may be optional, is a coded representation of a Role Category of a Node Location in a Customer Transaction Document, and may be based on datatype GDT: LocationRoleCategoryCode. DeterminationMethodCode may be optional, is a coded representation of a LocationDeterminationMethod, and may be based on datatype GDT: LocationDeterminationMethodCode.

The following inbound aggregation relationships may exist: Address Snapshot, from the business object Address Snapshot/node Root, with a cardinality of C:CN; InstallationPointAddressInformation, from the business object Installation Point/node Address Information, with a cardinality of C:CN, which is an installation point address to which or at which goods are delivered or a service is provided in the roles ShipFromLocation, ShipToLocation Returns, and ServicePoint; Location, from the business object Location/node Location, with a cardinality of C:CN, which is a location to which or at which goods are delivered or a service is provided in the roles ShipFromLocation, ShipToLocation Returns, and ServicePoint; and PartyAddressInformation, from the business object Party/node Address Information, with a cardinality of C:CN, which includes AddressInformation of a representative of a Business Partner or Organizational Centre corresponding to a Location. The following specialization associations for navigation may exist: Address Snapshot Overview, to the business object Address Snapshot/node Overview, with a target cardinality of C; Parent, to the node Service Confirmation, with a target cardinality of 1; Root, with a target cardinality of 1; and Used Address, to the business object Used Address/node Used Address, with a target cardinality of C, which can be used for an address used for a Location. The address can be a referenced address of a master data object, or a node ID of a node in a master data object that can be determined via the PartyTypeCode, AddressHostUUID, and AddressHostTypeCode elements and that has a composition relationship to a DO address that is to be represented by a TO UsedAddress.

In some implementations, there is only one aggregation or composition relationship to a dependent object. If there is an aggregation relationship to the business object Location, the LocationID attribute can be filled with the ID of business object Location and other ID fields, such as PartyID, InstalledBaseID, and InstallationPointID can remain blank. In some implementations, if the address of a party is referenced representative of a BusinessPartner or an OrganisationalCentre, the PartyID attribute can be filled with the ID of the Party, and other ID fields, such as LocationID, InstalledBaseID, and InstallationPointID can remain blank, and a reference can be kept in the AddressUUID attribute. In some implementations, if there is an aggregation relationship to an address of an InstalledBase, the InstalledBaseID attribute can be filled with the ID of the InstalledBase, other ID fields, such as LocationID, PartyID, and InstallationPointID can remain blank, and a reference can be kept in the AddressUUID InstalledBaseAddressInformationUUID attribute. In some implementations, If there is an aggregation relationship to an address of an InstallationPoint, the InstallationPointID attribute can be filled with the ID of the InstallationPoint, other ID fields, such as LocationID, PartyID, and InstalledBaseID can remain blank, and a reference can be kept in the AddressUUID attribute. In some implementations, if an address is referenced via the element AddressUUID, then elements AddressBusinessObjectTypeCode and AddressHostTypeCode are also filled.

A Party is a natural or legal person, organization, organizational unit, or group that is involved in a CustomerTransactionDocument in a PartyRole. Party occurs in the following specializations: BuyerParty (a BuyerParty is a party Customer that purchases a product or service and occurs in a role of a buyer or ordering party with whom a contractual agreement is concluded), SellerParty (a SellerParty is a party that sells goods or services and represents a selling company that has a contractual agreement with a BuyerParty), ProductRecipientParty (a ProductRecipientParty is a party Customer, Supplier, or Company to whom goods are delivered or services are provided that fulfills a role of a customer who receives goods or, in case of returns, a vendor or supplying company), VendorParty (a VendorParty is a party Company, Customer or Supplier who delivers goods or provides services and who performs a role of a delivering enterprise or of an external vendor or, in the case of returns, a customer), BillToParty (a BillToParty is a party Customer to whom an invoice for goods or services is sent), PayerParty (a PayerParty is a party Customer that pays for a product or a service), SalesUnitParty (a SalesUnitParty is a party Sales Unit that is responsible for the sales of goods and services), ServiceSupportTeamParty (a ServiceSupportTeamParty is a party Service Unit that is responsible for the processing of service requests and customer complaints as well as the planning and preparation of services), ResponsibleEmployeeParty (a ResponsibleEmployeeParty is a party Employee that is responsible for the processing of sales or services), ServiceExecutionTeamParty (a ServiceExecutionTeamParty is a party Service Unit that is responsible for executing service orders), ServicePerformerParty (a ServicePerformerParty is a party Employee that provides services for a company), ProcessorParty (a ProcessorParty is a party Employee that processes a CustomerTransactionDocumentTemplate document), ContractReleaseAuthorisedParty (a ContractReleaseAuthorisedParty is a party that is authorized to release goods or services from a contract), FreightForwarderParty (a Freight ForwarderParty is a party Business Partner that supplements a service by subcontracting transportation and other associated services), and SalesPartnerParty (a SalesPartnerParty is a party that initiates and implements business transactions for another company). A Party can be a reference to a business partner or one of its specializations, such as Customer, Supplier, or Employee, or a reference to one of the following specializations of an organizational unit: Company, FunctionalUnit, or ReportingLineUnit. The elements located directly at the node Party are defined by the data type CustomerTransactionDocumentPartyElements. These elements include: PartyKey, PartyUUID, RoleCategoryCode, RoleCode, AddressReference, DeterminationMethodCode, and MainIndicator. PartyKey is an identifier for a party in a PartyRole in a business document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. If a business partner or organizational unit are referenced, the PartyID attribute can include associated identifiers. If an unidentified identifier is entered, for example by a user, the PartyID attribute can include such an identifier. PartyUUID is a unique identifier for a business partner, organizational unit, or associated specialization, and may be based on datatype GDT: UUID. RoleCategoryCode may be optional, indicates a Party Role Category of a party in a business document, and may be based on datatype GDT: PartyRoleCategoryCode. RoleCode may be optional, indicates a Party Role of a party in a business document, and may be based on datatype GDT: PartyRoleCode. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator specifies whether a <business object-Node>party is emphasized with a same PartyRole in a number of parties, and may be based on datatype GDT: Indicator, with a qualifier of Main.

The following composition relationships to subordinate nodes exist: PartyContactParty, in a 1:CN cardinality relationship. The following inbound aggregation relationships may exist: Address Snapshot, from the business object Address Snapshot/node Root, with a cardinality of C:CN; and Party, from the business object Party/node Party, with a cardinality of C:CN, which is a referenced Party in Master Data. The following specialization associations for navigation can exist: Address Snapshot Overview, to the business object Address Snapshot/node Overview, with a target cardinality of C; Main Party Contact Party, to the node Party Contact Party, with a target cardinality of C, which is an association to a PartyContact that occurs in a MainPartyContactParty specialization; Parent, to the node Service Confirmation, with a target cardinality of 1; Root, with a target cardinality of 1; and Used Address, to the business object Used Address/node Used Address, with a target cardinality of C.

In some implementations, a BuyerParty is not changed after a document has been created. In some implementations, a PayerParty is not changed once it has been created. In some implementations, there is only one aggregation relationship to a business partner, an organizational unit, or associated specializations. In some implementations, if a PartyUUID exists, a PartyTypeCode also exists. In some implementations, parties are referenced via a Transformed Object Party that represent at least one of the following business objects: Company, SalesUnit, ServiceUnit, ReportingLineUnit, Supplier, Customer, Employee, or BusinessPartner.

A PartyContactParty is a natural person or an organizational unit that can be contacted for a respective party. A contact can be a contact person or a secretariat, for example. Communication data can be available for a contact. The elements located directly at the node Party Contact Party are defined by the data type CustomerTransactionDocumentPartyContactPartyElements. These elements include: PartyKey, PartyUUID, AddressReference, DeterminationMethodCode, and MainIndicator.

PartyKey is an identifier for a contact party in a customer transaction document, and may be based on datatype KDT: PartyKey. PartyKey can include PartyKey/PartyTypeCode, which is a coded representation of a type of party, and may be based on datatype GDT: BusinessObjectTypeCode. PartyKey can include PartyKey/PartyID, which is an identifier for a party, and may be based on datatype GDT: PartyID. If a business partner or organizational unit are referenced, the PartyID attribute can include corresponding identifiers. PartyUUID is a unique identifier for a business partner, organizational unit or associated specializations, and may be based on datatype GDT: UUID. AddressReference includes information to reference an address of a Party, and may be based on datatype GDT: PartyAddressReference. DeterminationMethodCode may be optional, is a coded representation of a PartyDeterminationMethod, and may be based on datatype GDT: PartyDeterminationMethodCode. MainIndicator may be optional, specifies whether a PartyContactParty is emphasized in a number of contacts with a same PartyRole, and may be based on datatype GDT: Indicator, with a qualifier of Main. The following inbound aggregation relationships may exist: Address Snapshot, from the business object Address Snapshot/node Root, with a cardinality of C:CN; Party, from the business object Party/node Party, with a cardinality of C:CN, which is a referenced Party in master data. The following specialization associations for navigation may exist: Address Snapshot Overview, to the business object Address Snapshot/node Overview, with a target cardinality of C; Parent, to the node Party, with a target cardinality of 1; Root, to the node Service Confirmation, with a target cardinality of 1; and Used Address, to the business object Used Address/node Used Address, with a target cardinality of C, which is an address used for a Party. The address can be a referenced address of a master data object, or a PartyAddress used via a composition relationship. It is possible to determine which of these two types of addresses apply by means of a PartyAddressHostTypeCode element. If the address is a referenced address, a node ID of a node in a master data object can be determined via PartyTypeCode, PartyAddressUUID and PartyAddressHostTypeCode elements that have a composition relationship to a DO address that is to be represented by a TO UsedAddress. In some implementations, a master data address is copied by a TO UsedAddress, changes take place to the copy, and a corresponding DO Address is created at a Party via a PartyAddress composition relationship. If the address is a PartyAddress, a TO UsedAddress can be informed of a BusinessObjectTypeCode, BusinessObjectNodeTypeCode and Node ID of a Party.

PeriodTerms is a period related agreement for goods and services that can occur in a CustomerTransactionDocument. PeriodTerms can occur in the following specializations with reference to a role of a period PeriodRoleCode: RequestedFulfillmentPeriod; which is a period in which delivery of goods or provision of services are requested; and ValidityPeriod, which is a period during which a CustomerTransactionDocumentTemplate document is valid. The elements located directly at the node Period Terms are defined by the data type CustomerTransactionDocumentPeriodTermsElements. These elements include: PeriodRoleCode, TimePointPeriod, StartTimePointDateCalculationFunctionReference, and EndTimePointDateCalculationFunctionReference. PeriodRoleCode is a role of a specified period, and may be based on datatype GDT: PeriodRoleCode. TimePointPeriod is a specification of a period. The business role of a period can specified by a PeriodRoleCode. TimePointPeriod may be based on datatype GDT: TimePointPeriod. StartTimePointDateCalculationFunctionReference is a reference to a function with which a start point-in-time of a period is calculated, and may be based on datatype GDT: DateCalculationFunctionReference. EndTimePointDateCalculationFunctionReference is a reference to a function with which an end point-in-time of a period is calculated, and may be based on datatype GDT: DateCalculationFunctionReference. The following specialization associations for navigation may exist to the node Service Confirmation: Parent, with a target cardinality of 1, and Root, with a target cardinality of 1.

PricingTerms are characteristics used for pricing and valuation of goods and services in a CustomerTransactionDocument. The elements located directly at the node Pricing Terms are defined by the data type CustomerTransactionDocumentPricingTermsElements. These elements include: CurrencyCode, CustomerPricingProcedureDeterminationCode, PriceDateTime, PriceSpecificationCustomerGroupCode, CustomerPriceListTypeCode, CustomerGroupCode, WarrantyGoodwillCode, and GrossAmountIndicator. CurrencyCode may be optional, is a currency for a valuation of goods and services ordered document currency, and may be based on datatype GDT: CurrencyCode. CustomerPricingProcedureDeterminationCode may be optional, is a customer scheme for determining a pricing procedure proposed by a buyer or an ordering party, and may be based on datatype GDT: CustomerPricingProcedureDeterminationCode. PriceDateTime is a price date at which price specifications are determined using a rule for automatic scheduling, and may be based on datatype GDT: LOCALNORMALISED_DateTime, with a qualifier of Price. PriceSpecificationCustomerGroupCode is a group of customers for whom same price specifications apply that are suggested by a buyer or ordering party, and may be based on datatype GDT: PriceSpecificationCustomerGroupCode. CustomerPriceListTypeCode may be optional, is a customer price list type proposed by a buyer or ordering party, and may be based on datatype GDT: CustomerPriceListTypeCode. CustomerGroupCode is a group of customers for general purposes, such as pricing and statistics, that is proposed by a buyer or ordering party, and may be based on datatype GDT: CustomerGroupCode. WarrantyGoodwillCode specifies an extent to which a provision of services or materials are not or are only partially invoiced to a customer in the case of a warranty or compensation, and may be based on datatype GDT: WarrantyGoodwillCode. GrossAmountIndicator may be optional, is an indicator that specifies whether a price and/or value is given as a gross amount including taxes, and may be based on datatype GDT: Indicator, with a qualifier of GrossAmount. The following specialization associations for navigation may exist: Parent, to the node Service Confirmation, with a target cardinality of 1; and Root, to the node Service Confirmation, with a target cardinality of 1. In some implementations, exchange rate elements ExchangeRate are set together.

SalesTerms are agreements and conditions applicable for a sale of goods and services in a CustomerTransactionDocument. The elements located directly at the node Sales Terms are defined by the data type CustomerTransactionDocumentSalesTermsElements. These elements include: IndustrialSectorCode, IndustryClassificationSystemCode, ProductUsageCode, CancellationReasonCode, and ProbabilityPercent. IndustrialSectorCode is an industrial sector assigned to a buyer ordering party. An industrial sector is a division of enterprises according to a focus of business activities. IndustrialSectorCode may be based on datatype GDT: IndustrialSectorCode. IndustryClassificationSystemCode represents an industry system assigned to a buyer ordering party. An industry system or industry classification system is a systematically structured hierarchy, and may be based on datatype GDT: IndustryClassificationSystemCode. ProductUsageCode defines what a buyer ordering party uses a product for in a current process, and may be based on datatype GDT: ProductUsageCode. CancellationReasonCode is a reason for canceling a sales transaction, can be set by both a buyer or seller, and may be based on datatype GDT: CancellationReasonCode. ProbabilityPercent may be optional, is a probability of a sales order or contract arising from a quote, and may be based on datatype GDT: SMALLNONNEGATIVE_Percent, with a qualifier of Probability. The following specialization associations for navigation may exist to the node Service Confirmation: Parent, with a target cardinality of 1; and Root, with a target cardinality of 1.

A ServiceReferenceObject is an object that a service refers to in a CustomerTransactionDocument. A ServiceReferenceObject can be a material, an individual material or a service product, for example. For example, a service can refer to a specific photocopier and associated component parts. As another example, a service can refer to other objects, such as installation components. The elements located directly at the node Service Reference Object are defined by the data type CustomerTransactionDocumentServiceReferenceObjectElements. These elements include: ID, MainIndicator, MaterialKey, IndividualMaterialKey, IndividualProductSerialIDKey, MaterialUUID, IndividualMaterialUUID, and InstallationPointUUID. ID may be optional, may be an alternative key, and may be based on datatype GDT: CustomerTransactionDocumentServiceReferenceObjectID. MainIndicator specifies whether an instance is a main service reference object, and may be based on datatype GDT: Indicator, with a qualifier of Main. MaterialKey is a key to identify a material to which a service refers, and may be based on datatype KDT: ProductKey. MaterialKey can include MaterialKey/ProductID, which is an identifier for a product, and may be based on datatype GDT: ProductID. IndividualMaterialKey is a key to identify an individual material to which a service refers, and may be based on datatype KDT: ProductKey. IndividualMaterialKey/ProductID is an identifier for a product, and may be based on datatype GDT: ProductID. IndividualProductSerialIDKey may be optional, is a grouping of elements that uniquely identifies an individual product in a service reference object of a customer transaction document by universally unique reference product ID and serial number, and may be based on datatype KDT: IndividualProductSerialIDKey. IndividualProductSerialIDKey/ReferenceProductUUID may be optional, is a universally unique identifier for a product, and may be based on datatype GDT: UUID. IndividualProductSerialIDKey/SerialID may be optional, is an identifier for an individual product, and may be based on datatype GDT: SerialID. MaterialUUID is a universally unique identifier for a material, and may be based on datatype GDT: UUID. IndividualMaterialUUID is a universally unique identifier for an IndividualMaterial, and may be based on datatype GDT: UUID. InstallationPointUUID is a universally unique identifier of an installation point of an individual material, and may be based on datatype GDT: UUID.

The following inbound aggregation relationships may exist: IndividualMaterial, from the business object Individual Material/node Individual Material, with a cardinality of C:CN, which is an Individual Material to which a service refers; IndividualProduct, from the business object IndividualProduct/node Root, with a cardinality of C:CN, which is an individual product to which a service refers; InstallationPoint, from the business object Installation Point/node Installation Point, with a cardinality of C:CN, which is an InstallationPoint at which an individual material is installed; Material, from the business object Material/node Material, with a cardinality of C:CN, which is a Material to which a service refers; and Material V1, from the business object Material/node Material, with a cardinality of C:CN, which is a material to which a service refers. The following specialization associations for navigation may exist to the node Service Confirmation: Parent, with a target cardinality of 1; and Root, with a target cardinality of 1. In some implementations, there is one main service reference object at any one time. In some implementations, a service reference object entered initially is flagged automatically as a main service reference object. In some implementations, at least the MaterialID or the IndividualMaterialID are specified. In some implementations, the InstallationPointUUID is determined internally and cannot be set externally.

ServiceTerms are conditions and agreements that apply for the execution of a service activity in a CustomerTransactionDocument and which can control processing. The elements located directly at the node Service Terms are defined by the data type CustomerTransactionDocumentServiceTermsElements. These elements include: ServiceProvisionLocationTypeCode, ServiceIssueCategoryCatalogueKey, ServiceIssueCategoryCatalogueCategoryKey, ServiceIssueCategoryUUID, WarrantyKey, WarrantyUUID, WarrantyValidityPeriod, ServiceLevelObjectiveID, and ServiceLevelObjectiveUUID. ServiceProvisionLocationTypeCode is a coded representation of the type of a location at which a service is provided, and may be based on datatype GDT: ServiceProvisionLocationTypeCode. ServiceIssueCategoryCatalogueKey is a key to identify a category catalog in which a category is included, and may be based on datatype KDT: ServiceIssueCategoryCatalogueKey. ServiceIssueCategoryCatalogueKey can include ServiceIssueCategoryCatalogueKey/ServiceIssueCategoryCatalogueID, which is an identifier of an issue category catalog, and may be based on datatype GDT: ServiceIssueCategoryCatalogueID. ServiceIssueCategoryCatalogueKey can include ServiceIssueCategoryCatalogueKey/ServiceIssueCategoryCatalogueVersionID, which is an identifier of a version of an issue category catalog, and may be based on datatype GDT: VersionID. ServiceIssueCategoryCatalogueCategoryKey is a key structure to identify a category that schedules a service business transaction, and may be based on datatype KDT: ServiceIssueCategoryCatalogueCategoryKey. ServiceIssueCategoryCatalogueCategoryKey/ServiceIssueCategoryID is an identifier of an issue category, and may be based on datatype GDT: ServiceIssueCategoryID. ServiceIssueCategoryCatalogueCategoryKey/ServiceIssueCategoryCatalogueUUID is a universally unique identifier of an issue category catalog and a version, and may be based on datatype GDT: UUID. ServiceIssueCategoryUUID is a universally unique identifier for a category that schedules a service business transaction, and may be based on datatype GDT: UUID. WarrantyKey is a key to identify a warranty that covers a customer transaction document, and may be based on datatype KDT: ProductKey. WarrantyKey/ProductID is an identifier for a product, and may be based on datatype GDT: ProductID. WarrantyUUID is a universally unique identifier for a warranty, and may be based on datatype GDT: UUID. WarrantyUUID can be used as an alternate key for a relationship to a warranty. WarrantyValidityPeriod is a period specifying a warranty validity, and may be based on datatype GDT: CLOSED_DatePeriod, with a qualifier of WarrantyValidity. ServiceLevelObjectiveID is an identifier for a Service Level Objective that specifies objectives for execution of services, and may be based on datatype GDT: ServiceLevelObjectiveID. ServiceLevelObjectiveUUID is a universally unique identifier for a Service Level Objective that specifies objectives for execution of services, and may be based on datatype GDT: UUID.

The following inbound aggregation relationships may exist: ServiceIssueCategory, from the business object Service Issue Category Catalogue/node Category, with a cardinality of C:CN, which is a ServiceIssueCategory which schedules a service business transaction; ServiceLevelObjective, from the business object Service Level Objective/node Service Level Objective, with a cardinality of C:CN, which is a ServiceLevelObjective, which specifies the objectives for execution of services; and Warranty, from the business object Warranty/node Root, with a cardinality of C:CN, which is a Warranty which covers a CustomerTransactionDocument. The following specialization associations for navigation may exist to the node Service Confirmation: Parent, with a target cardinality of 1; and Root, with a target cardinality of 1.

TimePointTerms is a point-in-time related agreement for goods and services that can occur in a CustomerTransactionDocument. TimePointTerms can occur in the following specializations with reference to a role of a point-in-timeTimePointRoleCode: FirstReactionDueTimePoint, which is a point-in-time by which a response to a newly-received service request or service order is requested; CompletionDueTimePoint, which is a point-in-time by which a service request or service order is to be fully processed; RequestInitialReceiptTimePoint, which is a point-in-time when a request is first received; RequestReceiptTimePoint, which is a point-in-time when a request is received or updated; RequestlnProcessAtTimePoint, which is a point-in-time when a request is put in process; RequestFinishedAtTimePoint, which is a point-in-time when a processing of a request is finished; RequestClosedAtTimePoint, which is a point-in-time when a request is considered as being finally closed; RequestSentToProviderAtTimePoint, which is a point-in-time when a request is forwarded to a provider; RequestCompletionByProviderDueTimePoint, which is a point-in-time by which a provider is to complete the processing of a request; RequestReceivedFromProviderAtTimePoint, which is a point-in-time by which a provider has completed the processing of a request; CompletionTimePoint, which is a point-in-time by which a customer transaction document is completed; ExecutionReleaseTimePoint, which is a point-in-time at which a customer transaction document is released for execution; Actual Arrival At Customer Time Point, which is an actual point of time at which a service performer arrived at a customer; Planned Arrival At Customer Time Point, which is a time point at which a service performer is planned to arrive at a customer; and Incident Completion Time Point, which is a time point at which an incident is completed.

The elements located directly at the node Time Point Terms are defined by the data type CustomerTransactionDocumentTimePointTermsElements. These elements include: TimePointRoleCode, TimePoint, and DateCalculationFunctionReference. TimePointRoleCode is a role of a specified point-in-time, and may be based on datatype GDT: TimePointRoleCode. TimePoint is a specification of a point-in-time. A business role of the point-in-time can be specified by the TimePointRoleCode. TimePoint may be based on datatype GDT: TimePoint. DateCalculationFunctionReference is a reference to a function with which a point-in-time is calculated, and may be based on datatype GDT: DateCalculationFunctionReference. The following specialization associations for navigation may exist to the node Service Confirmation: Parent, with a target cardinality of 1; and Root, with a target cardinality of 1.

TotalValues are cumulated total values that occur in a CustomerTransactionDocument, for example, a total gross and net weight, volume, gross and net amount, tax amount, or freight costs. Quantities, weights, volumes and values can be calculated by accumulation, and dates can be calculated by special logic. The elements located directly at the node Total Values are defined by the data type CustomerTransactionDocumentTotalValuesElements. These elements include: GrossWeightMeasure, NetWeightMeasure, GrossVolumeMeasure, GrossAmount, NetAmount, TaxAmount, FreightChargeAmount, NetWithoutFreightChargeAmount, LastPromisedDateTime, and LastConfirmedDateTime. GrossWeightMeasure is a total gross weight in a customer transaction document, and may be based on datatype GDT: Measure, with a qualifier of GrossWeight. NetWeightMeasure is a the total net weight in a Customer Transaction Document document, and may be based on datatype GDT: Measure, with a qualifier of NetWeight. GrossVolumeMeasure is a total gross volume in a Customer Transaction Document, and may be based on datatype GDT: Measure, with a qualifier of GrossVolume. GrossAmount is a total gross amount in a Customer Transaction Document document, and may be based on datatype GDT: Amount, with a qualifier of Gross. NetAmount is a total net amount in a Customer Transaction Document, and may be based on datatype GDT: Amount, with a qualifier of Net. TaxAmount is a total tax amount in a Customer Transaction Document, and may be based on datatype GDT: Amount, with a qualifier of Tax. FreightChargeAmount indicates total freight charges in a Customer Transaction Document document, and may be based on datatype GDT: Amount, with a qualifier of FreightCharge. NetWithoutFreightChargeAmount is a total net amount excluding freight charges, and may be based on datatype GDT: Amount, with a qualifier of NetWithoutFreightCharge. LastPromisedDateTime is a last promised date in a Customer Transaction Document document, and may be based on datatype GDT: LOCALNORMALISED_DateTime, with a qualifier of LastPromised. LastConfirmedDateTime is a last confirmed date in a Customer Transaction Document document, and may be based on datatype GDT: LOCALNORMALISED_DateTime, with a qualifier of LastConfirmed. The following specialization associations for navigation exist to the node Service Confirmation: Parent, with target cardinality of 1; and Root, with a target cardinality of 1. In some implementations, TotalValues are not changed externally.

A number of implementations have been described. Nevertheless, it will be understood that various modifications may be made without departing from the spirit and scope of the disclosure. Accordingly, other implementations are within the scope of the following claims.

1. A non-transitory computer readable medium including program code for providing a message-based interface for exchanging information about service confirmations, the medium comprising:
program code for receiving via a message-based interface derived from a common business object model, where the common business object model includes business objects having relationships that enable derivation of message-based interfaces and message packages, the message-based interface exposing at least one service as defined in a service registry and from a heterogeneous application executing in an environment of computer systems providing message-based services, a first message for initiating a request from an external service performing and charging system to create a service confirmation with reference to a customer contract, the first message including a first message package hierarchically organized in memory, the first message package including:
an external service performing and charging system service confirmation create request message entity; and
an external service performing and charging system service confirmation package including an external service performing and charging system service confirmation entity, wherein the external service performing and charging system service confirmation entity includes at least one of the following: a customer contract identifier and a name; and
program code for processing the first message according to the hierarchical organization of the first message package, where processing the first message includes unpacking the first message package based on the common business object model;
program code for sending a second message to the heterogeneous application responsive to the first message, where the second message includes a second message package derived from the common business object model to provide consistent semantics with the first message package.

2. The computer readable medium of claim 1, wherein the external service performing and charging system service confirmation entity further includes at least one item entity from an item package.

3. The computer readable medium of claim 1, wherein the external service performing and charging system service confirmation entity further includes at least one of the following: a text collection and an attachment folder.

4. A distributed system operating in a landscape of computer systems providing message-based services defined in a service registry, the system comprising:
at least one processor operable to execute computer readable instructions embodied on non-transitory media;
a graphical user interface executable by the at least one processor and comprising computer readable instructions, embedded on non-transitory media, for a request from an external service performing and charging system to create a service confirmation with reference to a customer contract, the instructions using a request;
a first memory storing a user interface controller executable by the at least one processor, the user interface controller for processing the request and involving a message including a message package hierarchically organized, the hierarchical organization of the message package including as:
an external service performing and charging system service confirmation create request message entity; and
an external service performing and charging system service confirmation package including an external service performing and charging system service confirmation entity, wherein the external service performing and charging system service confirmation entity includes at least one of the following: a customer contract identifier and a name; and
a second memory, remote from the graphical user interface, storing a plurality of service interfaces executable by the at least one processor and derived from the common business object model to provide consistent semantics with messages derived from the common business object model, wherein one of the message-based service interfaces processes the message based on the hierarchical organization of the message package, where processing the message includes unpacking the first message package based on the message package's structure and the message package's derivation from the common business object model, wherein the particular structure of the message package is used at least in part to identify the purpose of the message.

5. The distributed system of claim 4, wherein the first memory is remote from the graphical user interface.

6. The distributed system of claim 4, wherein the first memory is remote from the second memory.
